(19) United States
(12) Patent Application Publication
(10) Pub. No.: US 2004/0215697 A1
(43) Pub. Date: Oct. 28, 2004

(54) Systems and methods for managing unit operating data

(76) Inventors: Vasileios Vergopoulos, Woodstock, MD (US); Christopher J. Schult, Elkridge, MD (US); Raymond W. Mott, Severna Park, MD (US); Henry L. Jackson II, Pikesville, MD (US); Denis Khazan, Owings Mills, MD (US)

Correspondence Address: Finnegan, Henderson, Farabow,, Garrett & Dunner, L.L.P., 1300 I Street, N.W., Washington, DC, 20005-3315, US

(21) Appl. No.: 10/411,089

(22) Filed: Apr. 11, 2003

(51) Int. Cl. G06F 15/16

(52) U.S. Cl. 709/201

(57) ABSTRACT

Systems and methods manage unit operating data of a customer. A customer may be a refinery or any other entity that utilizes unit operating data. Unit operating data may include feed stock data, operations data, yield data, and catalyst data. An analysis service provider analyzes the unit operating data and makes results of the analysis accessible to the customer. The analysis may be based on historical data, industry-wide data, or changes in feed stock data, operations data, yield data, and catalyst data.

### DESCRIPTION OF THE INVENTION

I. Field of the Invention

The present invention relates to systems and methods for managing unit operating data for a customer. In particular, the present invention relates to systems and methods for managing unit operating data including data about substances used by a customer.

II. Background of the Invention

Many businesses today use and rely upon various substances. These businesses often have the substances analyzed for a variety of reasons. For example, a business may be able to improve efficiency or reduce costs based on the analysis of a substance as well as the products and operating conditions used to create the substance. Furthermore, a business may be able to improve efficiency or reduce costs by choosing a different substance or by choosing different products and operating conditions in the creation of the substance.

Within the petrochemical refining industry, a refinery may determine whether any part of the refining process may be improved. A refinery many seek improvement by analyzing the petroleum or by analyzing the constituent parts and operating conditions. A refinery may also determine whether its efficiency could be improved by comparing the substance analysis with a predicted analysis based on a different desired result. A refinery may also determine whether its efficiency could be improved by comparing the substance analysis with a predicted analysis based on various other variables, such as, for example, unit operating data.

In the medical industry, doctors and hospitals frequently need to have substances, such as blood samples, analyzed for a variety of reasons, such as diagnosis and treatment. In the automotive industry, automobile repair shops need substances, such as gasoline and oil, analyzed. Indeed, any entity that uses any type of substances may benefit from the analysis of the substances.

Substance analysis and related services may be provided by an analysis service provider that receives a sample of a substance from a customer, analyzes the substance, and returns results of the analysis to the customer. For example, a laboratory may receive a blood sample from a doctor's office, perform one or more tests on the blood sample, and return a report to the doctor's office with results of the one or more tests. In another example, a chemical company may receive a sample of a used catalyst from a petroleum refinery, perform one or more tests on the sample, and return the test results to the refinery.

An analysis service provider may also receive unit operating data from a customer and use the unit operating data in the analysis process. For example, a refinery may send a petroleum sample to be analyzed along with the operating data about the refinery, such as, for example, the feed stock, the operations data, yield data, and catalyst data. The analysis service provider may use the additional data to predict improvements in efficiency based on, for example, changing the operating conditions or choosing a different catalyst.

In traditional systems, days or weeks may elapse before the test results are returned to the customer. Delay by an analysis service provider may be due to a number of factors. For example, unit operating data is typically received from a customer in a customer-specific format. It takes a great deal of time for the analysis service provider to manually reformat the data into a standard format for analysis. Furthermore, if multiple tests are performed, an analysis service provider may hold the test results until all of the tests have been completed, delaying the results of tests completed earlier. Many analysis service providers manually create reports to communicate the test results, resulting in delays if the analysis service provider becomes too busy. Furthermore, returning test results using traditional channels, such as the mail, can further delay the receipt of results. Delays of days or even hours may prevent a customer from making optimum use of the test results. It is therefore desirable to provide substance analysis results to customers as quickly as possible.

To make the best use of substance analysis data, customers may wish to have the data reported in a customized fashion. For example, a customer may wish to have recent test results listed together with historical test results to determine any trends. Additionally, a customer may wish to receive all test results via an electronic medium, such as facsimile or e-mail, or in a specific format, such as a spreadsheet or pie chart. For data that includes multiple analyses, e.g., actual efficiency versus predicted efficiency, a customer may wish to receive the data in a format that makes it easy to compare the different analyses. It is desirable therefore to provide test results that can be customized according to a customer's preferences.

One obstacle to making substance analysis data readily available to customers is the highly sensitive nature of this type of data. For example, medical data is subject to strict confidentiality requirements to protect patients. Corporate data may include trade secrets or other valuable business-related information. While customers desire quick test results, they are unwilling to compromise the security of their data. It is therefore necessary to ensure data security in any system designed to provide substance analysis information to customers.

Another difficulty in making substance analysis data available to customers is the size and complexity of some customers. For example, multiple employees of a single corporation may require access to the same data. In some cases, different employees may need to access different portions of the data or may have different preferences for viewing the data. For example, a supervisor may need to access data available to his subordinates for management purposes. In another example, a trainer or salesperson may need to access data available to a user in order to train the user. Therefore, a system for providing substance analysis data to a customer should allow for multiple users to access data according to different preferences and needs.

In reporting substance analysis data, the analysis service provider must protect its proprietary information as well as that of its customers. For example, proprietary calculations may be used by the analysis service provider when analyzing substances. When the test results are presented to a customer, these proprietary calculations must be protected.

In addition to the analysis of its own substances, a customer may benefit from viewing substance analysis data for several customers or an entire industry. For example, a refinery may benefit from knowing how its used catalysts compare with catalysts used by a competing refinery. While this information may be highly beneficial, a customer might be reluctant to submit to such analysis in order to prevent divulging sensitive information to its competitors. Therefore, it is desirable to develop a system for providing industry analysis to customers while protecting any sensitive information.

In view of these obstacles as well as other considerations, there is a need for a system for presenting information such as substance analysis data and services to customers in an efficient and robust manner.

### SUMMARY OF THE INVENTION

Systems and methods consistent with the present invention allow customers to access information over a network, such as the Internet, that may be managed and presented in various ways based on customer choices. The information may be based on unit operating data including feed stock data, operations data, yield data, and catalyst data.

In one embodiment of the present invention, unit operating data may be received from the customer and analyzed. The results of the analysis may be stored in a database and the customer may access the results via a website. In this embodiment, a customer sends unit operating data including feed stock data, operations data, yield data, and catalyst data to an analysis service provider for analysis. The analysis service provider analyzes the unit operating data and posts the results on a website. The way in which results are presented to the customer may be customized according to customer preferences. The results may pertain, for example, to the analysis of operating conditions and substances, such as catalysts, used by a refinery.

Consistent with another embodiment of the present invention, unit operating data received from a customer may be translated into a standard format prior to analysis. In this embodiment, the customer may provide formatting information, for example, using a formatting tool provided by an analysis service provider. Once the formatting information is received, the customer may send unit operating data in a customer-specific format. Using the formatting information, the unit operating data may be automatically reformatted into a standard format and stored in a database. For example, the standard format may be a format compatible with analysis processes to provide for quick and easy analysis of the unit operating data. The reformatted data may be accessed by the customer. Consistent with an embodiment of the present invention, the customer may provide formatting information once and the formatting information may be used for multiple submissions of unit operating data from that customer, saving the customer time.

In another embodiment of the present invention, a predicted operating efficiency and/or an actual operating efficiency may be determined based on the unit operating data of a customer. For example, unit operating data including feed stock data, operations data, yield data, and catalyst data may be received from a customer. The unit operating data may be analyzed to determine an actual operating efficiency of the customer. Furthermore, a predicted operating efficiency may be determined by changing at least one of the feed stock data, operations data, yield data, and catalyst data. The actual operating efficiency and predicted operating efficiency may be presented to the customer. In this way, the customer may realize, for example, that changing an operating condition or using a different catalyst would decrease costs and/or produce higher yields.

In another embodiment of the present invention, a predicted operating efficiency and/or an actual operating efficiency may be determined based on data about a catalyst other than the one used by the customer. In this embodiment, unit operating data including feed stock data, operations data, and yield data may correspond to a catalyst used by a customer. An actual operating efficiency may be determined by analyzing the unit operating data. A predicted operating efficiency may be determined by analyzing the unit operating data based on use of a catalyst other than the catalyst used by the customer. In this way, the customer may realize, for example, that using a different catalyst would produce higher yields or enable less expensive operating conditions.

Still another embodiment of the present invention provides customers with unit operating data analysis and substance analysis. For example, a customer may submit a sample substance for analysis along with unit operating data. The substance may be analyzed to determine an actual operating efficiency based on the unit operating data. Incorporating substance analysis with unit operating data may improve the accuracy of the analysis, for example, by eliminating possible mistakes by the customer. The substance analysis results and the unit operating data may be stored in a database. An improved operating efficiency may be determined based on the unit operating data and the analysis of a different substance.

Yet another embodiment of the present invention provides unit operating data analysis based on industry data. For example, when customers submit unit operating data for analysis, the results may be stored in a database. In addition to analysis of individual customers' unit operating data, all of the unit operating data may be analyzed to produce an industry-wide analysis, such as an industry average or industry mean. Customers may then compare their own results to those of others in a given industry or to industry-wide results. The industry analysis may also be used to provide more accurate predictions based on changing a customer's unit operating data. The industry analysis information may be presented to customers in a way that does not disclose the origin of the data to protect the confidentiality of individual customers.

Additional advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate several embodiments of the invention and together with the description, serve to explain the principles of the invention. In the drawings:

FIG. 1 is a block diagram of a system consistent with an embodiment of the present invention;

FIG. 2 is a block diagram of another system consistent with an embodiment of the present invention;

FIG. 3 is a block diagram of unit operating data consistent with an embodiment of the present invention;

FIG. 4 is a block diagram of a customer in greater detail consistent with an embodiment of the present invention;

FIG. 5 is block diagram of an analysis service provider consistent with an embodiment of the present invention;

FIG. 6 is a block diagram of a customer interface in greater detail consistent with an embodiment of the present invention;

FIG. 6.1 is a sample home page for a website consistent with an embodiment of the present invention;

FIG. 6.2 is a sample registration page for a website consistent with an embodiment of the present invention;

FIG. 7 is a block diagram of membership information in greater detail consistent with an embodiment of the present invention;

FIG. 7.1 is a sample registered user home page for a website consistent with an embodiment of the present invention;

FIG. 8 is a block diagram of a technical library consistent with an embodiment of the present invention;

FIG. 8.1 is a sample technical publications page for a website consistent with an embodiment of the present invention;

FIG. 8.2 is a sample useful contacts page for a website consistent with an embodiment of the present invention;

FIG. 9 is a block diagram of troubleshooting in greater detail consistent with an embodiment of the present invention;

FIG. 9.1 is a sample troubleshooting page for a website consistent with an embodiment of the present invention;

FIG. 10 is a block diagram of product ordering in greater detail consistent with an embodiment of the present invention;

FIG. 10.1 is a sample product information page for a website consistent with an embodiment of the present invention;

FIG. 10.2 is a sample online order form for a website consistent with an embodiment of the present invention;

FIG. 10.3 is a sample order history page for a website consistent with an embodiment of the present invention;

FIG. 10.4 is a sample delivery history report for a website consistent with an embodiment of the present invention;

FIG. 11 is a sample emulation screen consistent with an embodiment of the present invention;

FIG. 12 is a block diagram of file exchange consistent with an embodiment of the present invention;

FIG. 13 is a block diagram of a unit operating data interface consistent with an embodiment of the present invention;

FIG. 14 is a block diagram of a standard variable list consistent with an embodiment of the present invention;

FIG. 15 is a block diagram of customer data formatting consistent with an embodiment of the present invention;

FIG. 15.1 is a sample set-up tool for customer data formatting for a website consistent with an embodiment of the present invention;

FIG. 15.2 is another sample set-up tool for customer data formatting for a website consistent with an embodiment of the present invention;

FIG. 15.3 is another sample set-up tool for customer data formatting for a website consistent with an embodiment of the present invention;

FIG. 15.4 is another sample set-up tool for customer data formatting for a website consistent with an embodiment of the present invention;

FIG. 15.5 is a sample data mapping screen for customer data formatting for a website consistent with an embodiment of the present invention;

FIG. 15.6 is a sample data mapping screen showing data mapping instructions for customer data formatting for a website consistent with an embodiment of the present invention;

FIG. 15.7 is a sample data mapping screen showing confirmed data mapping instructions for customer data formatting for a website consistent with an embodiment of the present invention;

FIG. 15.8 is another sample data mapping screen showing data mapping instructions for customer data formatting for a website consistent with an embodiment of the present invention;

FIG. 15.9 is a sample calculation screen for customer data formatting for a website consistent with an embodiment of the present invention;

FIG. 15.10 is another sample calculation screen for customer data formatting for a website consistent with an embodiment of the present invention;

FIG. 15.11 is a sample new variable creation screen for customer data formatting for a website consistent with an embodiment of the present invention;

FIG. 16 is a block diagram of a database in greater detail consistent with an embodiment of the present invention;

FIG. 17 is a block diagram of a security module in greater detail consistent with an embodiment of the present invention;

FIG. 18 is a block diagram of user authentication information in greater detail consistent with an embodiment of the present invention;

FIG. 19 is a block diagram of general public access information in greater detail consistent with an embodiment of the present invention;

FIG. 20 is a block diagram of an analysis module in greater detail consistent with the present invention;

FIG. 21 is a block diagram of analysis tools in greater detail consistent with an embodiment of the present invention;

FIG. 22 is a block-diagram of industry analysis in greater detail consistent with an embodiment of the present invention;

FIG. 23 is a block diagram of customer-specific analysis in greater detail consistent with an embodiment of the present invention;

FIG. 24 is a block diagram of unit operating data analysis in greater detail, consistent with an embodiment of the present invention;

FIG. 25 is a block diagram of a reporting module in greater detail consistent with an embodiment of the present invention;

FIG. 26 is a block diagram of a report generator in greater detail consistent with an embodiment of the present invention;

FIG. 27 is a block diagram of an interface for viewing reports in greater detail consistent with an embodiment of the present invention;

FIG. 28 is a block diagram of user reports in greater detail consistent with an embodiment of the present invention;

FIG. 29 is a block diagram of report formats in greater detail consistent with an embodiment of the present invention;

FIG. 29.1 is a sample technical information page for a website consistent with an embodiment of the present invention;

FIG. 29.2 is a sample customer-specific analysis page for a website consistent with an embodiment of the present invention;

FIG. 29.3 is a sample customer-specific report for a website consistent with an embodiment of the present invention;

FIG. 29.4 is a sample test detail report for a website consistent with an embodiment of the present invention;

FIG. 29.5 is a sample fresh substance analysis page for a website consistent with an embodiment of the present invention;

FIG. 29.6 is a sample fresh substance test detail report for a website consistent with an embodiment of the present invention;

FIG. 29.7 is a sample industry analysis page for a website consistent with an embodiment of the present invention;

FIG. 29.8 is a sample industry report for a website consistent with an embodiment of the present invention;

FIG. 29.9 is a sample comparison detail report for a website consistent with an embodiment of the present invention;

FIG. 29.10 is a sample advanced substance analysis report for a website consistent with an embodiment of the present invention;

FIG. 29.11 is a sample advanced substance analysis by catalyst report for a website consistent with an embodiment of the present invention;

FIG. 29.12 is a sample unit operating report request screen for a website consistent with an embodiment of the present invention;

FIG. 29.13 is a sample unit operating report selection screen for a website consistent with an embodiment of the present invention;

FIG. 29.14 is a sample report generation screen for a website consistent with an embodiment of the present invention;

FIG. 29.15 is a sample substance analysis report for a website consistent with an embodiment of the present invention;

FIG. 29.16 is a sample unit configuration report for a website consistent with an embodiment of the present invention;

FIG. 29.17 is a sample unit operating data report for a website consistent with an embodiment of the present invention;

FIG. 29.18 is another sample unit operating data report for a website consistent with an embodiment of the present invention;

FIG. 29.19 is another sample unit operating data report for a website consistent with an embodiment of the present invention;

FIG. 29.20 is another sample unit operating data report for a website consistent with an embodiment of the present invention; and

FIG. 29.21 is another sample unit operating data report for a website consistent with an embodiment of the present invention.

### DETAILED DESCRIPTION

Reference will now be made in detail to the exemplary embodiments of the invention, examples of which are illustrated in the accompanying drawings. Wherever possible, the same reference numbers will be used throughout the drawings to refer to the same or like parts.

I. System Overview

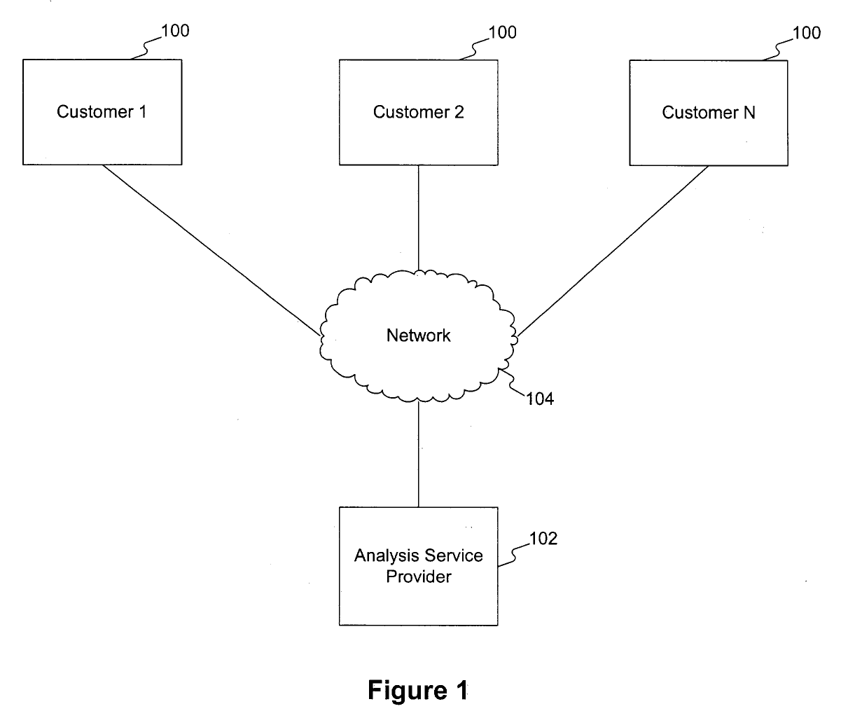

FIG. 1 is a block diagram of a system consistent with an embodiment of the present invention. A plurality of customers 100 communicate with an analysis service provider 102 via a network 104. Customers 100 may be, for example, refineries of petrochemical products or any other entities that need unit operating data management, substance analysis, and/or related services. Analysis service provider 102 may be, for example, a provider and analyzer of catalysts and additives for use in petrochemical refining that manages unit operating data. Consistent with the present invention, analysis service provider 102 may also be any other entity that provides substance analysis, manages unit operating data, and/or provides related services. Network 104 may be, for example, the Internet or any other collection of two or more nodes or computers.

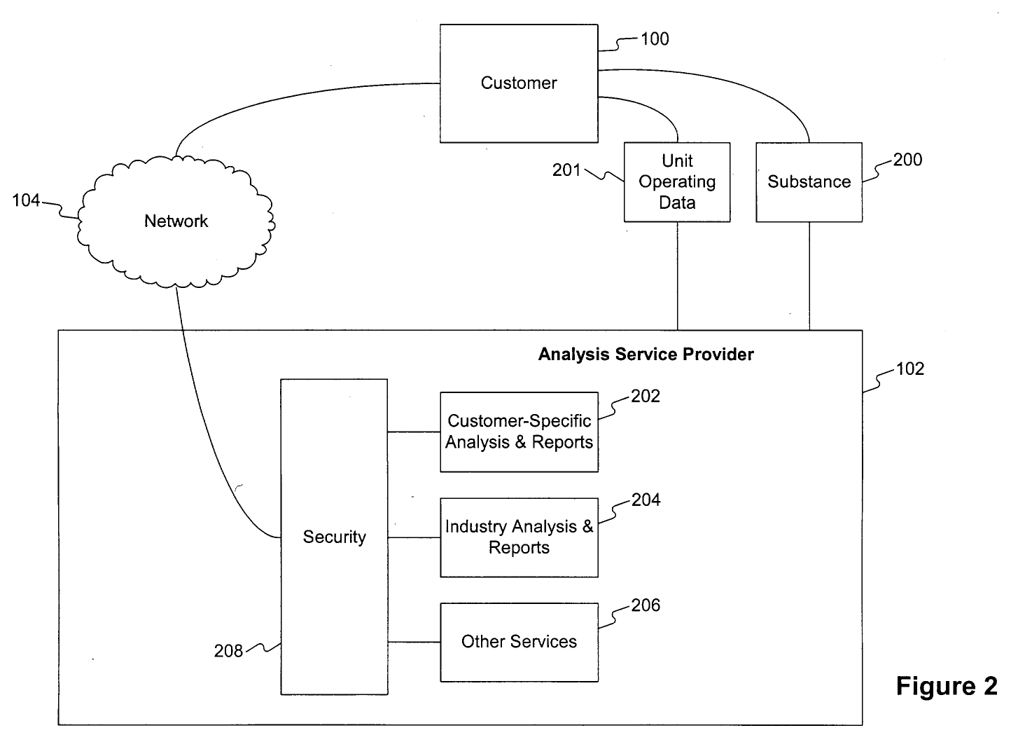

FIG. 2 is a block diagram of another system consistent with an embodiment of the present invention. As shown, a customer 100 sends a substance 200 to analysis service provider 102. The substance may be sent to analysis service provider 102 either directly or indirectly. Substance 200 may be, for example, a petrochemical product or other substance for testing, e.g., physical or chemical testing. Analysis service provider 102 analyzes substance 200 and, based on results of the analysis, produces customer-specific analysis and reports 202, industry analysis and reports 204, and other services 206.

Customer 100 also sends unit operating data 201 to analysis service provider 102. Analysis service provider analyzes unit operating data 201 and, based on results of the analysis, produces customer-specific analysis and reports 202, industry analysis and reports 204, and other services 206. To access this information, customer 100 communicates with analysis service provider 102 via network 104. For example, customer 100 may use a web browser to access a website stored on a web server at analysis service provider 102. Customer 100 may be subjected to security procedures 208 before being able to access customer-specific analysis and reports 202, industry analysis and reports 204, and/or other services 206. Although FIG. 2 depicts customer 100 sending both substance 200 and unit operating data 201 to analysis service provider 102, one skilled in the art will appreciate that, consistent with the present invention, customer 100 may send only unit operating data 201 or only substance 200 to analysis service provider 102. One skilled in the art will also appreciate that customer 100 may also send other items to analysis service provider 102.

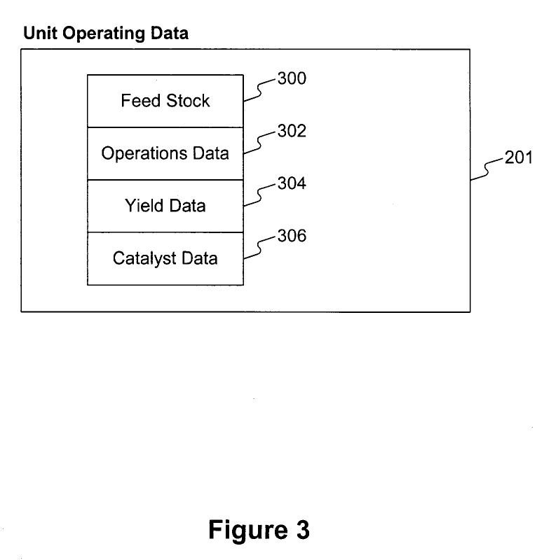

FIG. 3 is a block diagram of unit operating data 201, consistent with an embodiment of the present invention. Unit operating data 201 may include, for example, feed stock 300, operations data 302, yields data 304, and catalyst data 306. In one embodiment of the present invention, feed stock 300 includes data about the raw materials, e.g., crude oil, used by the customer, and operations data 302 includes data about operating conditions, e.g., temperature and pressure used by the customer. In this embodiment, yields data 304 includes data about the products and quantities, e.g., 10% gasoline, 5% diesel fuel, produced by the customer, and catalyst data 306 includes data about a catalyst (or catalysts) used by the customer. In an embodiment of the invention, yields data 302 may refer to the total product produced by the customer (e.g., 100 gallons of petroleum products) and may include selectivity data that refers to the amount/type of products produced (e.g., 95 gallons of gasoline, 5 gallons of diesel fuel).

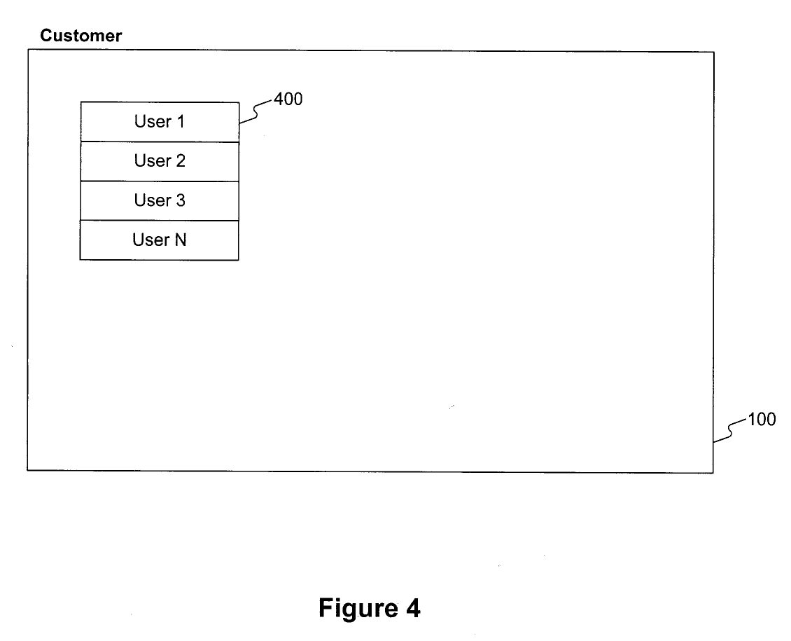

FIG. 4 is a block diagram of a customer in greater detail, consistent with an embodiment of the present invention. Customer 100 may have any number of corresponding users 400. For example, customer 100 may be a corporation with many individuals needing access to analysis service provider 102. In this embodiment of the present invention, each individual may be characterized as a user corresponding to the customer, i.e., the corporation. For example, customer 100 may be a petrochemical refinery, User 1 may be an engineer at the refinery, User 2 may be a purchasing officer at the refinery, and User 3 may be the purchasing officer's manager. Consistent with the present invention, a user may be characterized as a group of individuals, such as a department sharing a single computer or a business unit of a corporation. One skilled in the art will appreciate that customer 100 may include any number of users 400.

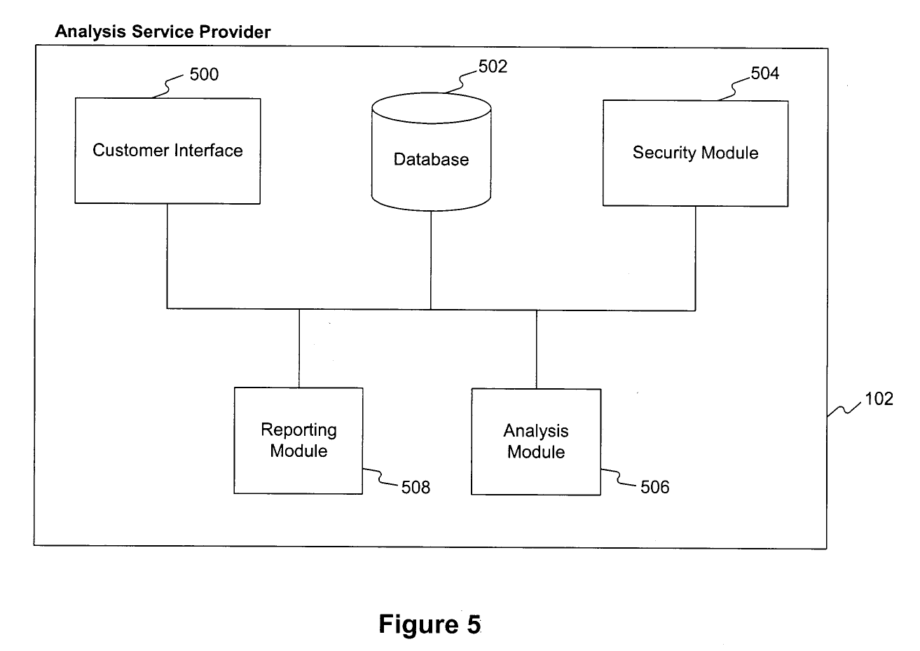

FIG. 5 is block diagram of an analysis service provider, consistent with an embodiment of the present invention. Analysis service provider 102 may be, for example, a provider and analyzer of catalysts and additives for use in petrochemical refining. Analysis service provider 102 may include, for example, a customer interface 500, a database 502, a security module 504, an analysis module 506, and a reporting module 508.

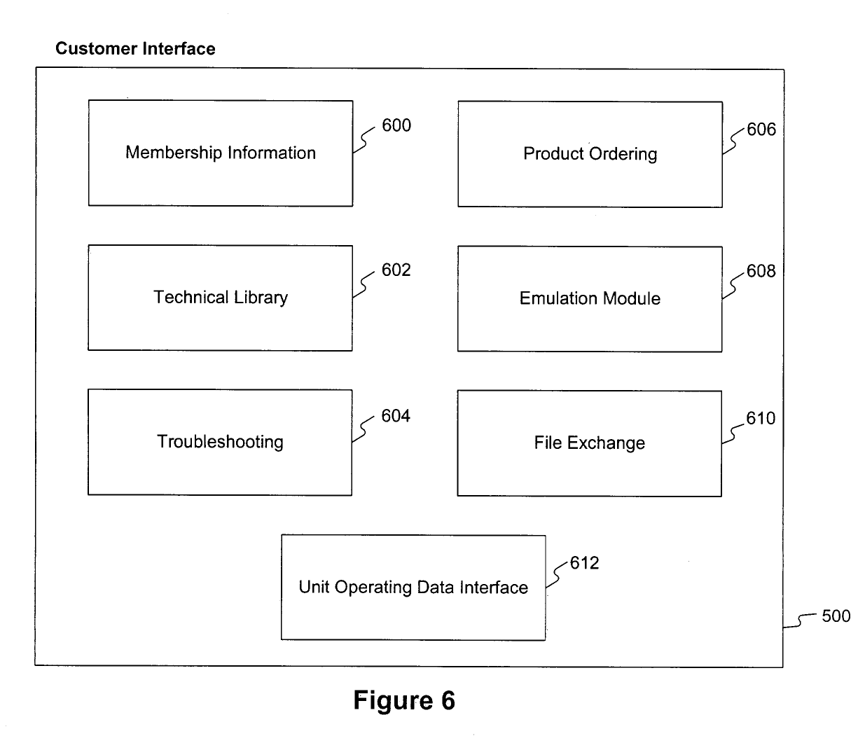

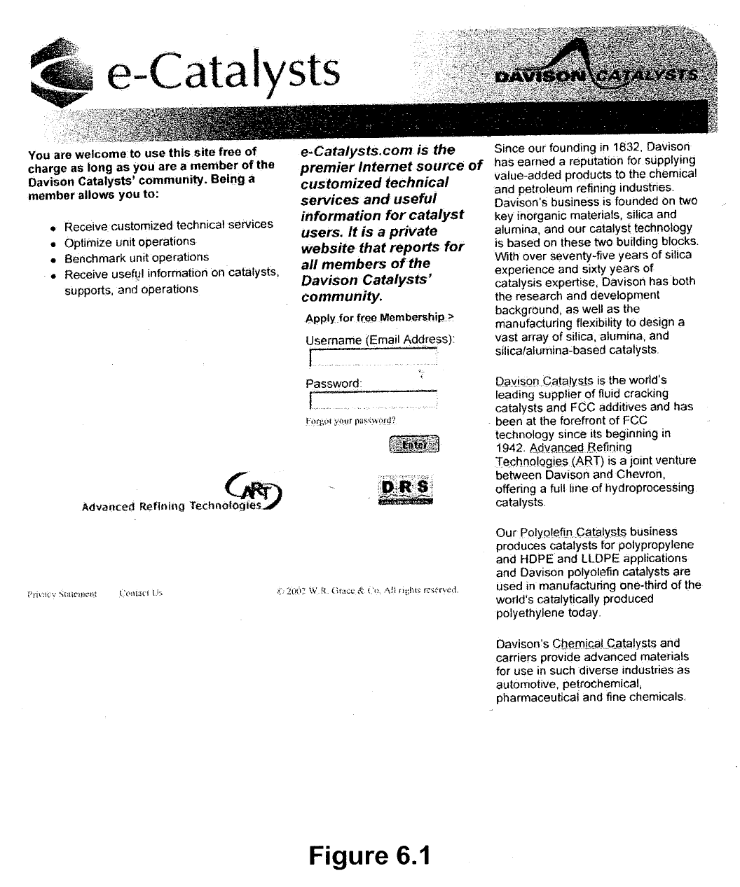

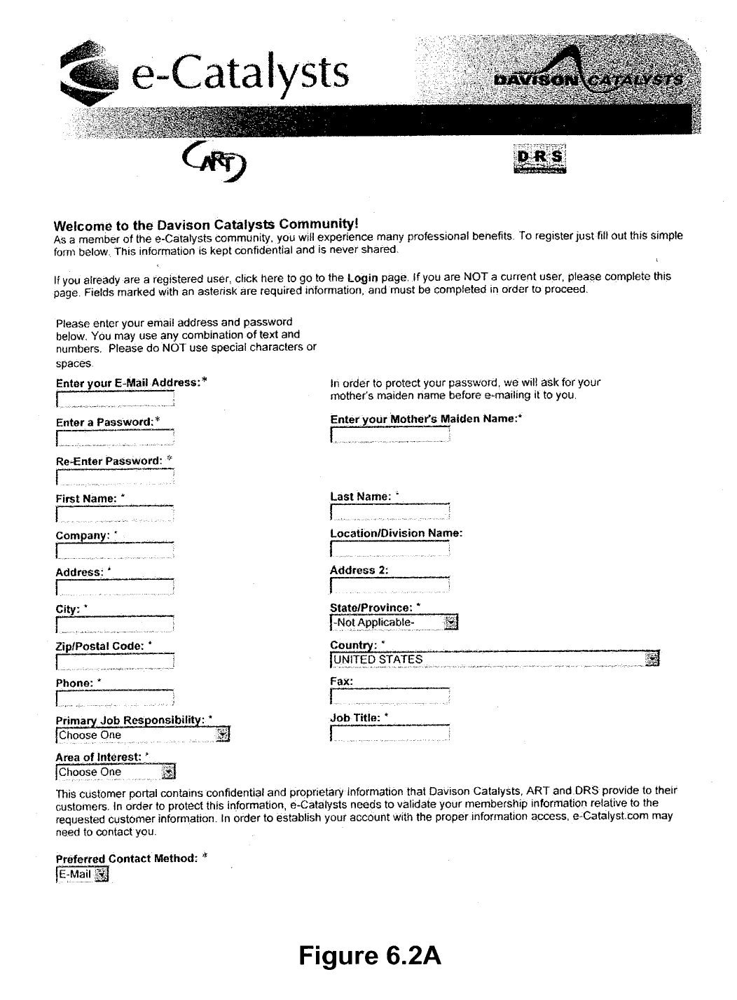

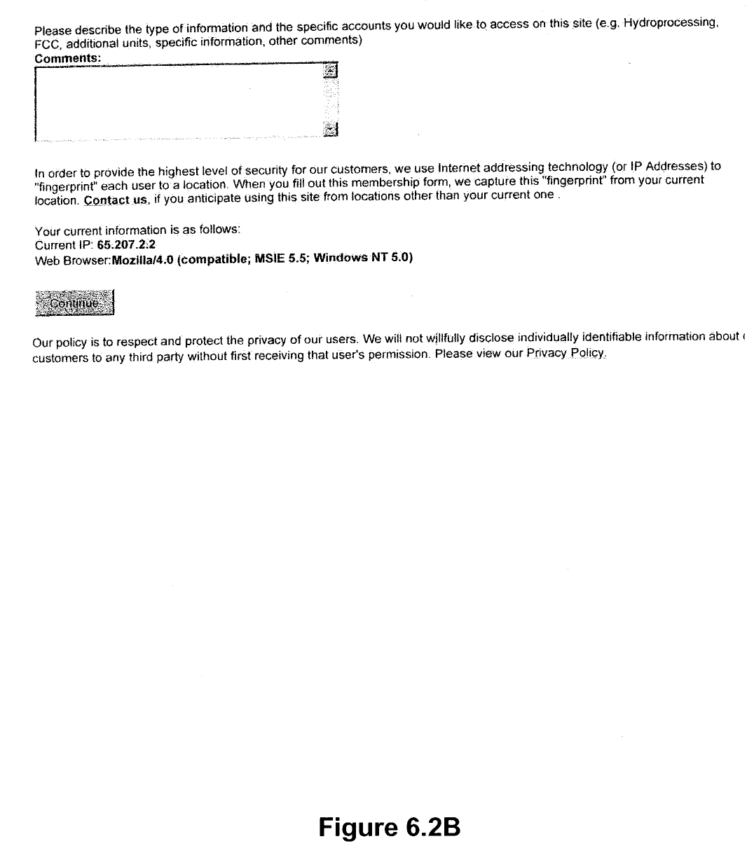

Customer interface 500 may enable communication between customers 100 (not shown) and analysis service provider 102 via network 104 (not shown). For example, customer interface 500 may include a web server for providing a website accessible by the Internet. Customer interface 500 is described in greater detail below with reference to FIGS. 6-15.

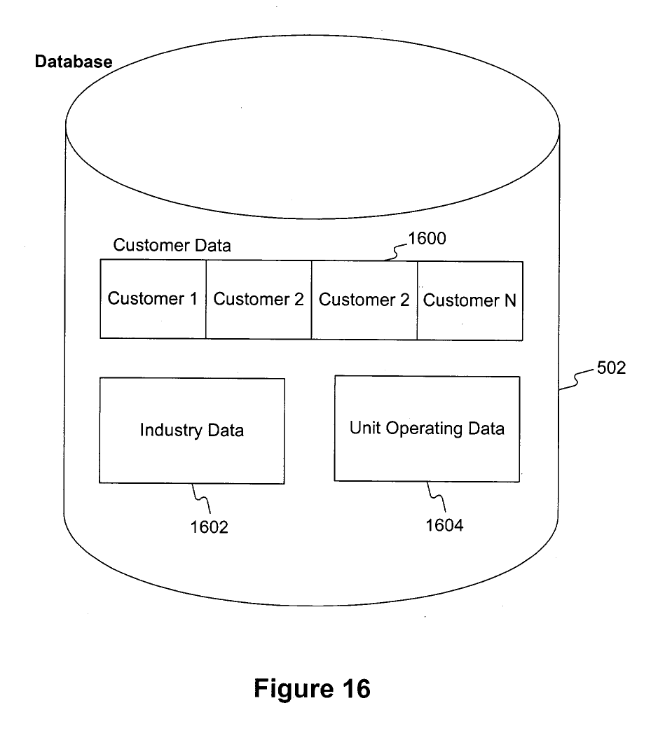

Database 502 may provide data storage for analysis service provider 102. Data stored in database 502 may be used by customer interface 500, security module 504, analysis module 506, and reporting module 508. Database 502 is described in greater detail below with reference to FIG. 16.

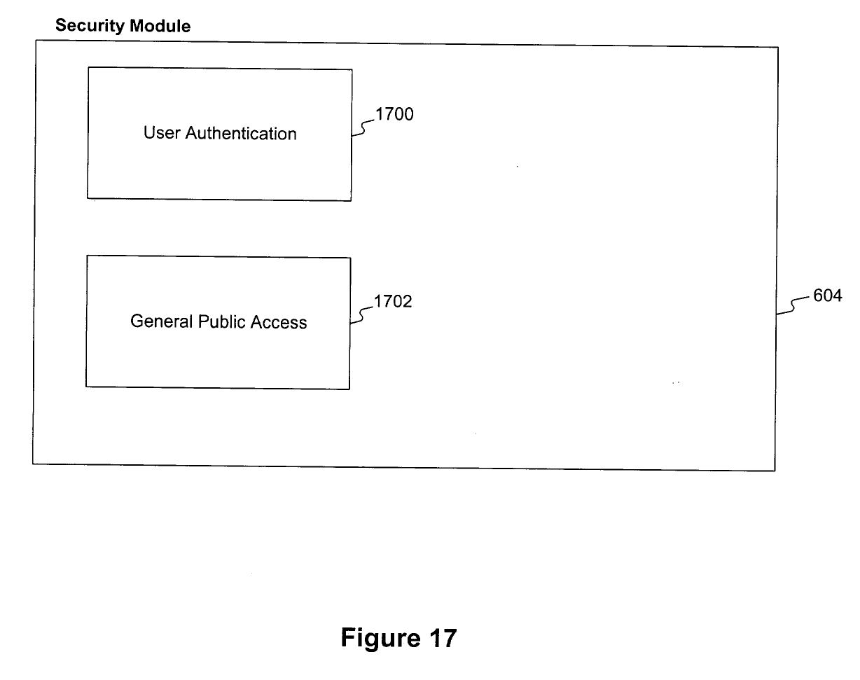

Security module 504 may be used to provide security for analysis service provider 102. For example, security module 504 may recognize and verify customers 100 that attempt to communicate with analysis service provider 102. Security module 504 is described in greater detail below with reference to FIGS. 17-19.

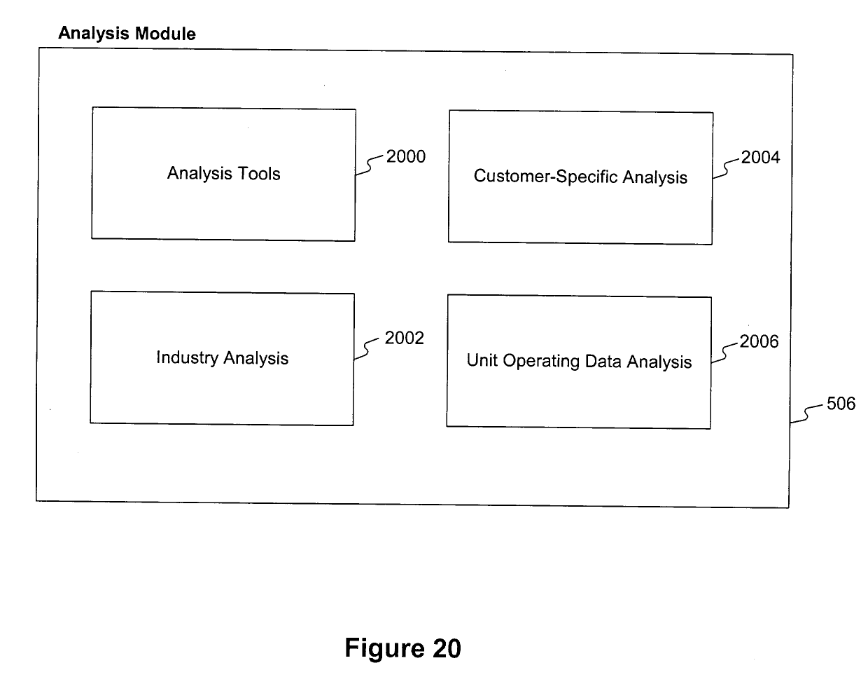

Analysis module 506 may be used, for example, to analyze substances and/or unit operating data received from customers. Analysis module 506 is described in greater detail below with reference to FIGS. 20-24.

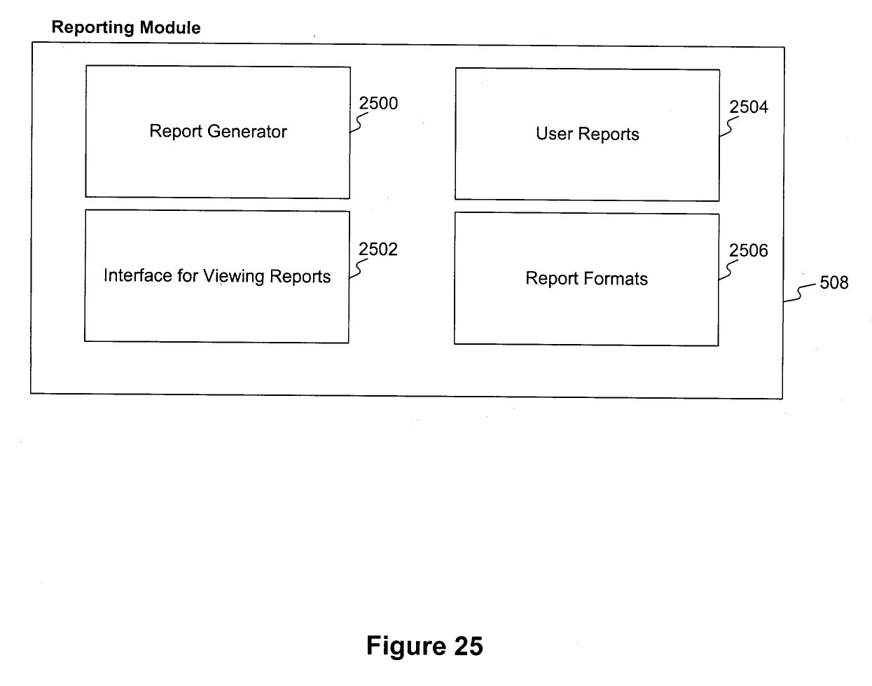

Reporting module 508 may be used to prepare and present reports for customers 100. Reporting module 508 is described in greater detail below with reference to FIGS. 25-29.

II. Customer Interface

FIG. 6 is a block diagram of a customer interface in greater detail, consistent with an embodiment of the present invention. Customer interface 500 may include membership information 600, a technical library 602, troubleshooting 604, product ordering 606, an emulation module 608, file exchange 610, and unit operating data interface 612. In an embodiment of the present invention, customer interface 500 may include a web server (not shown) for providing an analysis service provider website accessible by the Internet. The website may provide customers with access to membership information 600, technical library 602, troubleshooting 604, product ordering 606, emulation module 608, file exchange 610, and unit operating data interface 612.

FIG. 6.1 is a sample home page for a website consistent with an embodiment of the present invention. The home page may be presented, for example, to any member of the general public using the Internet address for the analysis service provider's website. The home page may include, for example, a list of member services, a log-in section, and information about the analysis service provider. The home page may be updated and presented via customer interface 500.

FIG. 6.2 is a sample registration page for a website consistent with an embodiment of the present invention. The registration page may be presented, for example, when an individual chooses a link on the home page to apply for membership. The member registration page may request, for example, a user's e-mail address, password, name, company (or customer) name, address, and a password protector, such as mother's maiden name.

The registration page may also request a user's location or division name within the company, a job title, a primary job responsibility, and an area of interest. The primary job responsibility field may be presented to the user as a drop-down list, with options such as analytical services, corporate engineering, operations, planning, purchasing, research and development, and training. The area of interest field may also be presented to the user as a drop-down list including options such as refining catalysts, chemical catalysts, polyolefin catalysts, or general information. The membership registration page may also allow the user to indicate a preferred contact method, such as e-mail, phone, fax, or mail, as well as providing a space for comments from the user, such as the type of information or accounts that the user would like to access using the analysis service provider's website. Customer interface 500 may collect the registration information and store it in, for example, membership information 600.

Security may also be implemented as part of the registration process. For example, when the registration page is completed by a user, customer interface 500 may use Internet addressing technology to capture the user's “fingerprint,” i.e., the current location of the computer used by the user. The fingerprint information may be displayed to the user as part of the registration page so that the user may verify the location from which he plans to access the analysis service provider's website in the future. After collecting the fingerprint information, customer interface 500 may store it together with the user's registration information in membership information 600.

A. Membership Information

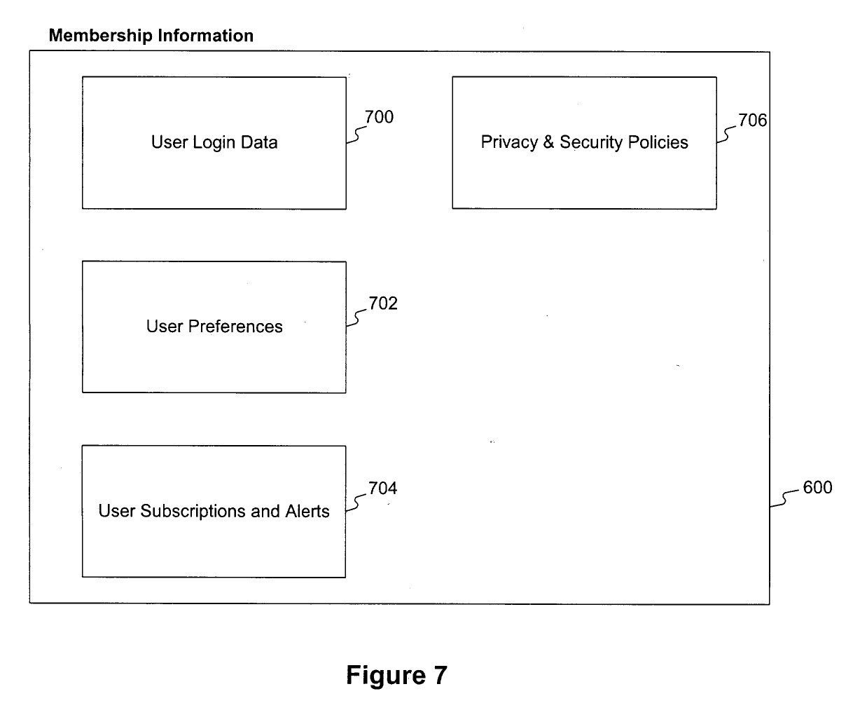

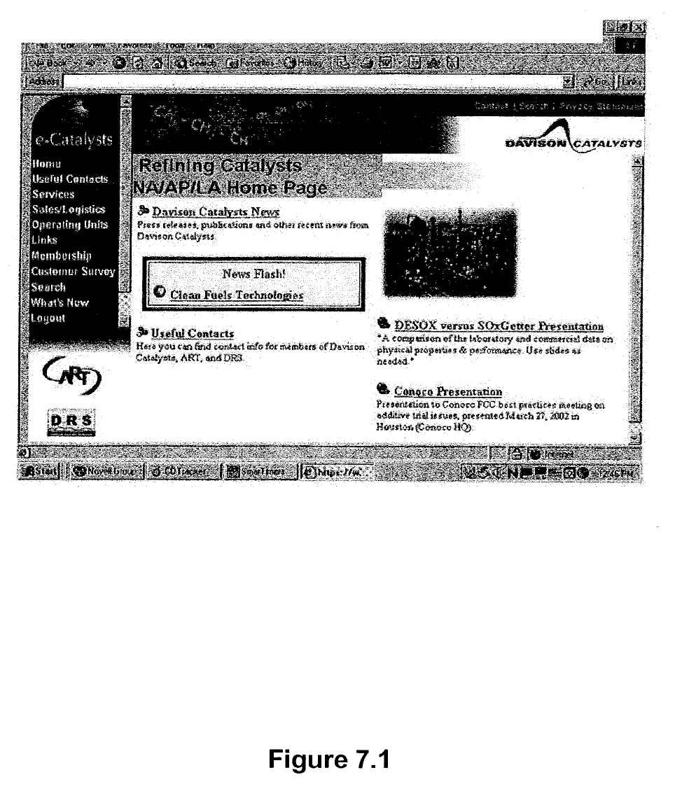

FIG. 7 is a block diagram of membership information in greater detail, consistent with an embodiment of the present invention. Membership information 600 may include user login data 700, user preferences 702, user subscriptions and alerts 704, and privacy and security policies 706. User login data 700 may include, for example, the information collected during the registration process described above. User preferences 702 may include, for example, customized home page information or access information for a user. User subscriptions and alerts 704 may include user-specific requests for subscriptions and/or alerts. For example, the user may be wish to be alerted whenever results of an analysis are available or whenever a new product becomes available. These types of requests would be stored in user subscriptions and alerts 704. Privacy and security policies 706 may include, for example, policies of the analysis service provider and/or the analysis service provider's website. Membership information 600 may be stored, for example, in database 502 and made available to customers via customer interface 500.

FIG. 7.1 is a sample registered user home page for a website consistent with an embodiment of the present invention. Once a user registers as a user of the analysis service provider's website, a new home page may be presented. In one embodiment, on the public home page (as shown in FIG. 6.1), a registered user may be given the option to enter a user name, such as an e-mail address, and a password and to click a button to log on to the site as a registered user. The registered user home page may then be displayed. The registered user home page may include, for example, links to news, useful contacts, and other pertinent information.

Using the registered user home page, a registered user may easily navigate among the services offered by the analysis service provider's website. A menu may list the various information available to registered users via customer interface 500. This information may include, for example, technical references, contact information, troubleshooting, and product ordering.

B. Technical Library

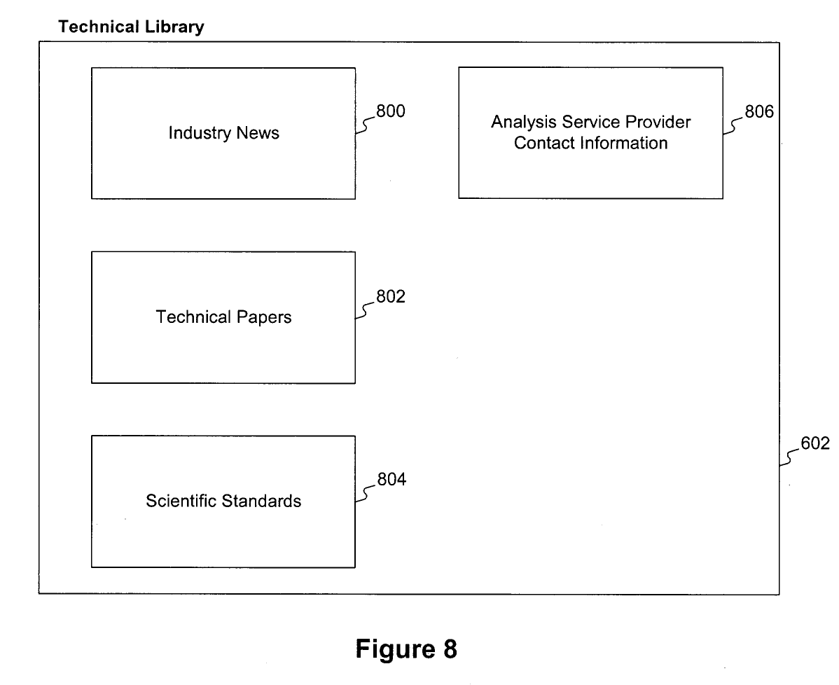

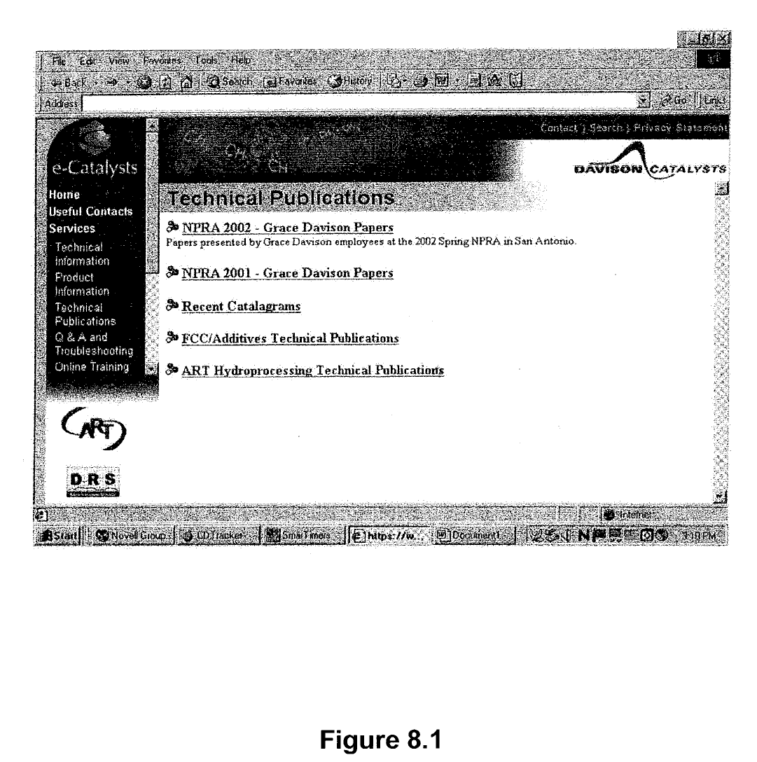

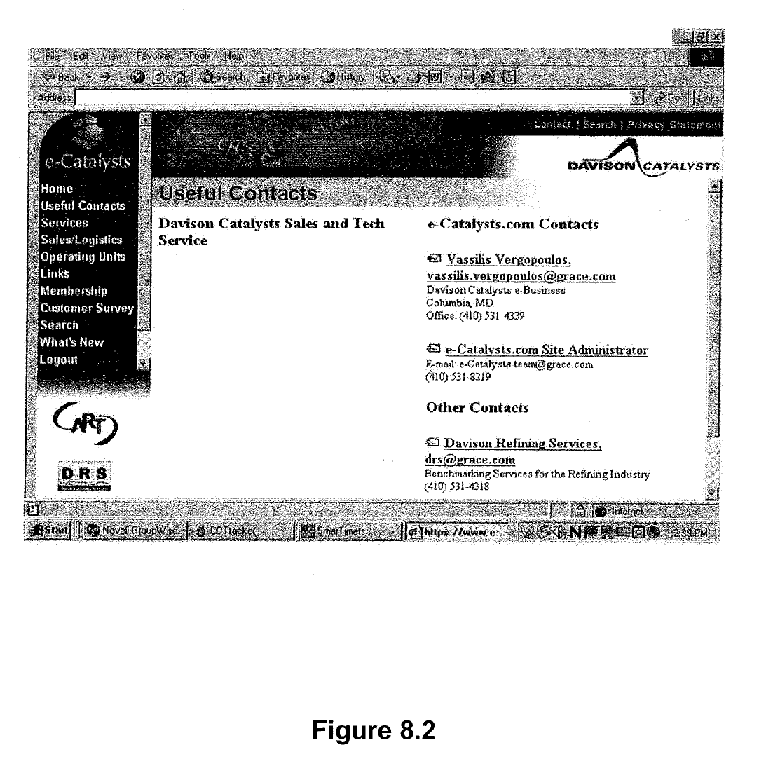

FIG. 8 is a block diagram of a technical library consistent with an embodiment of the present invention. Technical library 602 may include, for example, industry news 800, technical papers 802, scientific standards 804, and analysis service provider contact information 806. The information in technical library 602 may be stored in database 502 and made available to customers via customer interface 500.

FIG. 8.1 is a sample technical publications page for a website consistent with an embodiment of the present invention. Technical publications in technical library 602 may include, for example, technical papers and publications created by the analysis service provider or others in the industry. Other information in technical library 602 may include technical papers presented by analysis service provider employees, industry technical publications, and other publications.

FIG. 8.2 is a sample useful contacts page for a website consistent with an embodiment of the present invention. The useful contacts page may include, for example, analysis service provider contact information 706. Useful contacts may include, for example, contact information for various individuals or departments at the analysis service provider. The useful contacts page may include, for example, a contact person's name, e-mail address, department, address, and phone number. These contact listings may appear as links to the registered user. By choosing a contact person, for example, by clicking the contact person's name link, an e-mail may automatically open addressed to the contact person from the registered user.

C. Troubleshooting

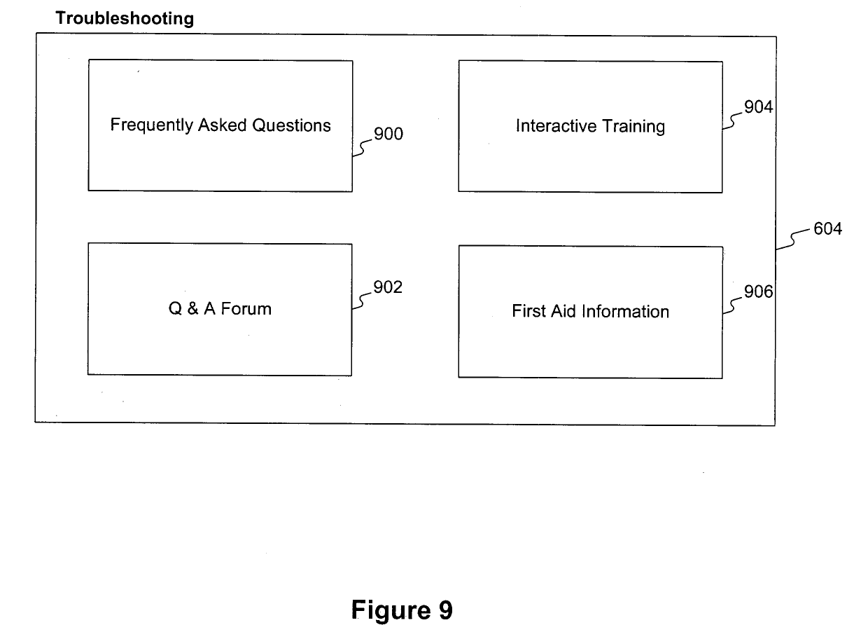

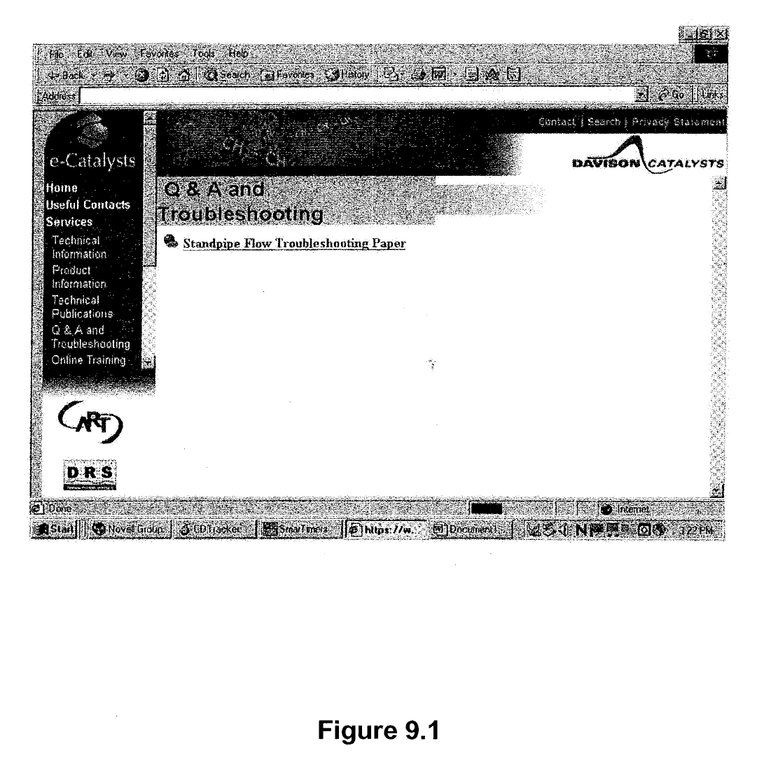

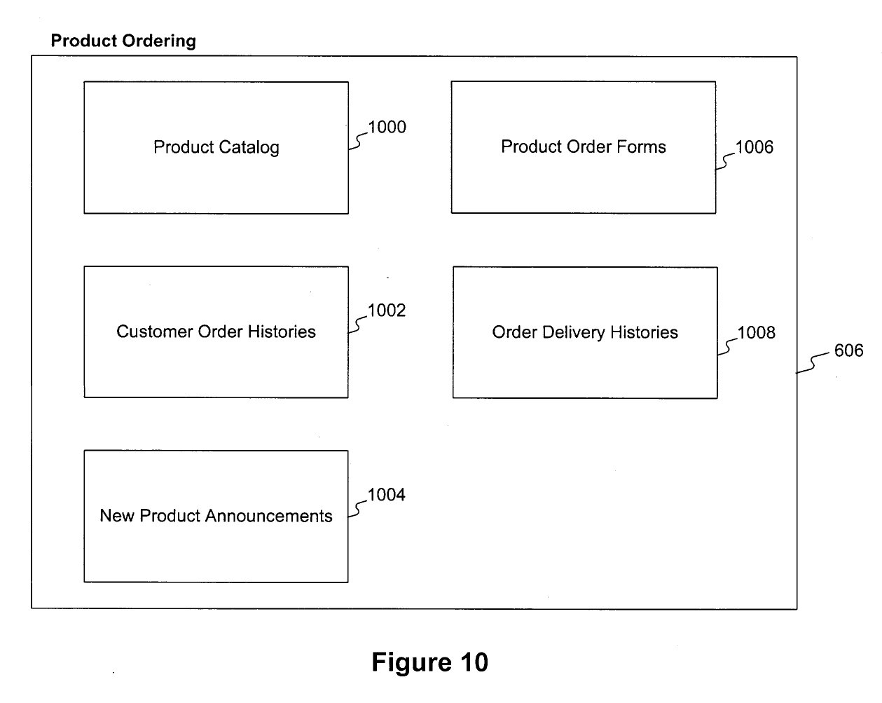

FIG. 9 is a block diagram of troubleshooting in greater detail consistent with an embodiment of the present invention. Troubleshooting 604 may include, for example, frequently asked questions 900, a Q&A forum 902, interactive training 904, and first aid information 906. Troubleshooting information 604 may be stored, for example, in database 502 and made available to the customer via customer interface 500.

FIG. 9.1 is a sample troubleshooting page for a website consistent with an embodiment of the present invention. The troubleshooting page may include any of the information available in troubleshooting 604, such as papers written by the analysis service provider or other parties for troubleshooting by customers.

D. Product Ordering

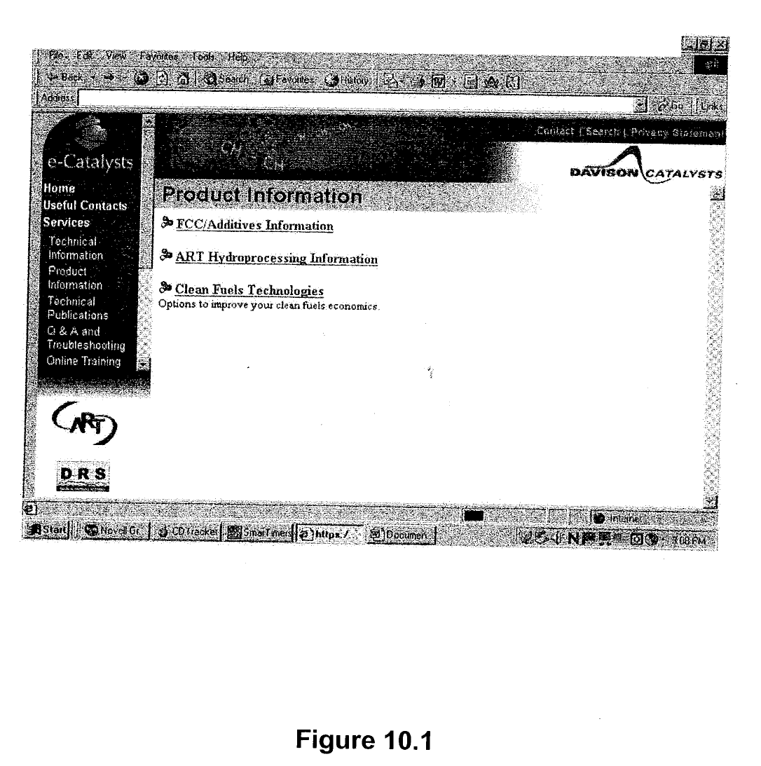

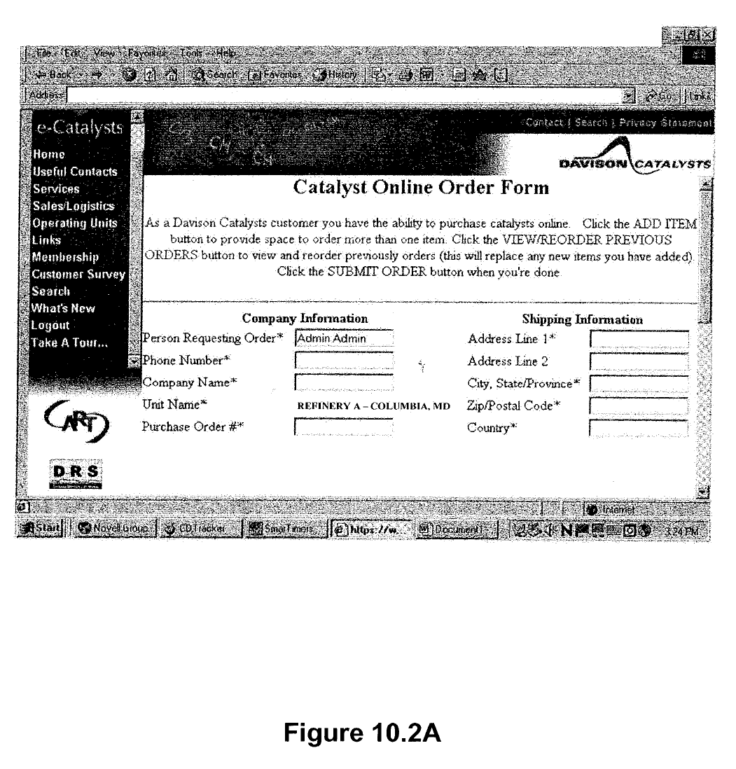

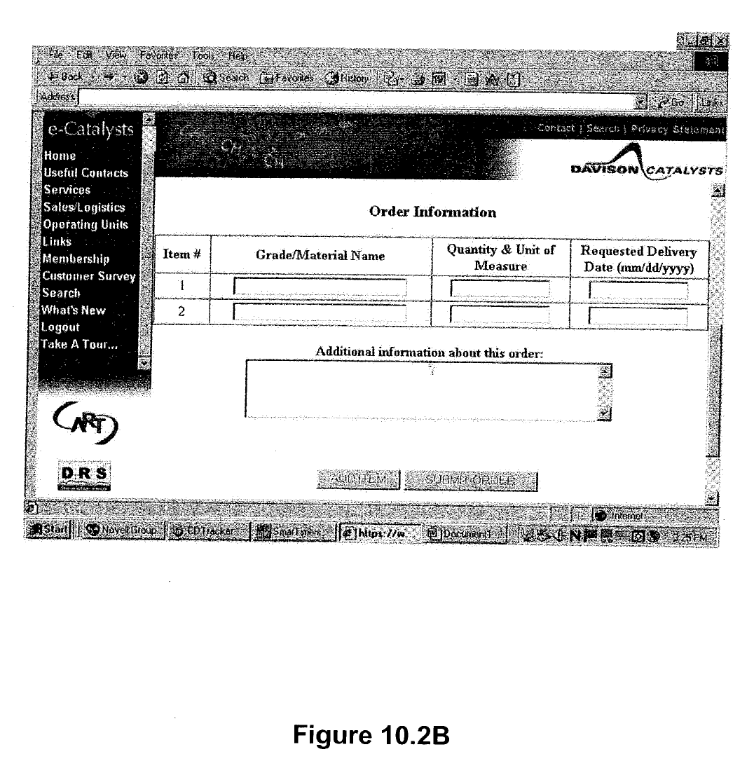

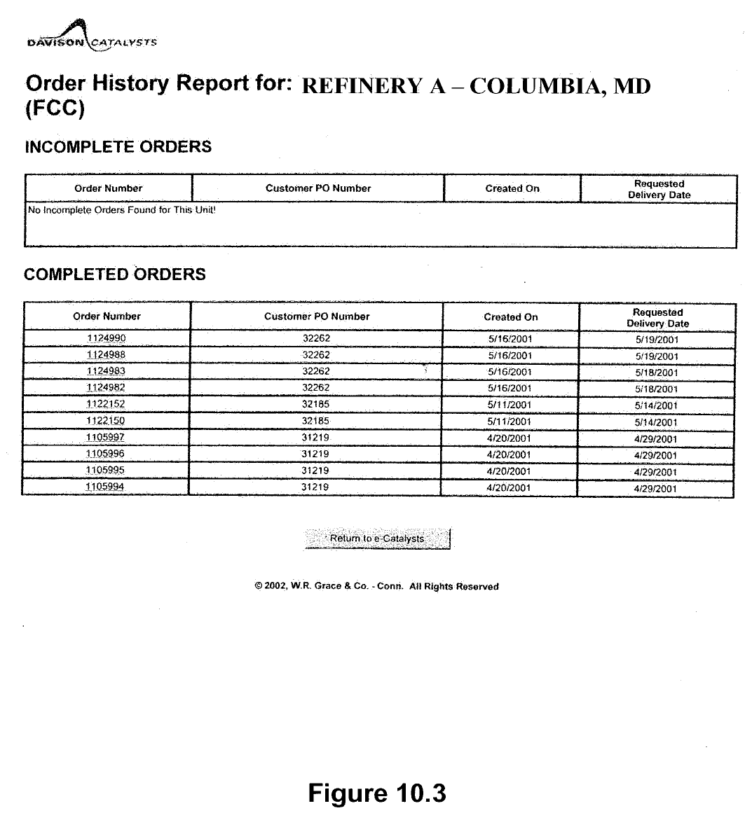

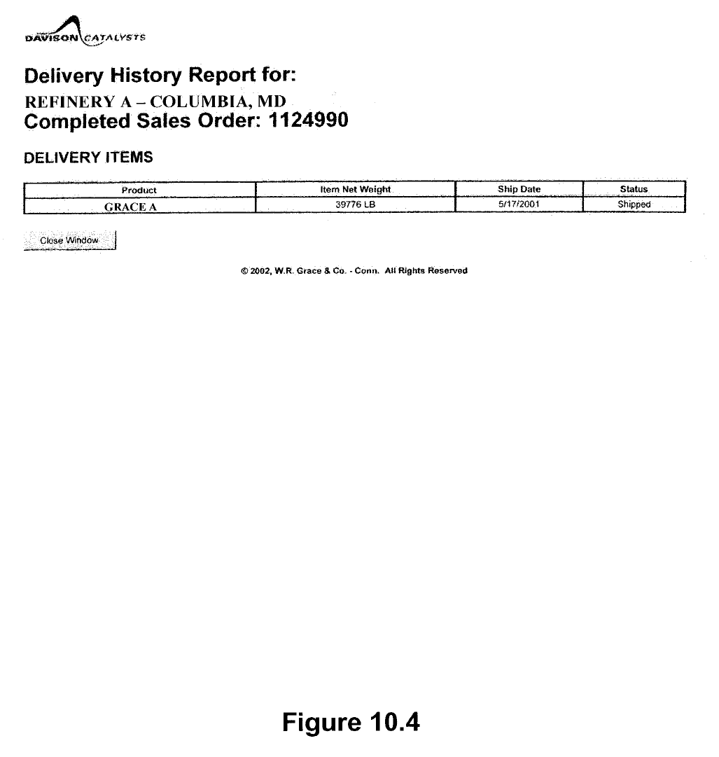

FIG. 10 is a block diagram of product ordering 606 in greater detail consistent with an embodiment of the present invention. Product ordering 606 may include, for example, a product catalog 1000, customer order histories 1002, new product announcements 1004, and product order forms 1006. Using product ordering 606, a user may browse products available for purchase, review products that the user has purchased in the past, keep abreast of the newest product announcements, and place orders electronically using product order forms.

FIG. 10.1 is a sample product information page for a website consistent with an embodiment of the present invention. The product information page may include, for example, information pertaining to product catalog 900.

FIG. 10.2 is a sample online order form for a website consistent with an embodiment of the present invention. The online order form may be stored in product order forms 1006 and made available via customer interface 500 to enable a user to place an order for catalysts or other substances. The online order form may include, for example, the person requesting the order, a phone number, the company or customer name, the unit name, the purchase order number, and shipping information. The online order form may also include a list of items to be ordered including an item number, grade or material name, quantity and unit of measure, and requested delivery date. The online order form may also include a window in which the user can enter additional information about this order. Using the online user form, the user may have the option to view previous orders or to reorder items previously purchased, for example by accessing customer order histories 1002.

FIG. 10.3 is a sample order history page for a website consistent with an embodiment of the present invention. The order history page may be displayed if a user requests to see an order history for a customer. The order history page may include, for example, incomplete orders and completed orders. For each order listed on the order history report, an order number, a customer PO number, date created, and requested delivery date may be displayed.

FIG. 10.4 is a sample delivery history report for a website consistent with an embodiment of the present invention. Each order number on an order history page may be a link to additional information about the order. For example, clicking on the purchase order number may display the delivery history report for a specific order. The delivery history report may include, for example, the product name, item net weight, ship date, and status. Data for the delivery history report may be included, for example, in order delivery histories 1008.

E. Emulation Mode

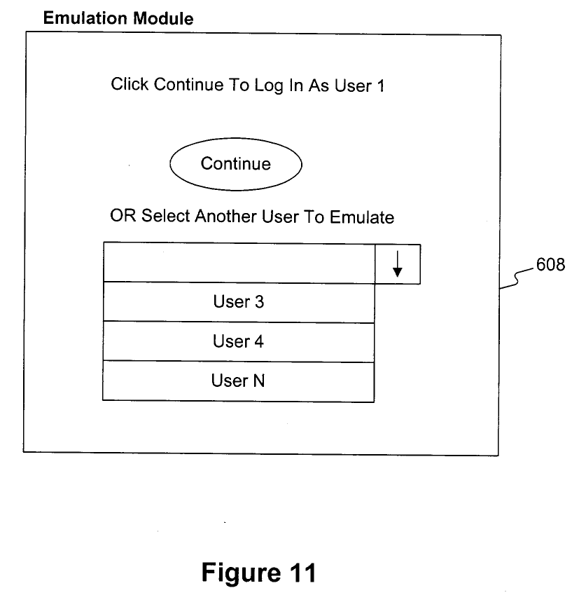

FIG. 11 is a sample screen for using an emulation process consistent with an embodiment of the present invention. Emulation module 608 enables a user to log on to analysis service provider 102 as another user. As shown in FIG. 11, the user may choose to continue to log-in as himself, e.g., User 1, or may select from a list of other possible users to emulate. The other users may be listed, for example, in a drop-down list. The emulation rules may be part of the user's membership information 602. For example, a supervisor may be permitted to emulate his employees in order to conduct business with analysis service provider 102. Also, a sales representative may be permitted to emulate any customer or any user with analysis server provider 102.

F. File Exchange

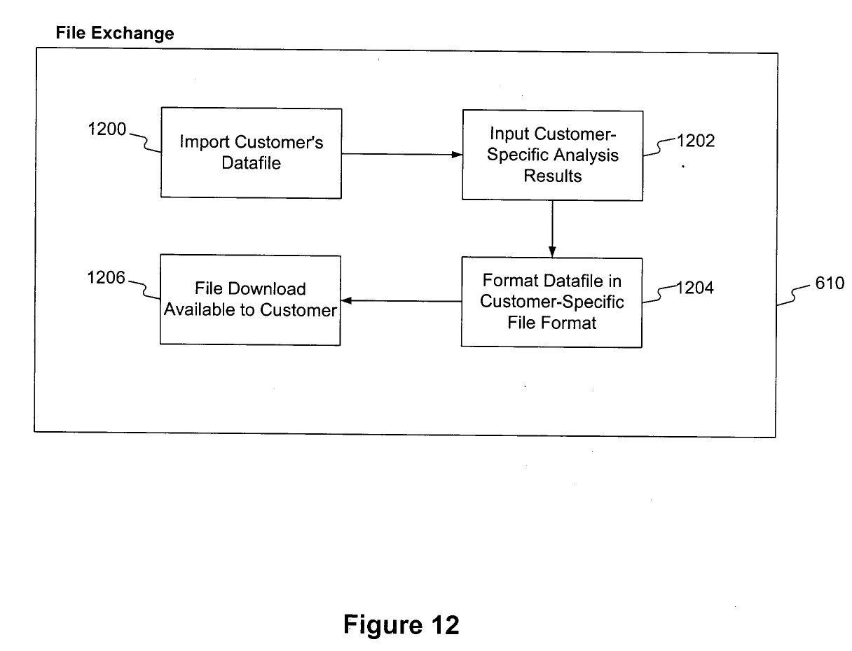

FIG. 12 is a block diagram of a file exchange process consistent with an embodiment of the present invention. Using the file exchange process, analysis service provider 102 may import a customer's datafile (Step 1200), input customer-specific analysis results, such as test results, into the datafile (Step 1202), format the datafile in a customer-specific file format (Step 1204), and make the formatted datafile file available for downloading to the customer (Step 1206). For example, the customer's datafile may be formatted as a spreadsheet using a spreadsheet program, such as Microsoft Excel. File exchange process 610 may further customize the datafile prior to making it available for download to the customer to ensure that the datafile will be operable on the customer's computer system. Customer-specific aspects of file exchange process 610 may be stored, for example, in user preferences 702.

G. Unit Operating Data Interface

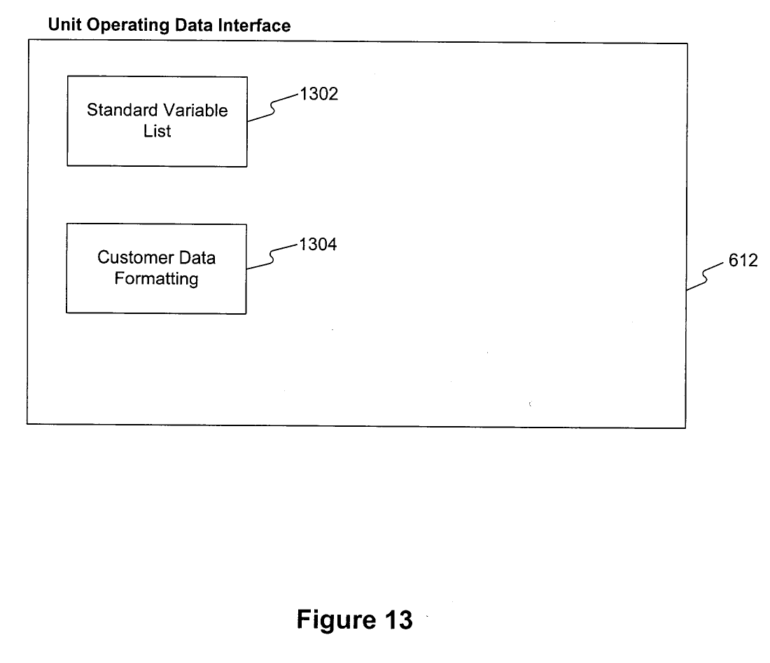

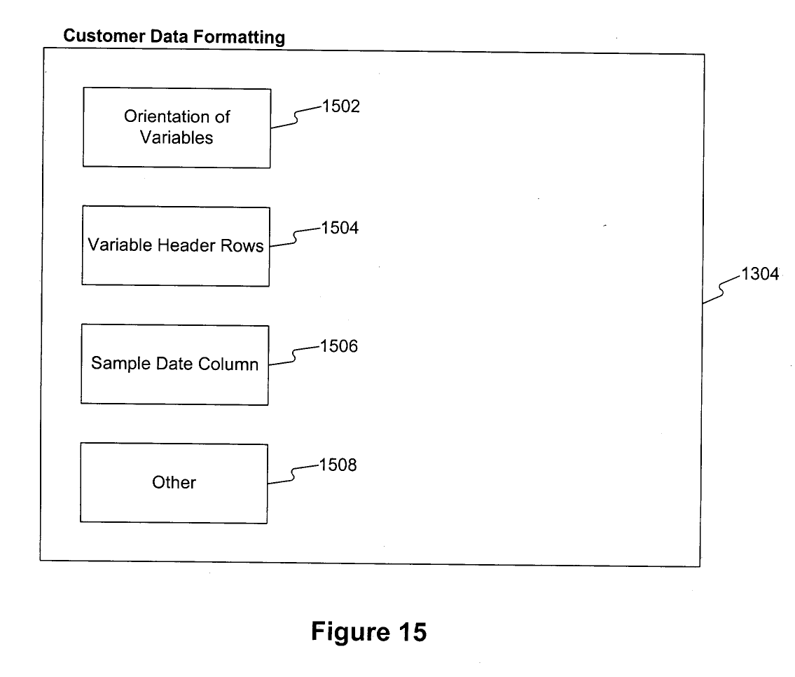

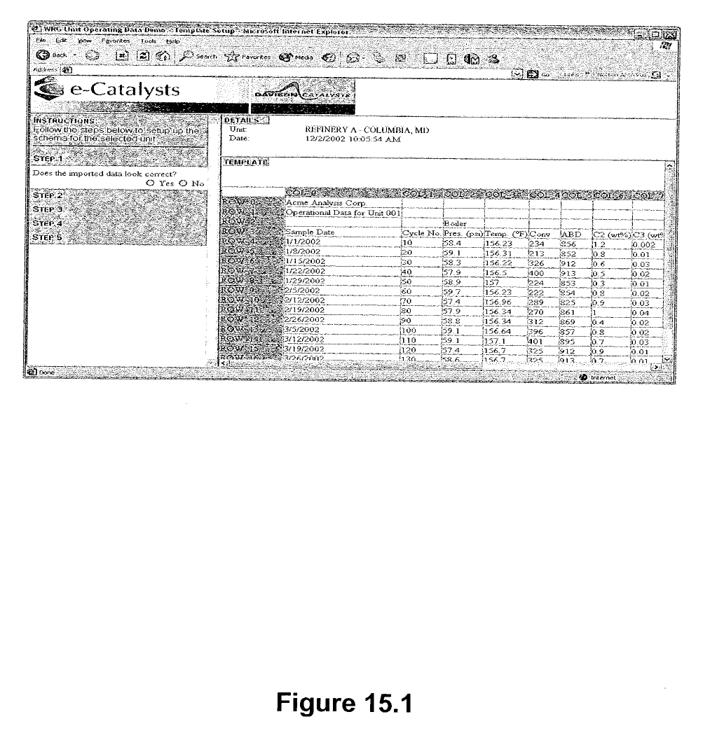

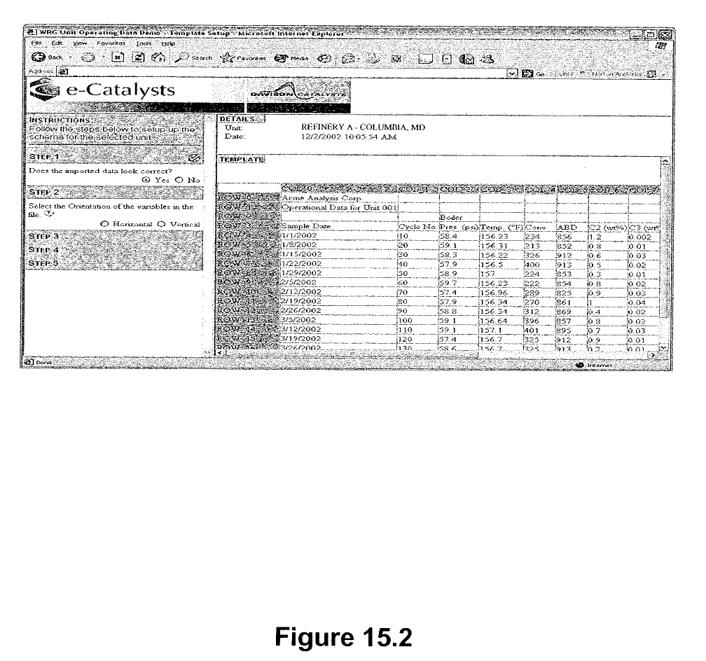

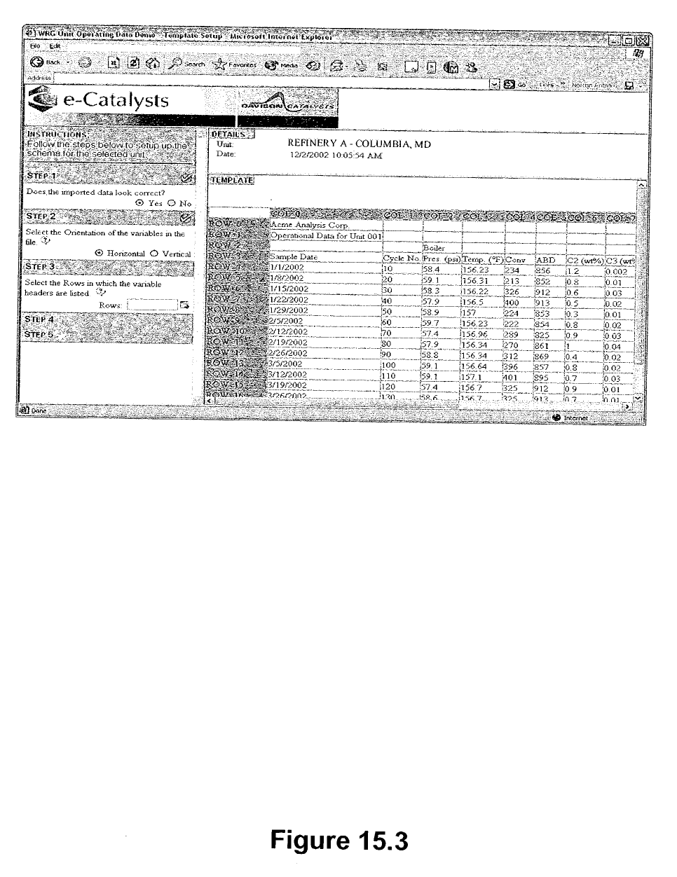

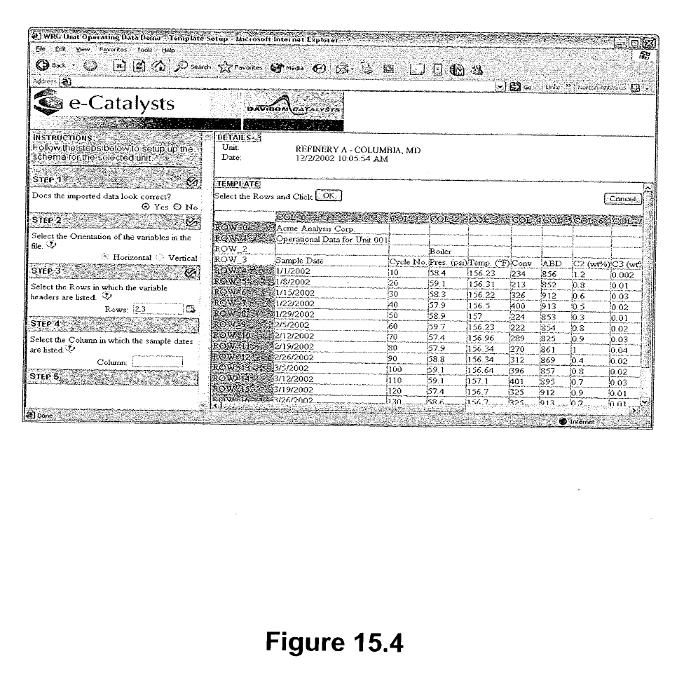

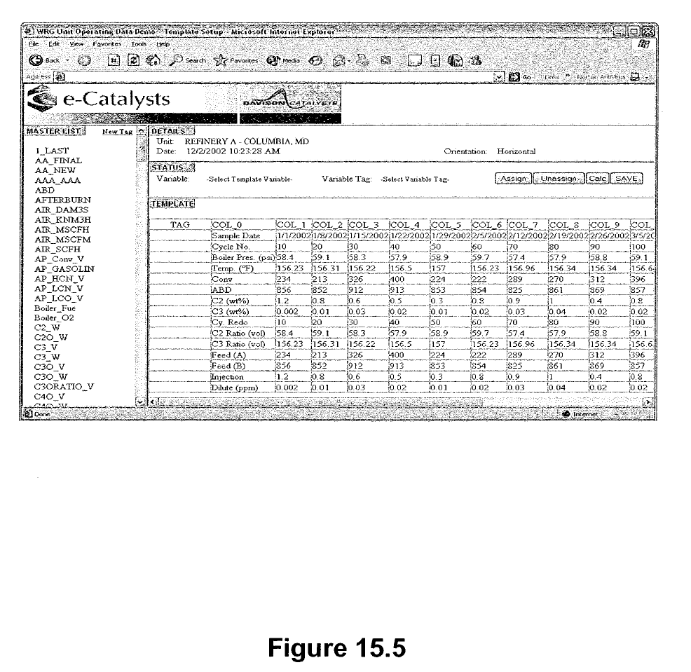

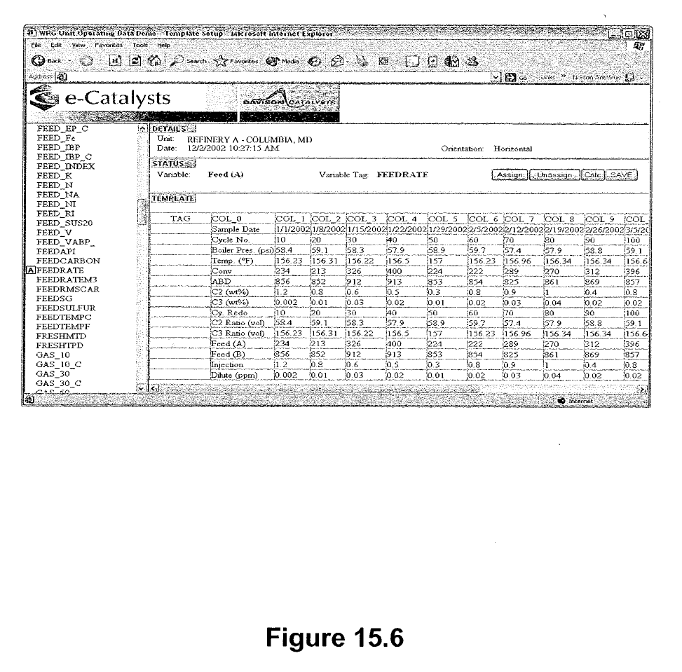

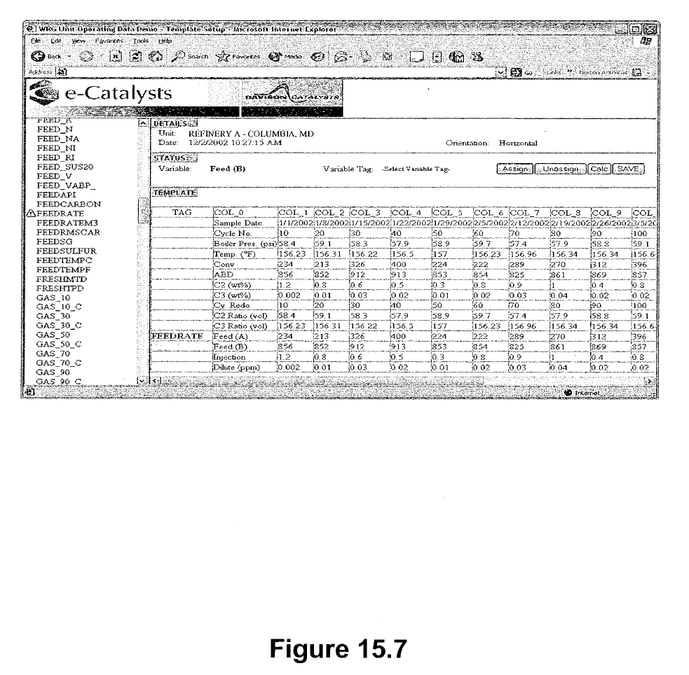

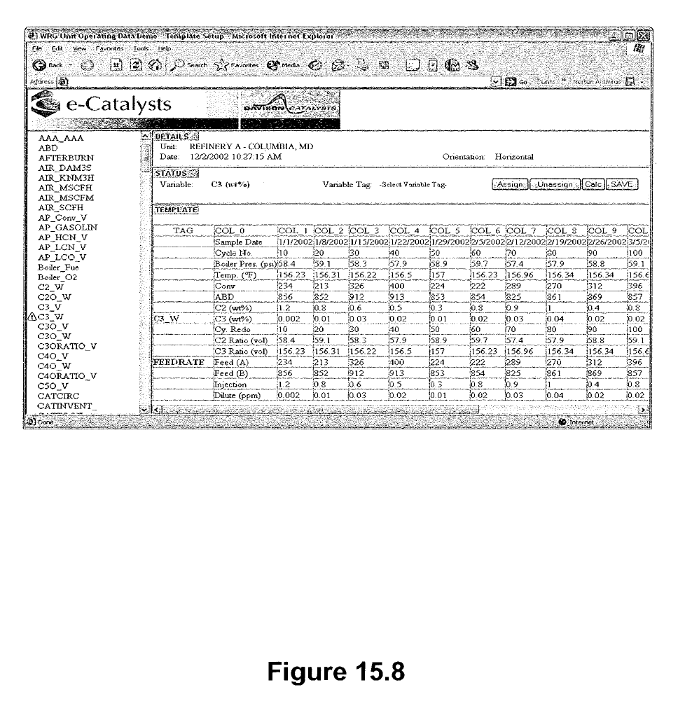

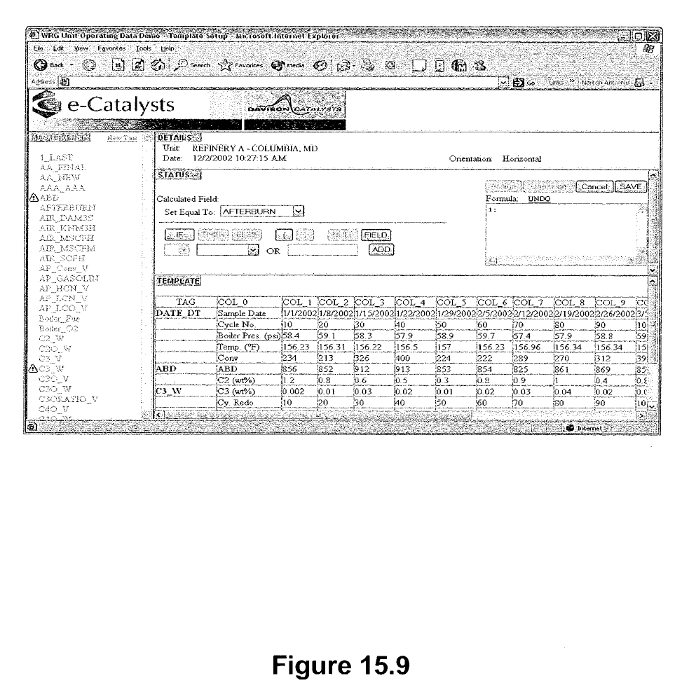

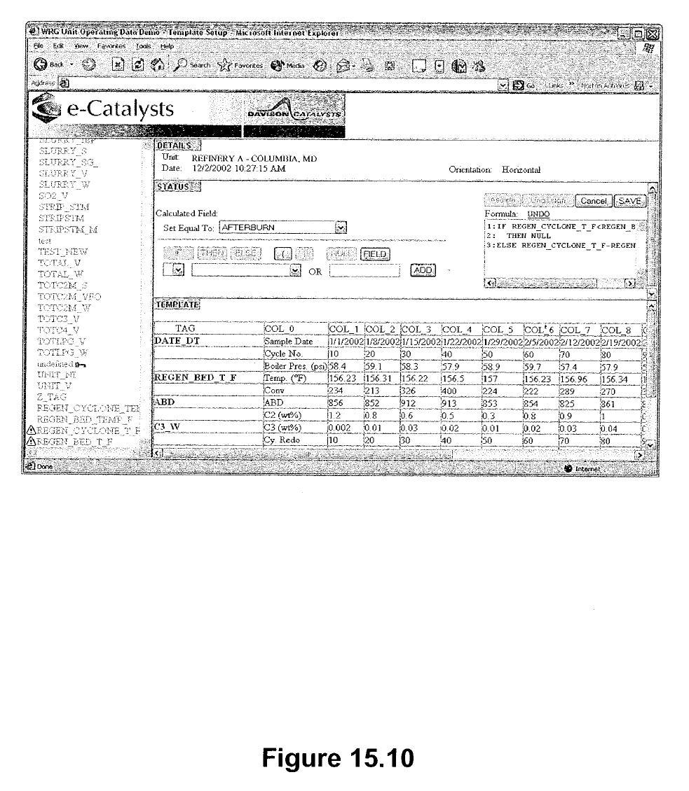

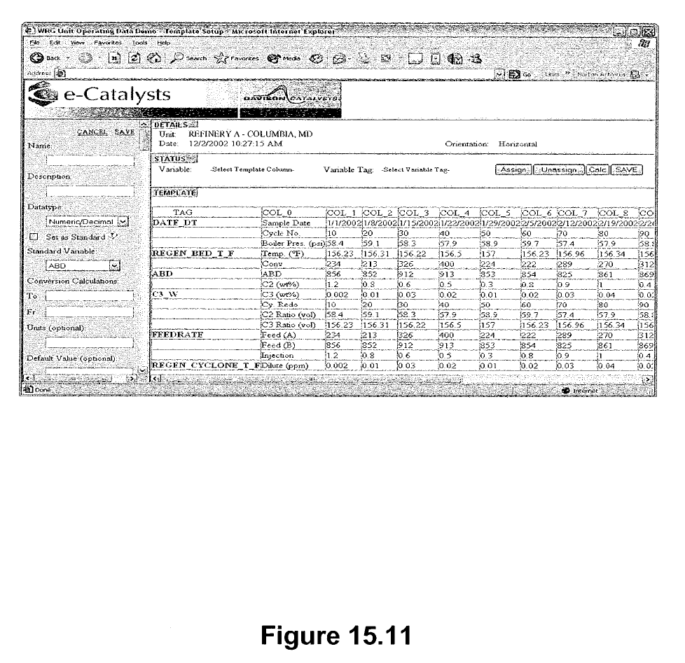

FIG. 13 is a block diagram of a unit operating data interface consistent with an embodiment of the present invention. Using unit operating data interface 612, a customer may send unit operating data to an analysis service provider for management and analysis. Unit operating data interface 612 may use a standard variable list 1302 and customer data formatting 1304 to translate unit operating data received from a customer into a standard format for analysis, as described below with reference to FIG. 15.

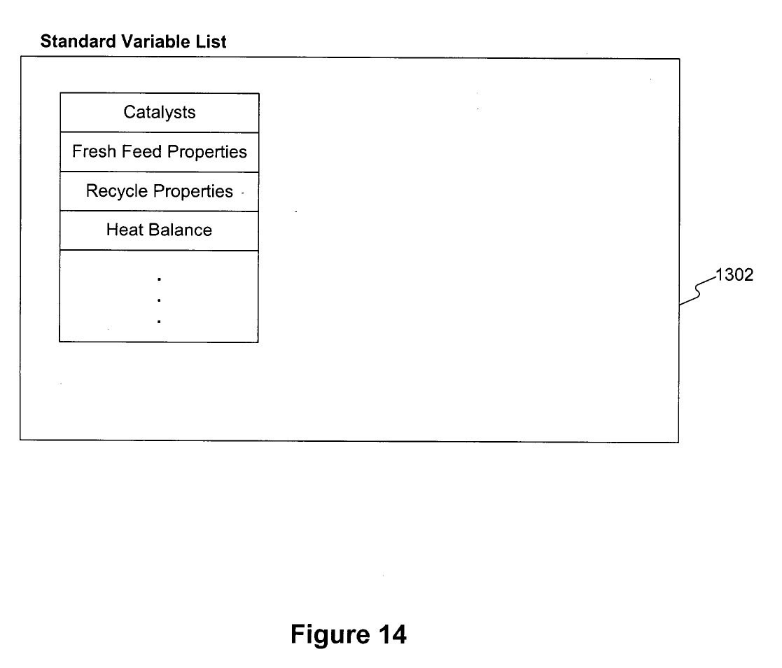

FIG. 14 is a block diagram of a standard variable list consistent with an embodiment of the present invention. A standard variable list 1302 may include, for example, catalysts, fresh feed properties, recycle properties, heat balance, etc. Unit operating data interface 612 may use standard variable list 1302 to specify standard data contents and formats for use in automatic calculations and analyses. Table 1, appended at the end of this specification, includes a sample of a standard variable list 1302.

FIG. 15 is a block diagram of customer data formatting consistent with an embodiment of the present invention. Unit operating data interface 612 may use customer data formatting 1304 to translate data received in a customer-specific format into data in a standard format for processing. In one embodiment, the customer may only need to provide customer data formatting 1304 once. Thereafter, the customer may simply submit unit operating data in a customer-specific format and unit operating data interface 612 may use the formatting information to automatically reformat the unit operating data into a standard format for quick and easy analysis.

FIG. 15.1 is a sample set-up tool for customer data formatting for a website consistent with an embodiment of the present invention. The set-up tool may be stored in unit operating data interface 612 and made available via customer interface 500 to enable a customer to provide data formatting information. The set-up tool may include a details section including a unit identifier and a date and a template section including unit operating data received from the customer. The set-up tool may also include a series of instruction steps to assist the customer in providing data formatting information. In step one, the customer may be asked to determine whether the imported data looks correct.

FIG. 15.2 is another sample set-up tool for customer data formatting for a website consistent with an embodiment of the present invention. In step two of the set-up tool instructions, the customer may be asked to select an orientation of variables, e.g., horizontal or vertical, in the file. For example, the unit operating data as imported in the customer-specific data format may include variables arranged in different ways.

FIG. 15.3 is another sample set-up tool for customer data formatting for a website consistent with an embodiment of the present invention. In step three of the set-up tool instructions, the customer may be asked to select the rows or columns in which variables headers are listed. For example, the unit operating data as imported in the customer-specific data format may include variable headers in any row or column.

FIG. 15.4 is another sample set-up tool for customer data formatting for a website consistent with an embodiment of the present invention. In step four of the set-up tool instructions, the customer may be asked to select the rows or columns in which sample dates are listed. For example, the unit operating data as imported in the customer-specific data format may include sample dates in any row or column. After the customer has completed steps one through four, the customer may select a button marked “Process” (not shown) to proceed to a data mapping screen.

FIG. 15.5 is a sample data mapping screen for customer data formatting for a website consistent with an embodiment of the present invention. Once the customer has completed steps one through four and selected the “Process” button, the data is reformatted into a standard data format and displayed as a data table, as shown in FIG. 15.5. The data mapping screen may include a details section including a unit identifier, a date, and an orientation, e.g., horizontal or vertical. The data mapping screen may also include a status section containing data mapping instructions and tools for creating custom calculations, described in detail below. The data mapping screen may further include a master list section including, for example, standard variable list 1302 and standard units of measurement and a template section including unit operating data received from the customer.

FIG. 15.6 is a sample data mapping screen showing data mapping instructions for customer data formatting for a website consistent with an embodiment of the present invention. To map the customer's data to the standard variable list, a customer may select, or “tag,” a cell, such as “Feed(A)” shown in FIG. 15.6, and select the corresponding variable from the standard variable list, such as “FEEDRATE” shown in FIG. 15.6. Both the tag (e.g., “Feed(A)”) and the standard variable (e.g., “FEEDRATE”) appear in the status section of the data mapping screen. To confirm the mapping, the customer may select the “Assign” button, as shown in FIG. 15.6.

FIG. 15.7 is a sample data mapping screen showing confirmed data mapping instructions for customer data formatting for a website consistent with an embodiment of the present invention. Once the customer has mapped a tag (e.g., “Feed(A)”) to a standard variable (e.g., “FEEDRATE”) and selected the “Assign” button, the standard variable will be marked as mapped in the standard variable list, as shown in FIG. 15.7.

FIG. 15.8 is another sample data mapping screen showing data mapping instructions for customer data formatting for a website consistent with an embodiment of the present invention. In this embodiment, a customer may simply select a tag (e.g., “C3 (wt %)”) and double-click on the standard variable (e.g., “C3_W”) to speed up the mapping process. To remove a mapping, the user may select both the tag and the standard variable and select the “Unassign” button.

FIG. 15.9 is a sample calculation screen for customer data formatting for a website consistent with an embodiment of the present invention. A customer may select a “Calc” button in a data mapping screen (e.g., the sample data mapping screen shown in FIG. 15.8) to activate a formula builder utility to create mathematical and/or logical formulas to calculate the values of standard variables. For example, to create a mathematical and/or logical formula to calculate the value of a standard variable, the customer may select the standard variable to be calculated (e.g., “AFTERBURN”).

FIG. 15.10 is another sample calculation screen for customer data formatting for a website consistent with an embodiment of the present invention. Once the customer has selected the standard variable to be calculated (e.g., “AFTERBURN”), the customer may use a formula builder to create a mathematical and/or logical formula to calculate the value of the standard variable, such as:

1: IF REGEN_CYCLE_T_F<REGEN_BED_T_F

2: THEN NULL

3: ELSE REGEN_CYCLE_T_F-REGEN-BED_T_F

In this embodiment, the customer may simply click on one or more variables in the standard variable list to simplify formula creation.

FIG. 15.11 is a sample new variable creation screen for customer data formatting for a website consistent with an embodiment of the present invention. A customer may select a new variable to be created by selecting the “New Tag” variable from the standard variable list button in a data mapping screen (e.g., the master list section shown in FIG. 15.5), which activates a new variable creation screen to create a new variable. The new variable creation screen may include a name, description, and data type. The new variable creation screen may also include a check-box to enable the customer to designate the new variable as a standard variable and a drop-down list to enable the customer to choose a standard variable as a basis for the new variable. The new variable creation screen may also include conversion calculations, units, and a default value.

As described above, the set-up tools described in FIGS. 15.1-15.11 are used by a customer to provide customer data formatting 1304. However, one skilled in the art will appreciate that another entity, such as analysis service provider 102, may use these set-up tools to establish customer data formatting 1304 at a unit operating data interface 612. Furthermore, in an embodiment of the present invention, the data mapping process described in FIGS. 15.1-FIG. 15.11 may be performed only once per customer, enabling a customer to submit unit operating data multiple times without having to re-format the data each time.

III. Database

FIG. 16 is a block diagram of a database in greater detail, consistent with an embodiment of the present invention. Database 502 may store any data used by analysis service provider 102, including customer data 1600, industry data 1602, and unit operating data 1604. Customer data 1600 and unit operating data 1604 may correspond to a plurality of customers. Database 502 may also include, for example, web pages used by customer interface 500, digital certificate software used by security module 504, standard reports used by reporting module 508, and calculations used by analysis module 506 (not shown).

IV. Security

FIG. 17 is a block diagram of a security module in greater detail, consistent with an embodiment of the present invention. Security module 504 may include user authentication information 1700 and general public access information 1702. In this way, members of the general public may access some parts of analysis service provider 102 while only authorized users may access other parts.

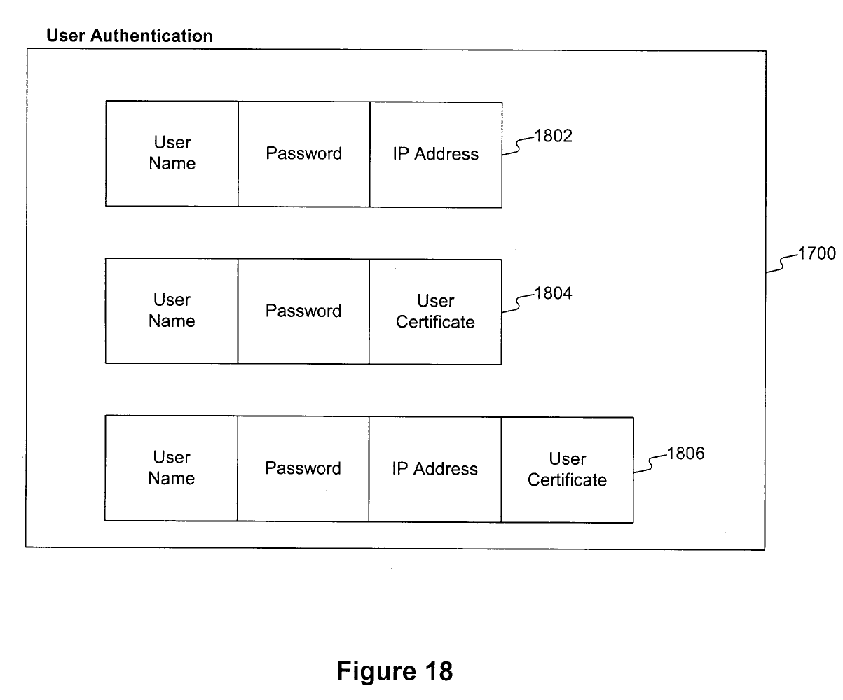

FIG. 18 is a block diagram of user authentication information 1700 in greater detail, consistent with an embodiment of the present invention. To ensure security of data used by analysis service provider 102, a user may be authenticated in a number of ways. For example, a user authentication may require a user name, password, and Internet protocol (IP) address. As described above, the IP address may relate to the physical address of the user's computer. The user may also be authenticated, for example, by a user name, password, and user certificate. For greater security, the user may be authenticated with a user name, password, IP address, and user certificate. One skilled in the art will recognize that other user authentication technology may also be implemented by security module 504.

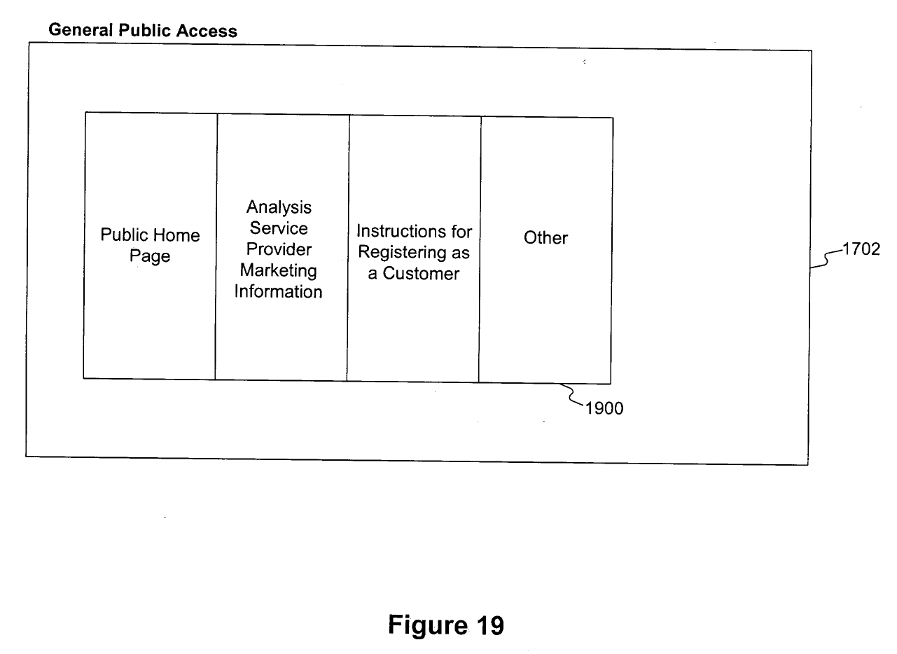

FIG. 19 is a block diagram of general public access information 1702 in greater detail, consistent with an embodiment of the present invention. General public access data 1702 may include a list 1900 of items available to the general public. For example, list 1900 may include webpages available to the general public such as a public home page, marketing information, and instructions for registering as a registered customer or user. One skilled in the art will recognize that other items may be included in list 1900 and/or general public access data 1702.

V. Analysis Module

FIG. 20 is a block diagram of an analysis module in greater detail, consistent with an embodiment of the present invention. In an embodiment of the present invention, customers 100 provide samples 200 and/or unit operating data 201 to analysis service provider 102. Analysis service provider 102 may use analysis module 506 to analyze the samples and/or unit operating data. Analysis module 506 may include, for example, analysis tools 2000, industry analysis 2002, customer specific analysis 2004, and unit operating data analysis 2006. Once analysis has been performed, customers may view the results in a number of ways using reporting module 508, as described in greater detail below.

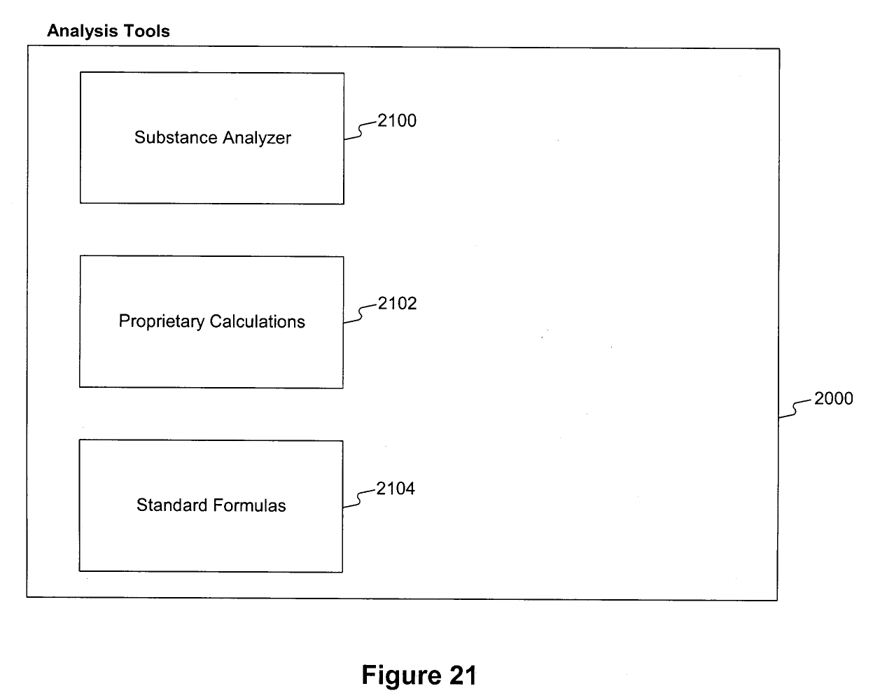

FIG. 21 is a block diagram of analysis tools in greater detail, consistent with an embodiment of the present invention. Analysis tools 2000 may include, for example, a substance analyzer 2100, proprietary calculations 2102, and standard formulas 2104. Substance analyzer 2000 may analyze a substance using proprietary calculations 2102 and standard formulas 2104. In an embodiment of the present invention, the customers may access the results of the analysis without having access to proprietary calculations 2102.

A. Industry Analysis

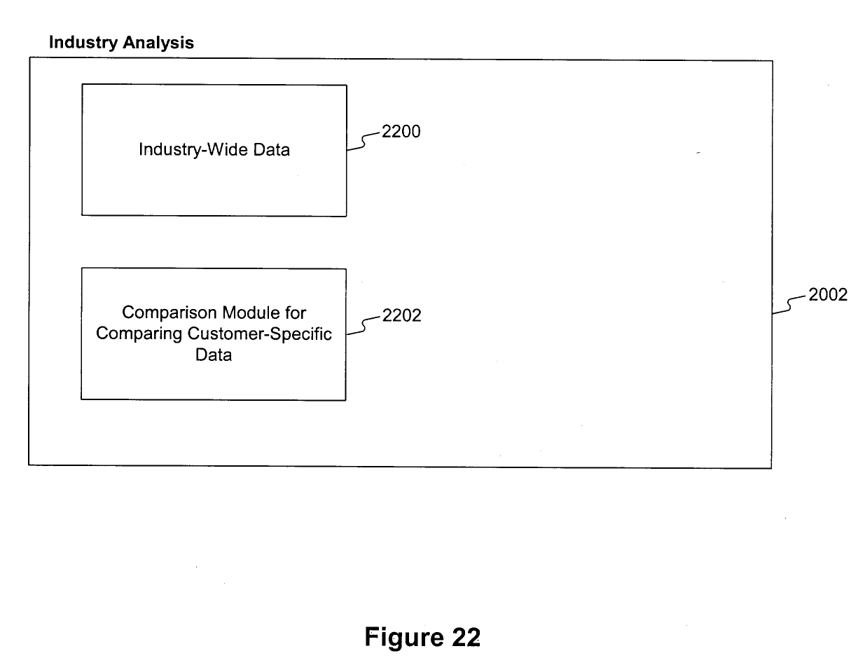

FIG. 22 is a block-diagram of industry analysis in greater detail, consistent with an embodiment of the present invention. Industry analysis 2000 may include, for example, industry-wide data 2200 and a comparison module for comparing customer-specific data 2202. For example, when customers submit samples for testing, the test results may be stored in industry-wide data 2200. In addition to analysis of individual customers' test results, all of the test results may be analyzed to produce an industry-wide analysis, such as an industry average or industry mean, also stored in industry-wide data 2200. In another example, unit operating data submitted by customers may be stored in industry-wide data 2200. In addition to analysis of individual customers' unit operating data, all of the unit operating data may be analyzed to produce an industry-wide analysis and stored in industry-wide data 2200. A customer may then use comparison module 2202 to compare its own test results to those of others in a given industry or to industry-wide results.

B. Customer-Specific Analysis

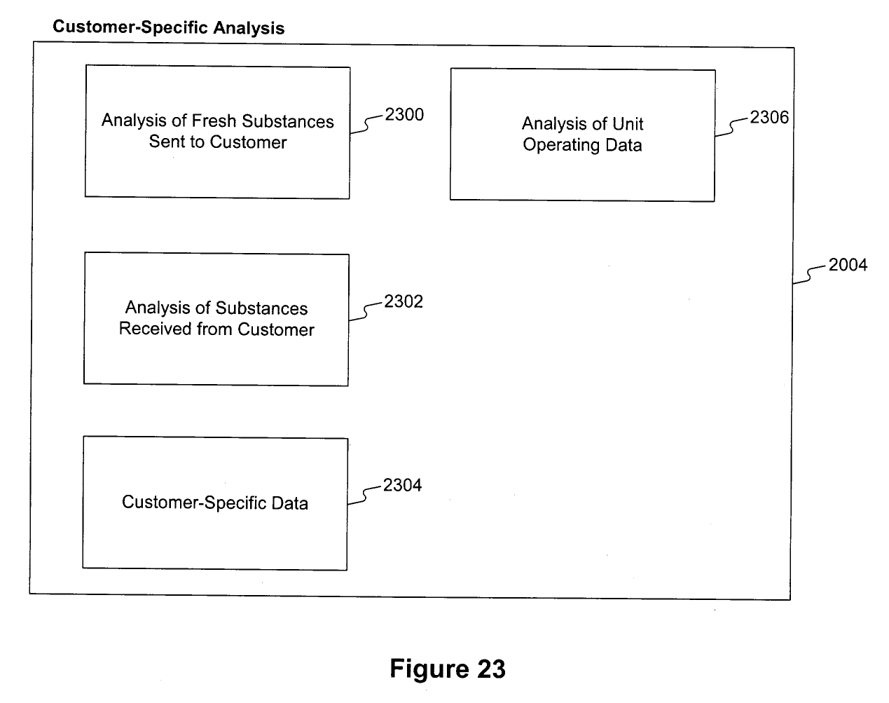

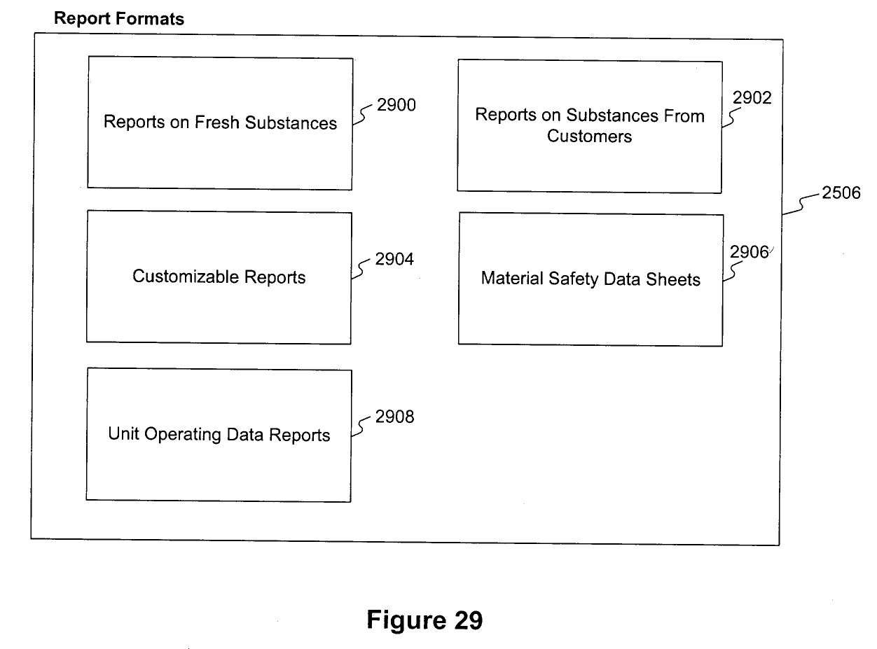

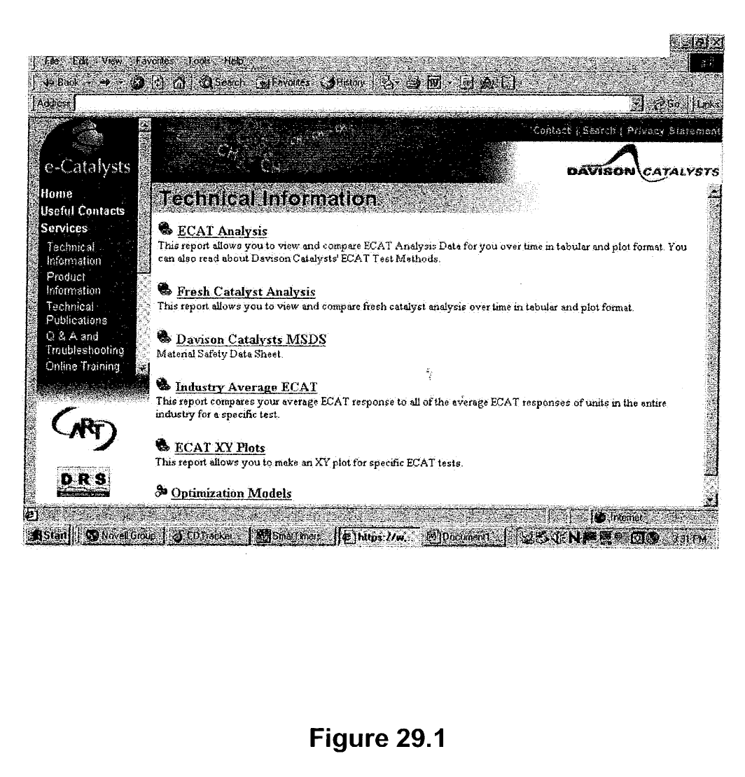

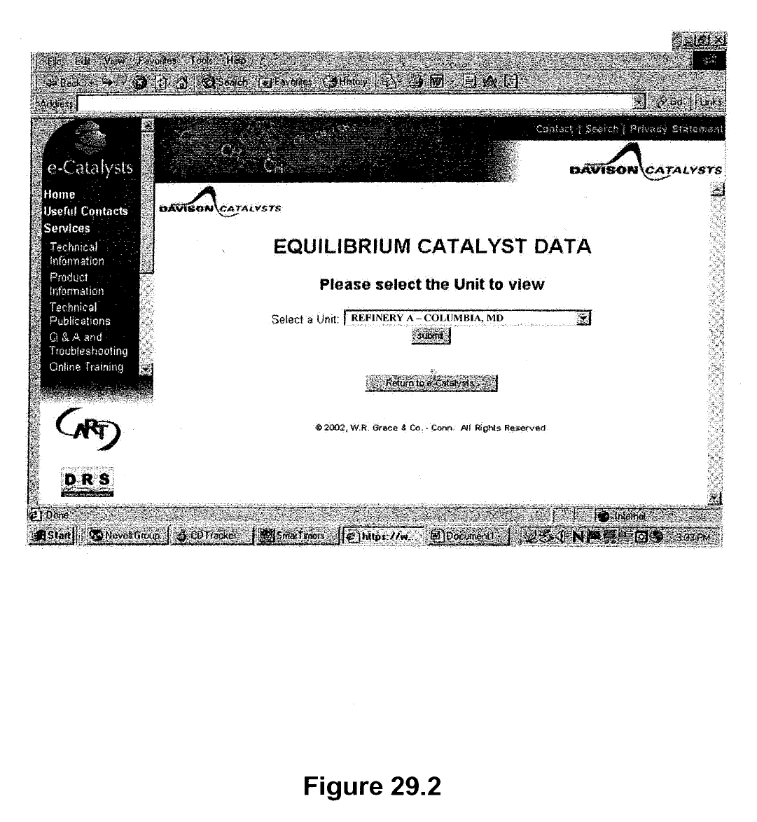

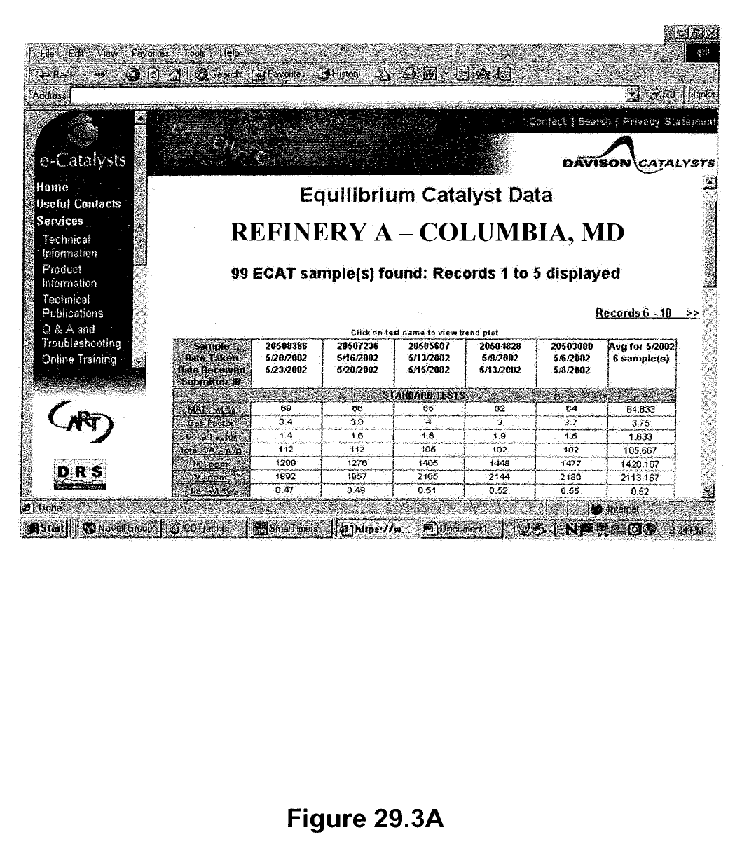

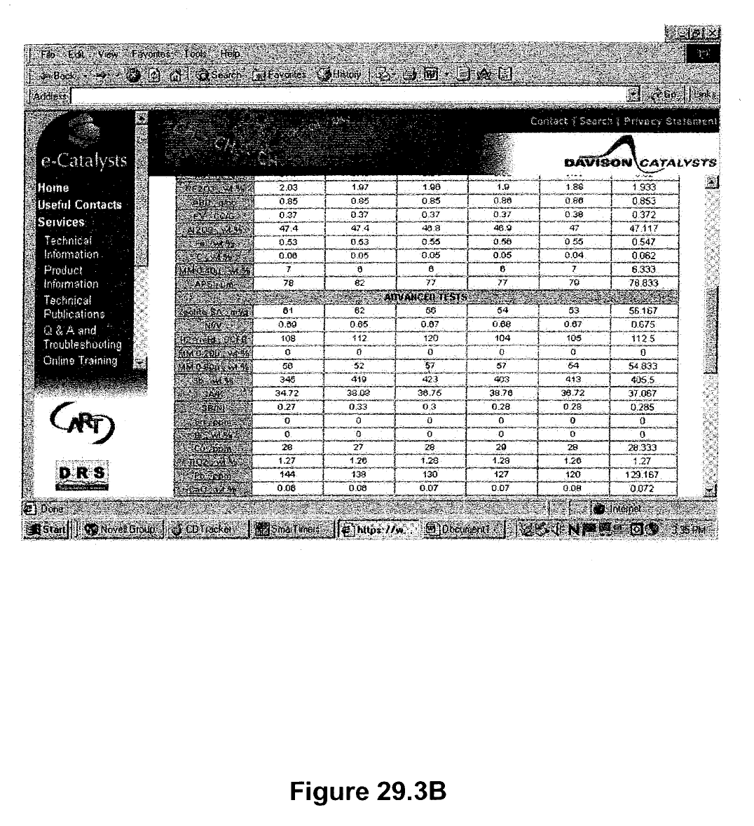

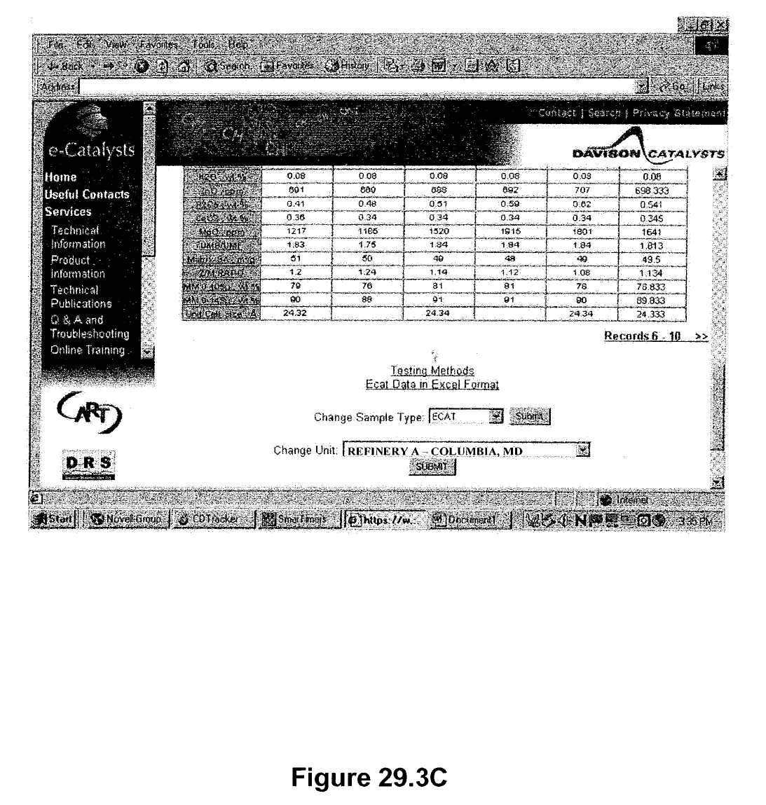

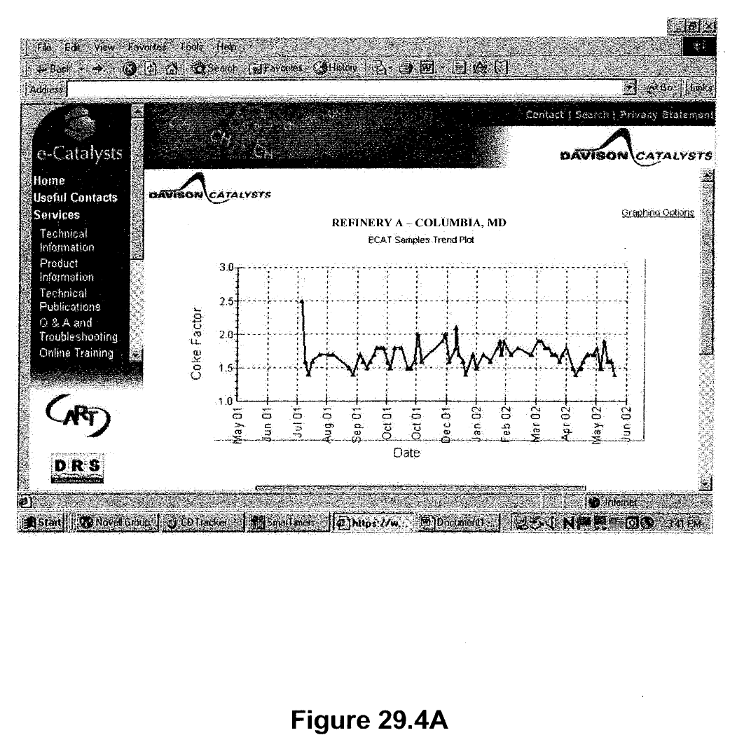

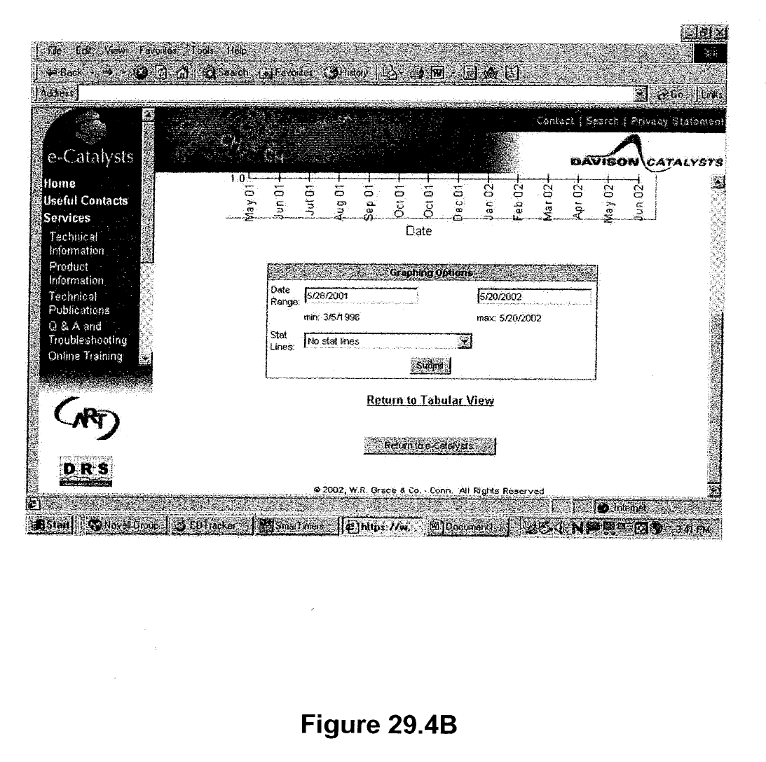

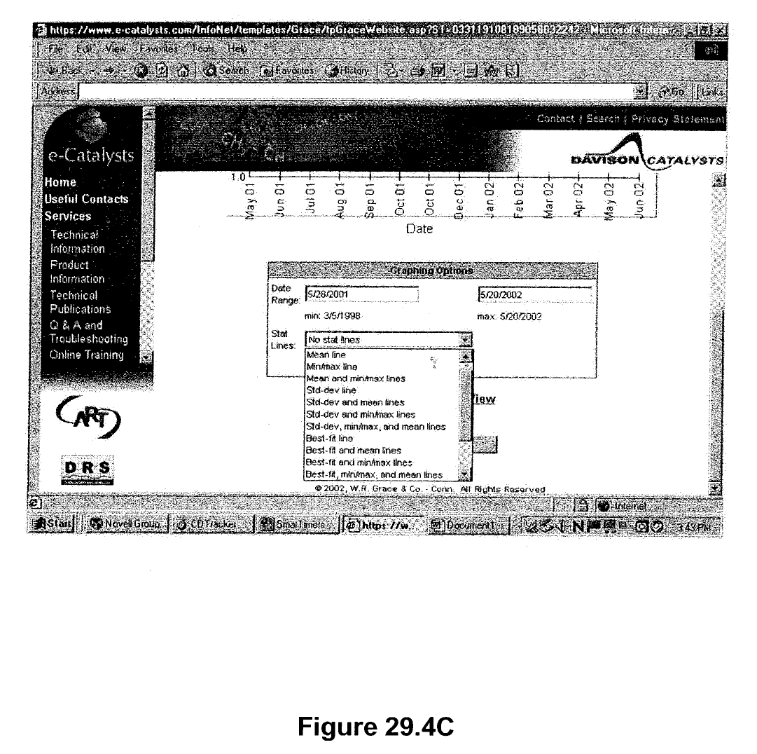

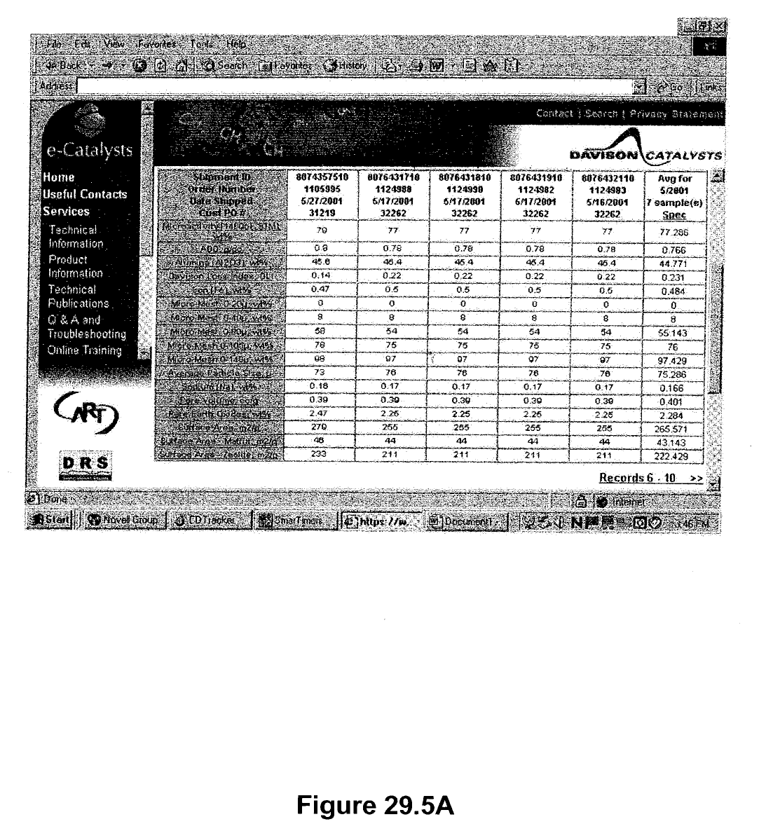

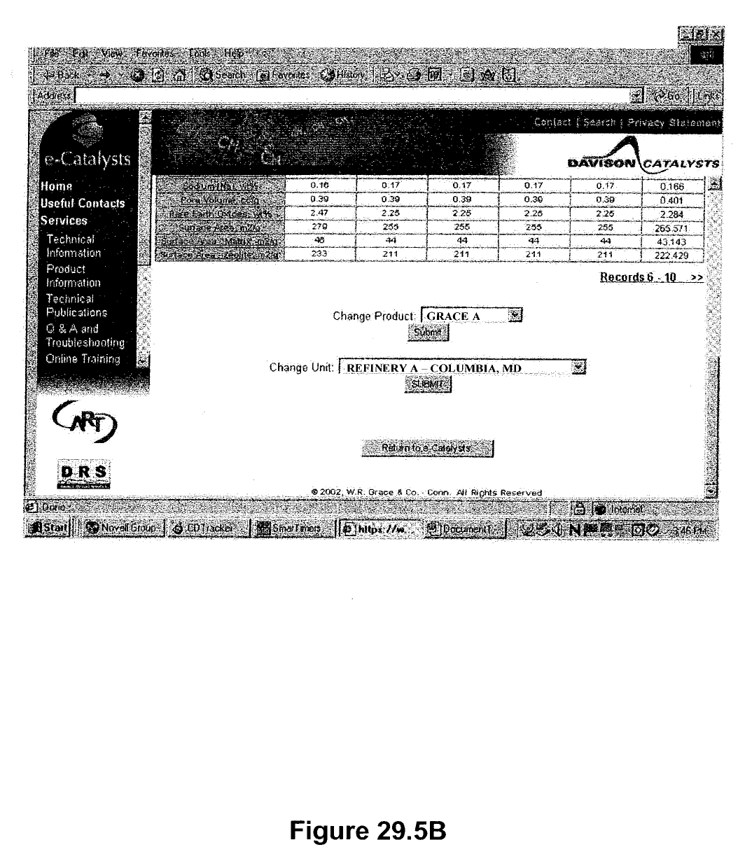

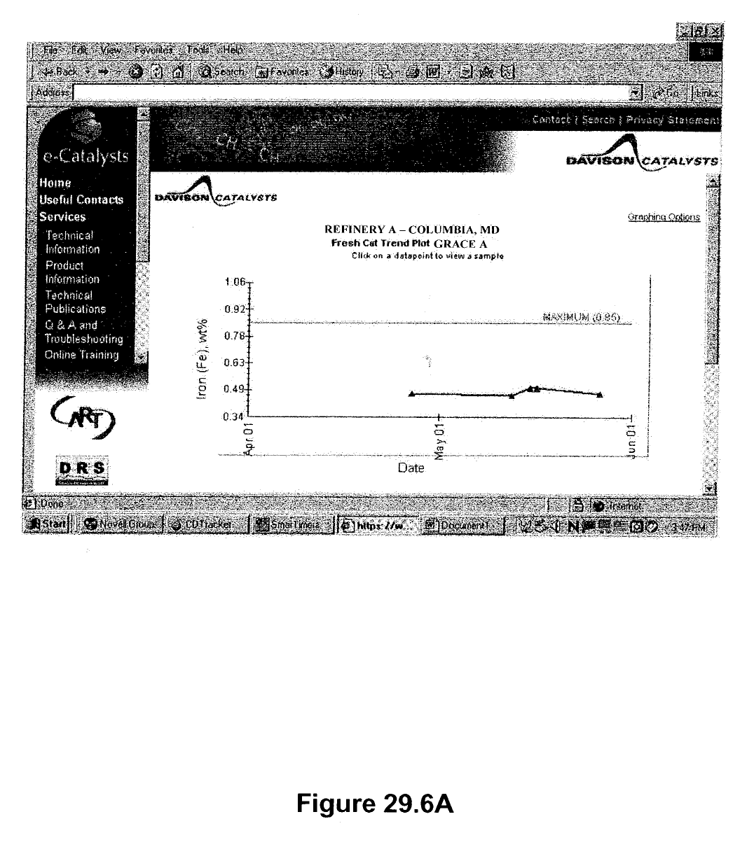

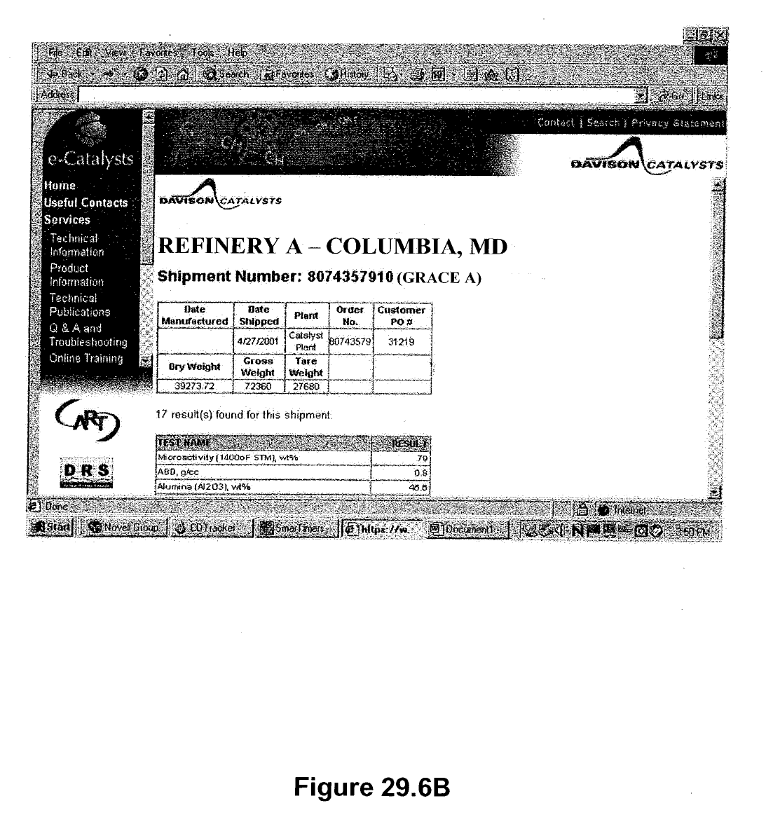

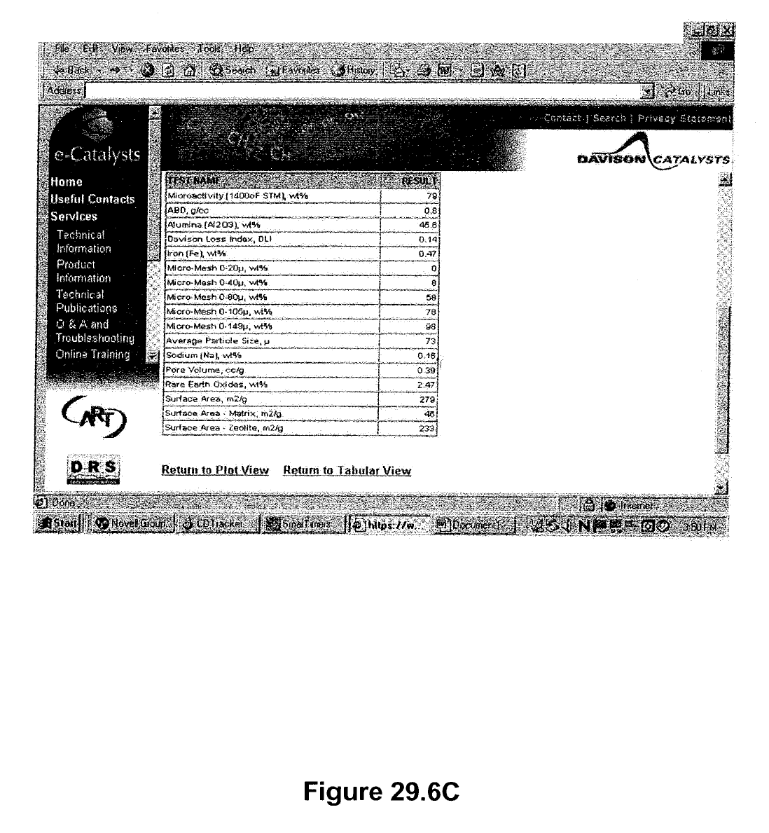

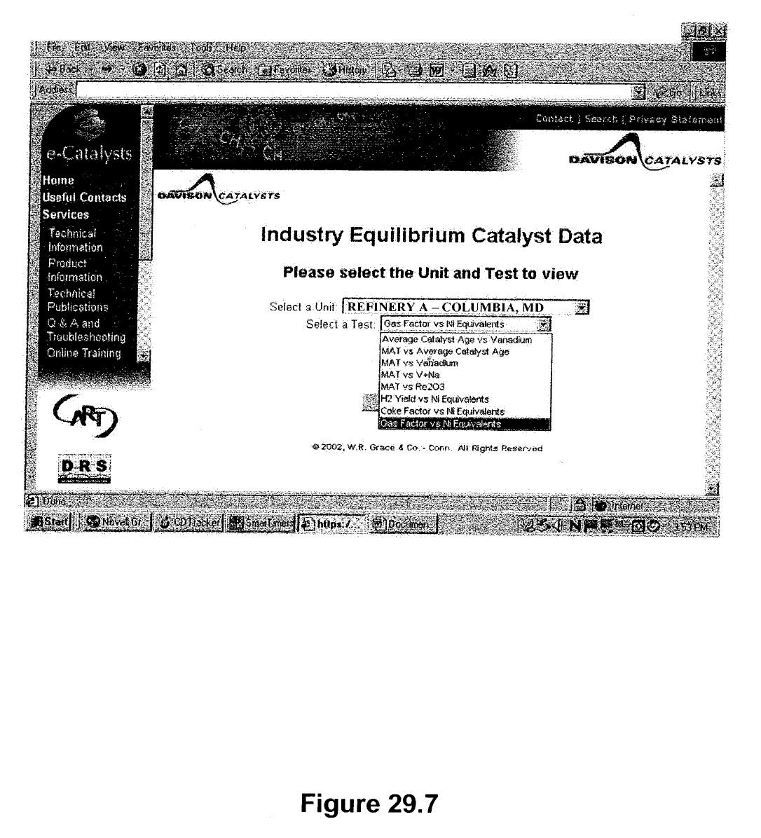

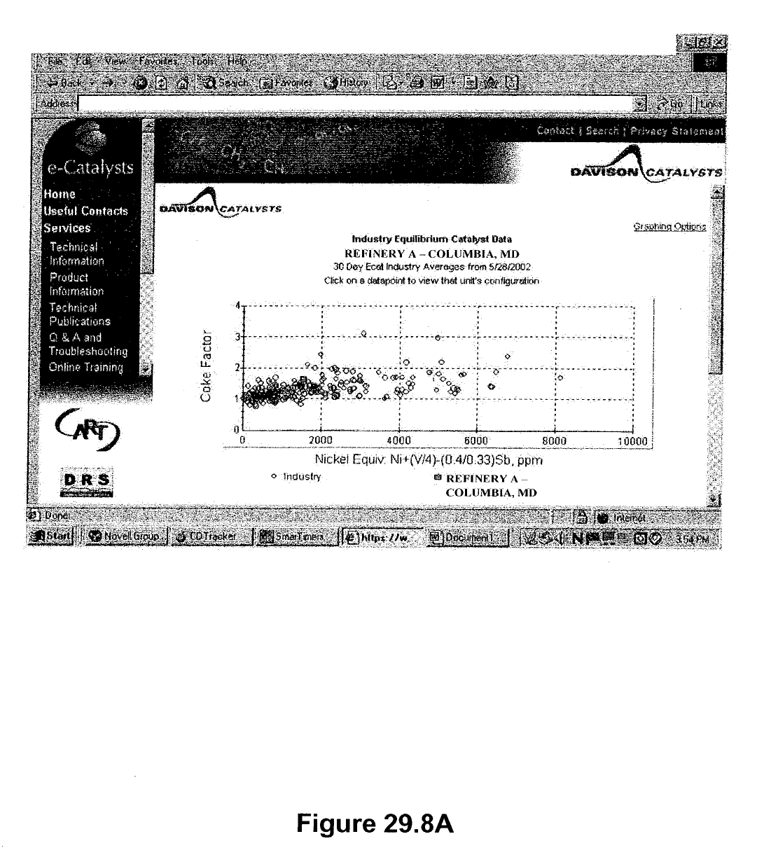

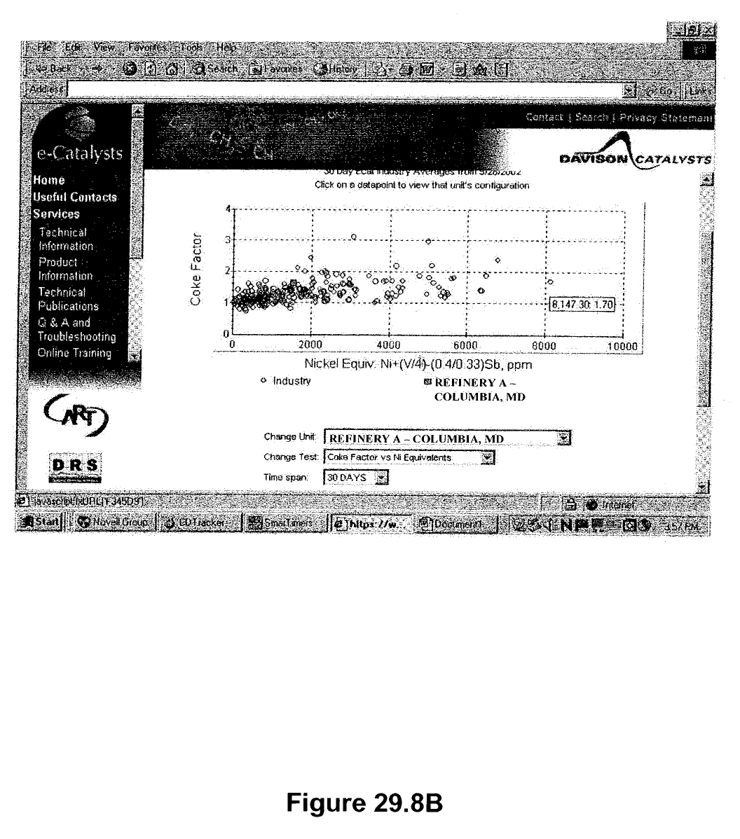

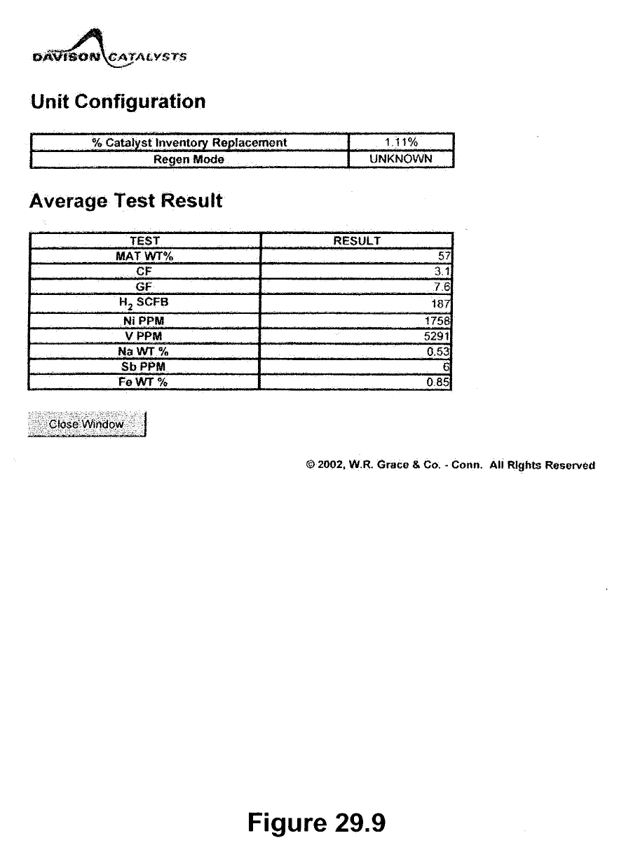

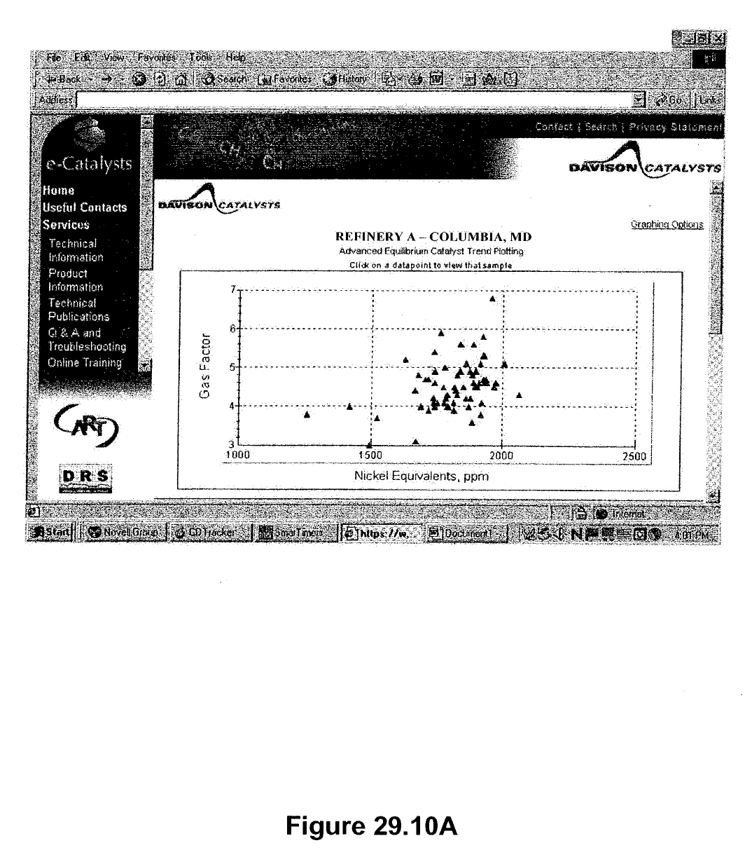

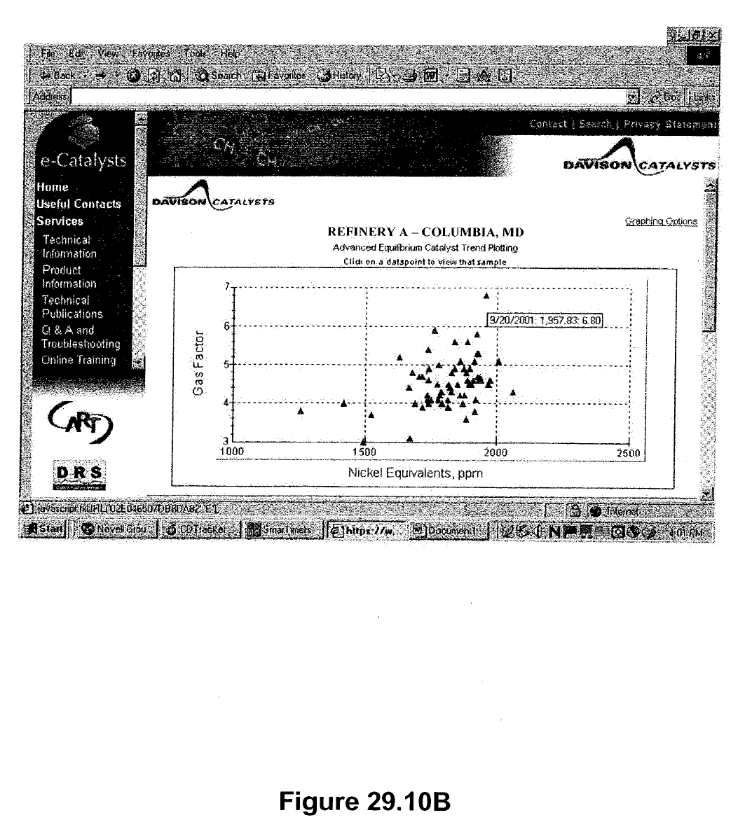

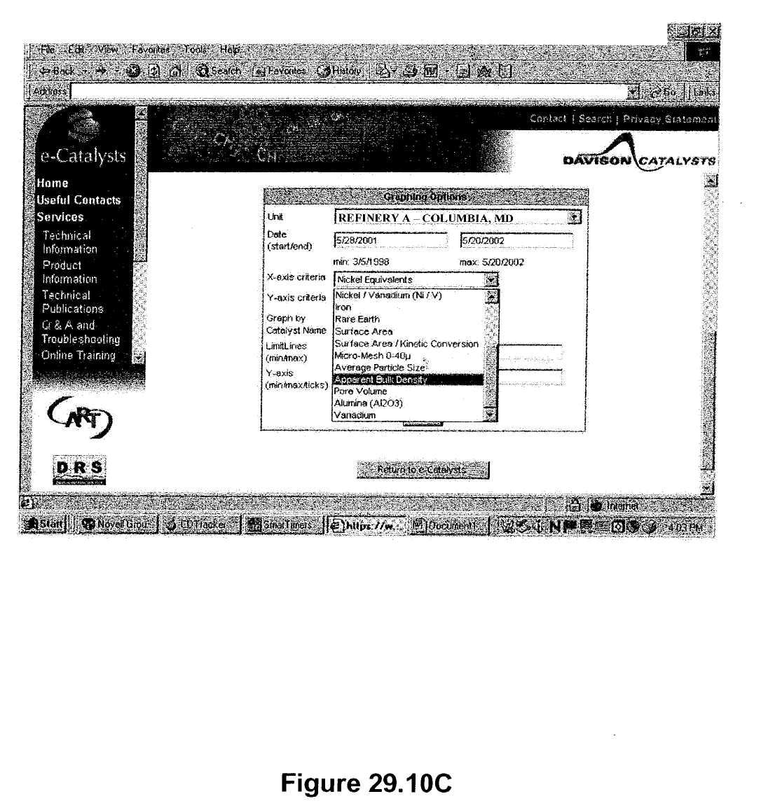

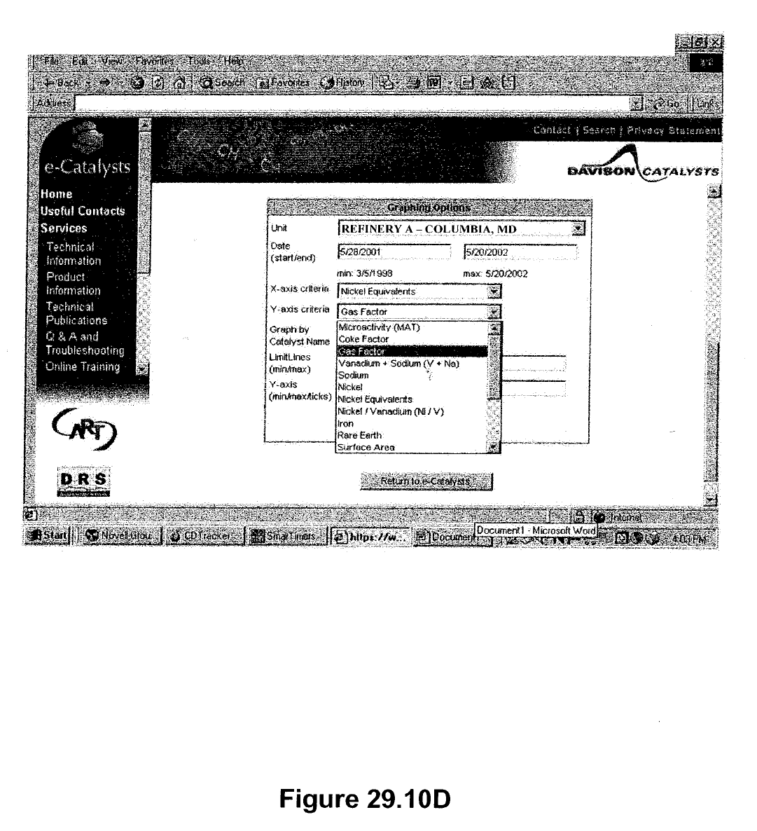

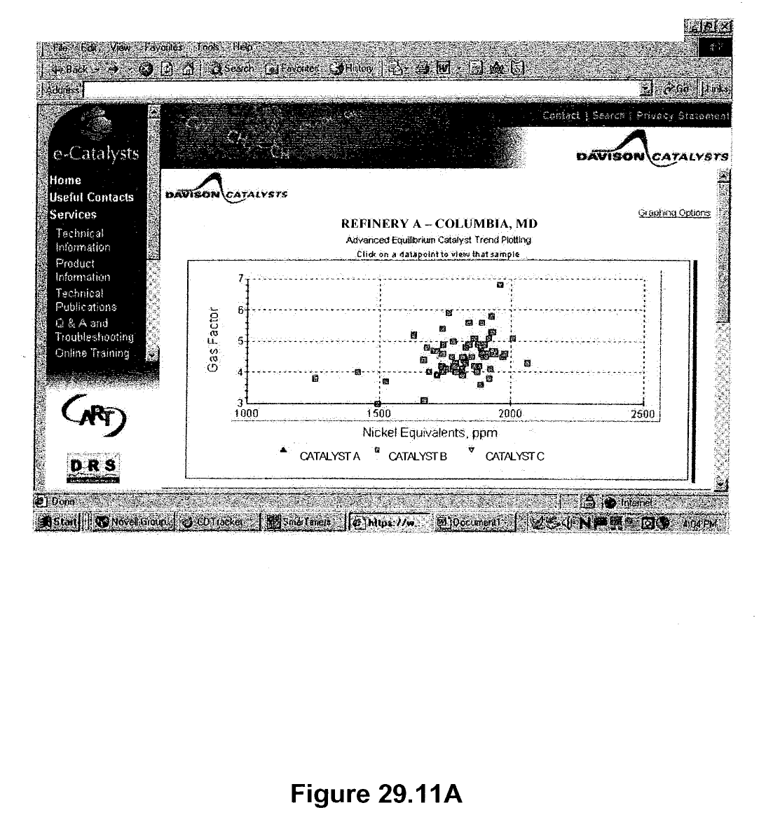

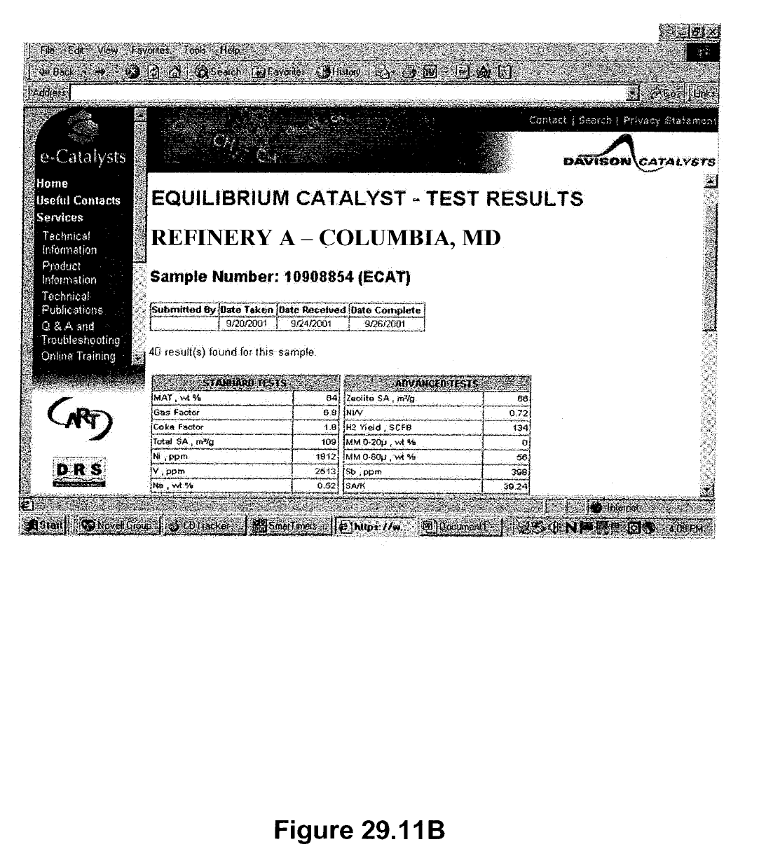

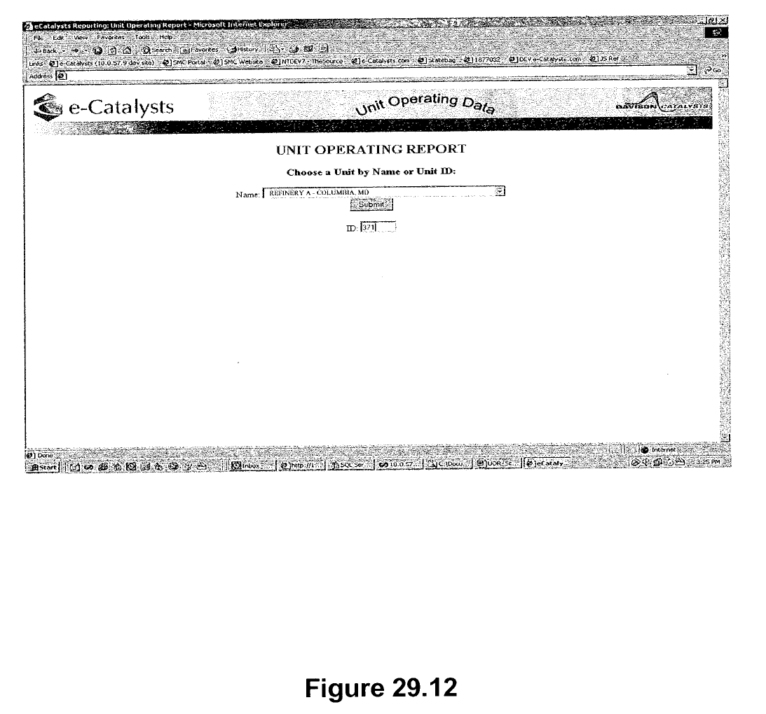

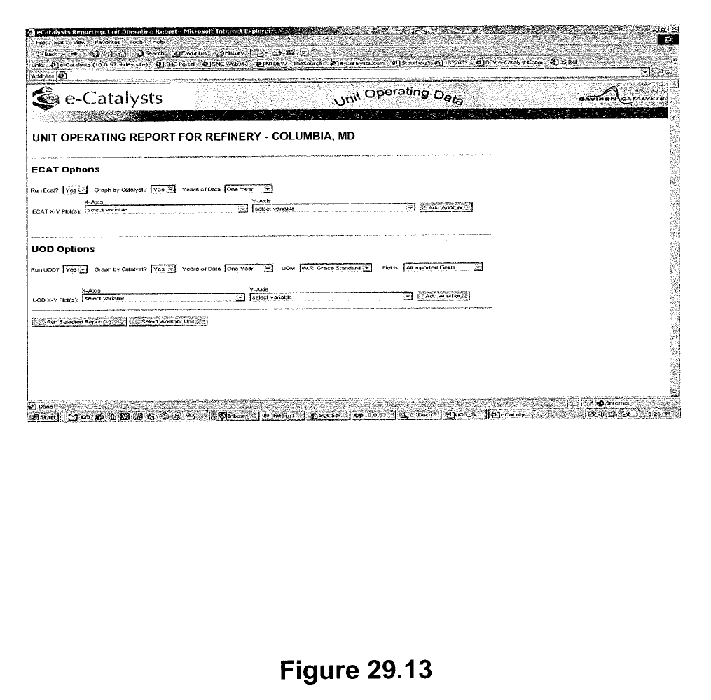

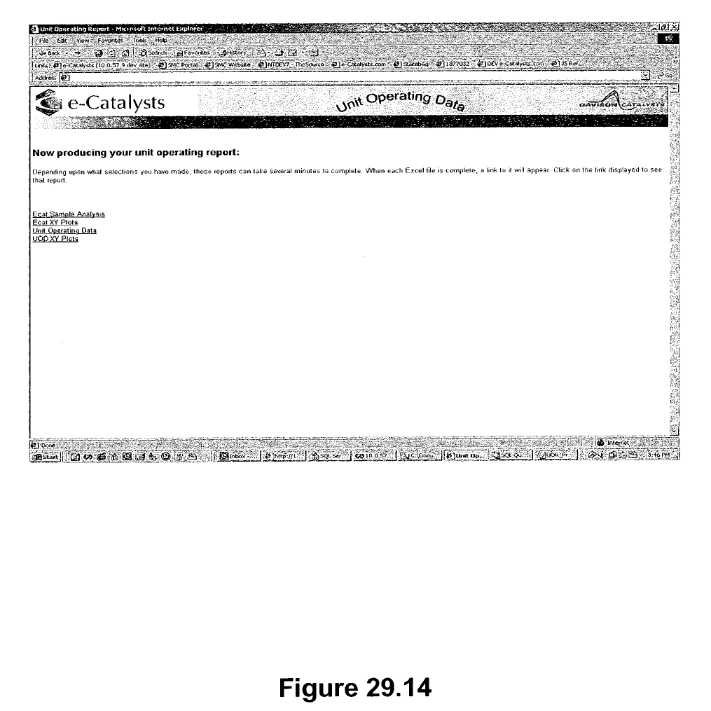

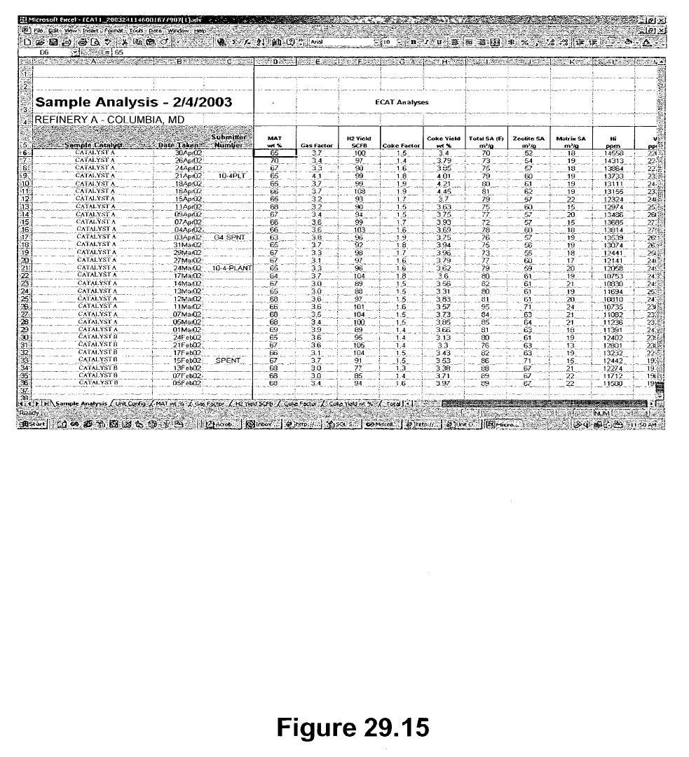

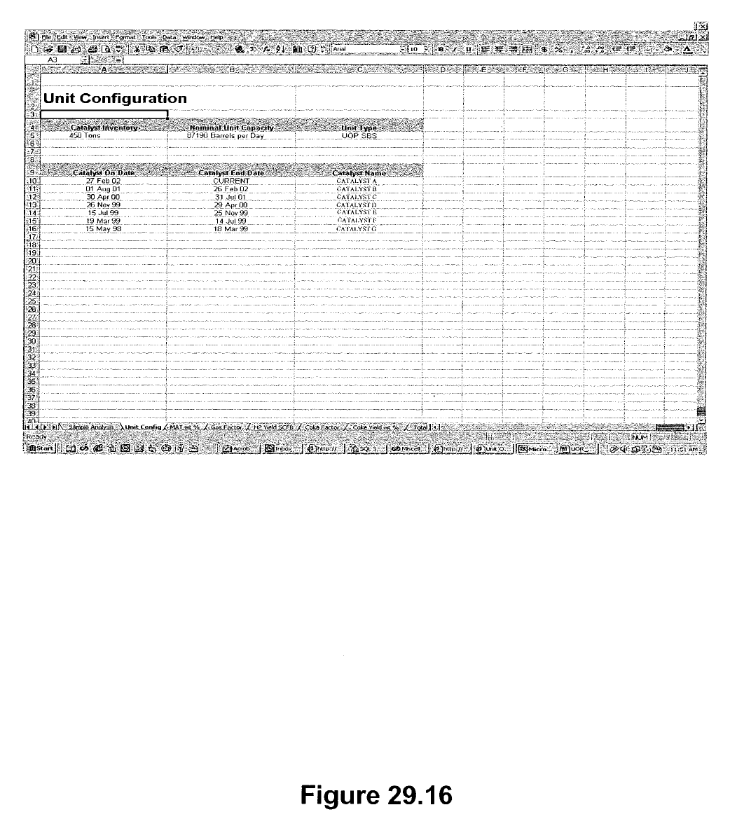

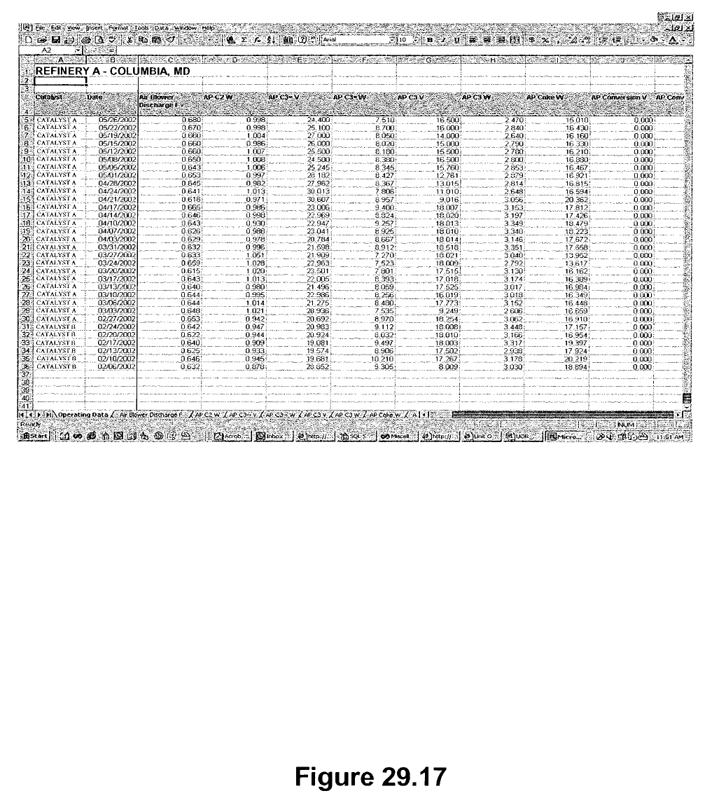

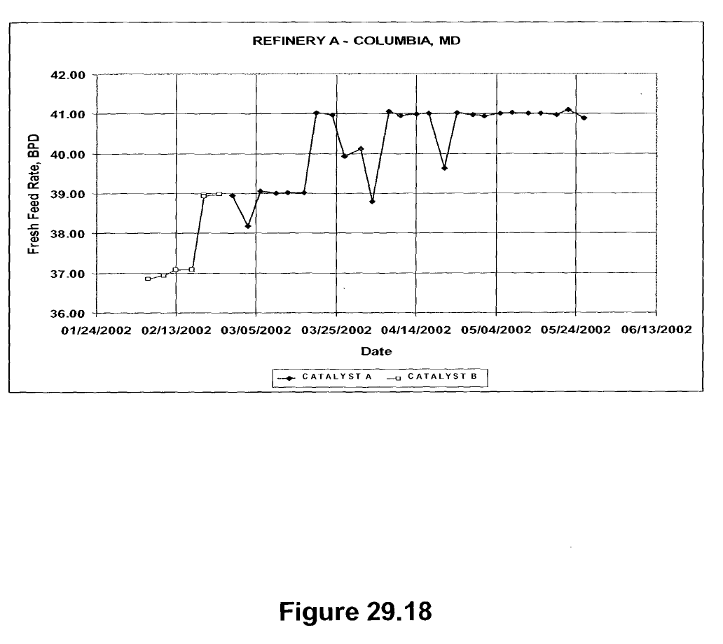

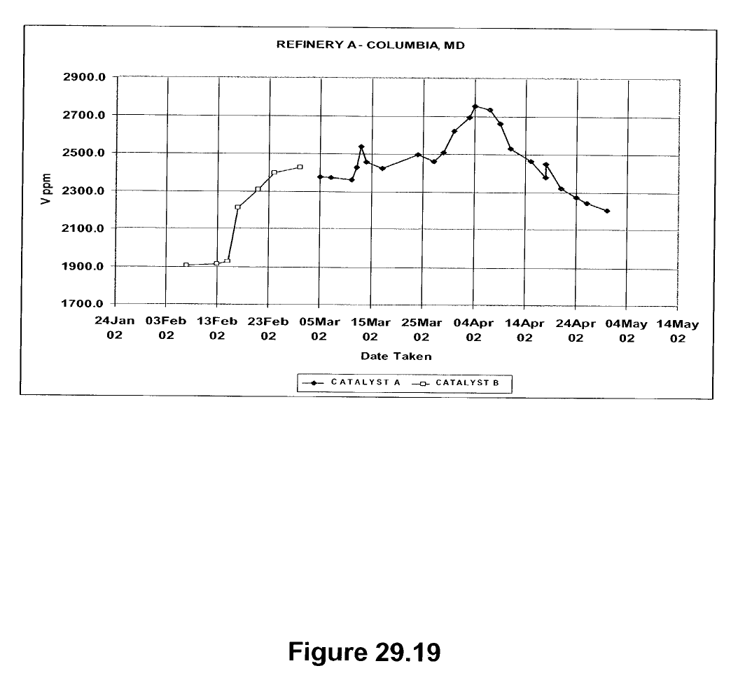

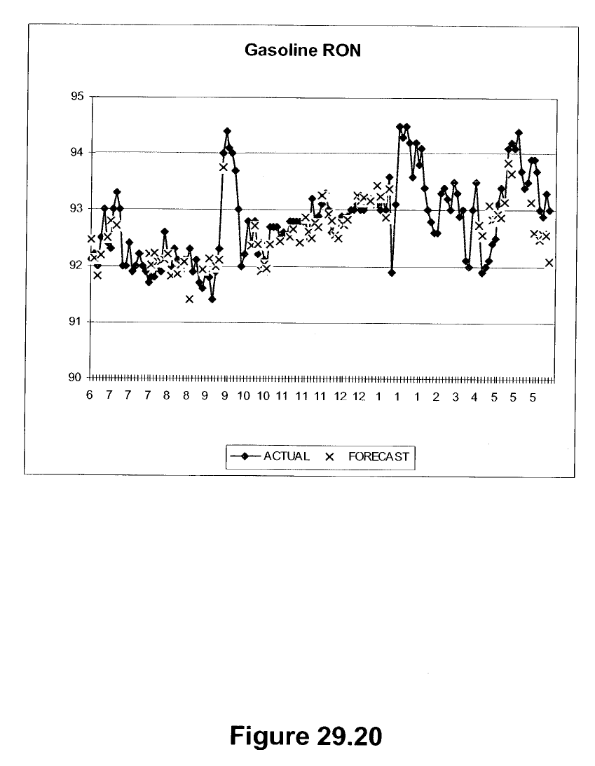

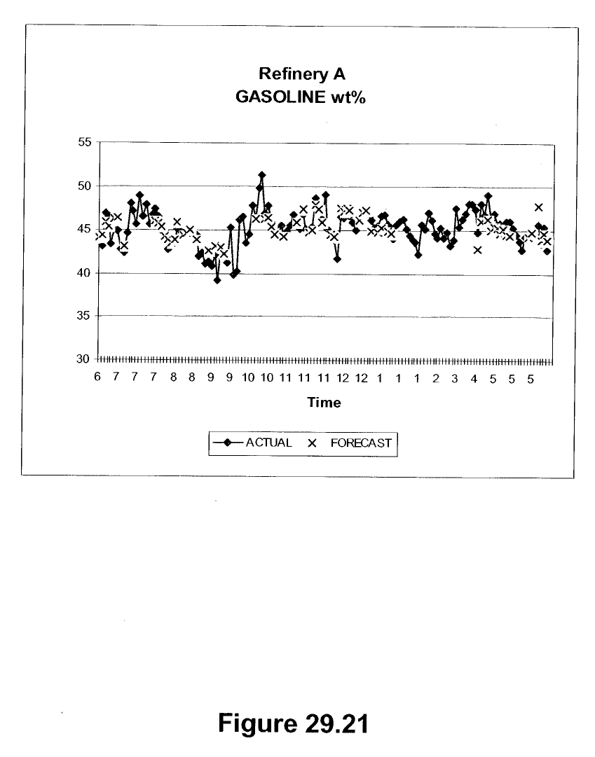

FIG. 23 is a block diagram of customer-specific analysis in greater detail, consistent with an embodiment of the present invention. Customer-specific analysis 2004 may include an analysis of fresh substances sent to a customer 2300, an analysis of substances received from the customer 2302, other customer-specific data 2304, and an analysis of unit operating data 2306. A fresh substance is a substance, such as a substance purchased by a customer, that is analyzed when it is new. One skilled in the art will recognize that customer-specific analysis 2004 may include other analysis, such as analysis of products purchased by customer. A detailed example of analysis consistent with an embodiment of the present invention is described below with reference to FIGS. 29.1-29.11.

C. Unit Operating Data Analysis

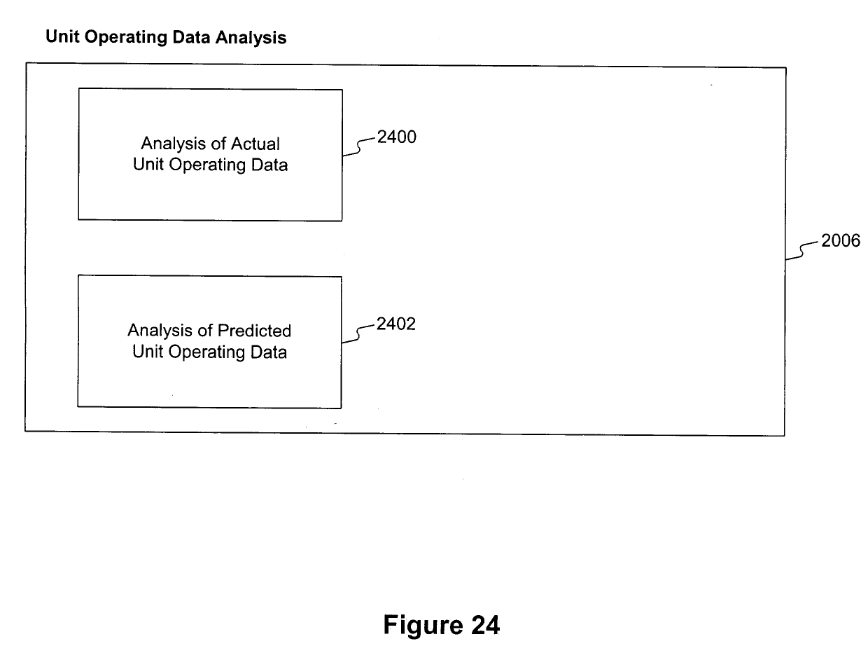

FIG. 24 is a block diagram of unit operating data analysis in greater detail, consistent with an embodiment of the present invention. Unit operating data analysis 2006 may include an analysis of actual operating data 2400 and an analysis of predicted unit operating data 2402. The analysis of actual operating data 2400 may include analysis of a customer's actual efficiency based on feed stock, operations data, yields, and catalyst data. The analysis of predicted unit operating data 2402 may include analysis by changing one or more of a customer's feed stock, operations data, yields, and catalyst data. For example, an improved yield or lower cost may be predicted if a different catalyst is used or if different operating conditions are used. To improve accuracy, these predictions may be based on historical data corresponding to a specific customer or industry-wide data, for example.

A detailed example of unit operating data analysis consistent with an embodiment of the present invention is described below with reference to FIGS. 29.12-29.21.

VI. Reporting Module

FIG. 25 is a block diagram of a reporting module in greater detail, consistent with an embodiment of the present invention. Reporting module 508 may include, for example, report generator 2500, interface for viewing reports 2502, user reports 2504, and report formats 2506. Reporting module 508 may be used to generate, store, and display reports based on analysis performed by analysis module 506, as described in greater detail above.

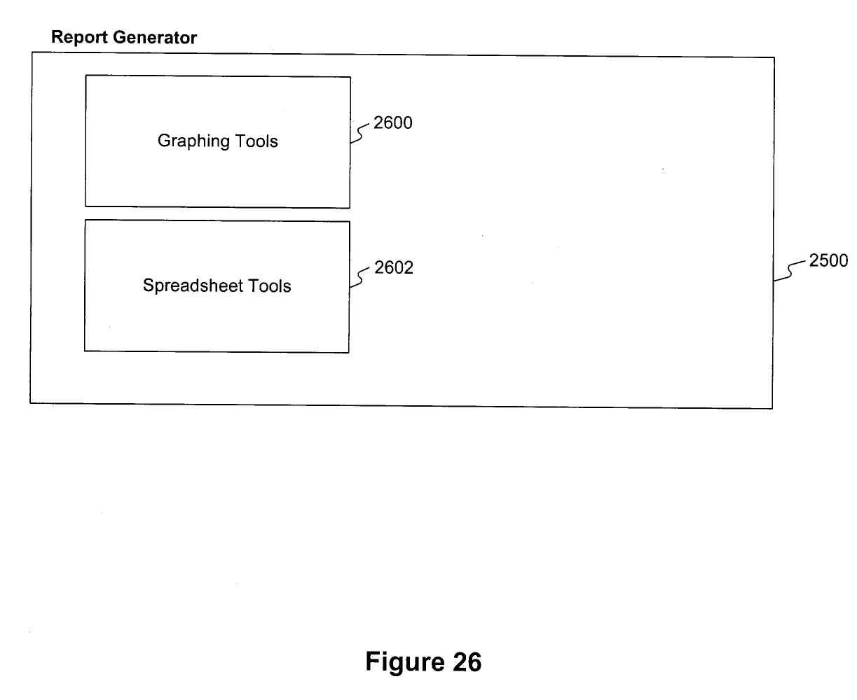

FIG. 26 is a block diagram of a report generator in greater detail, consistent with an embodiment of the present invention. Report generator 2500 may be used to generate reports based on the results of analysis performed by analysis module 506. Report generator 2500 may include, for example, graphing tools 2600, such as X-Y plotting tools, and spreadsheet tools 2602, such as Microsoft Excel or other spreadsheet software. In an embodiment of the present invention, graphing tools 2600 may include graphing different values together using different colors. For example, a graph may include an actual operating efficiency depicted using one color and a predicted operating efficiency depicted using a different color.

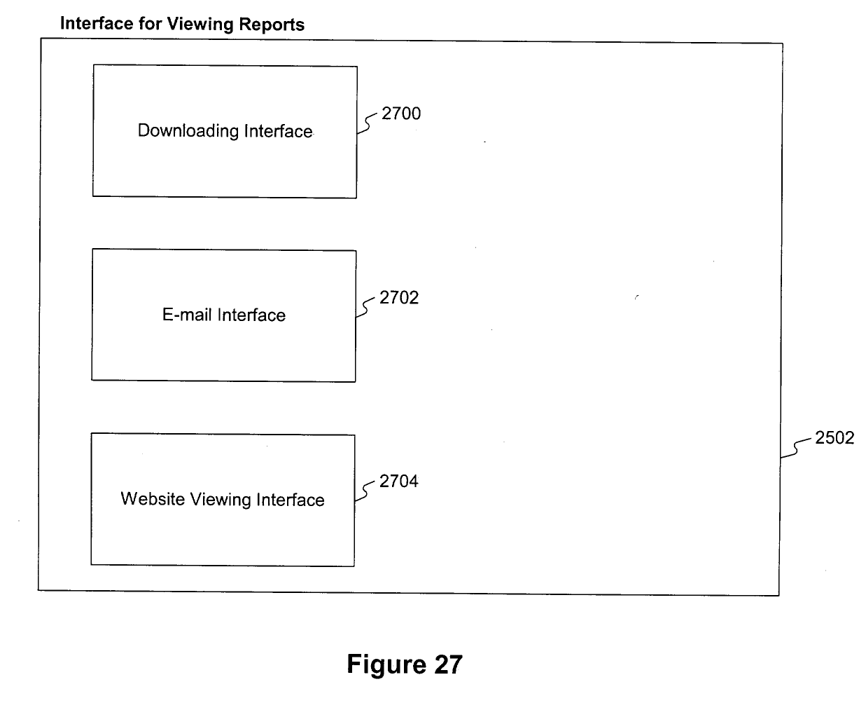

FIG. 27 is a block diagram of an interface for viewing reports in greater detail, consistent with an embodiment of the present invention. Interface for viewing reports 2502 may include, for example, a downloading interface 2700, an e-mail interface 2702, and a website viewing interface 2704. In this way, the user may download reports using download interface 2700, may request receiving reports by e-mail using e-mail interface 2702, and/or may view reports on the website using website viewer 2704.

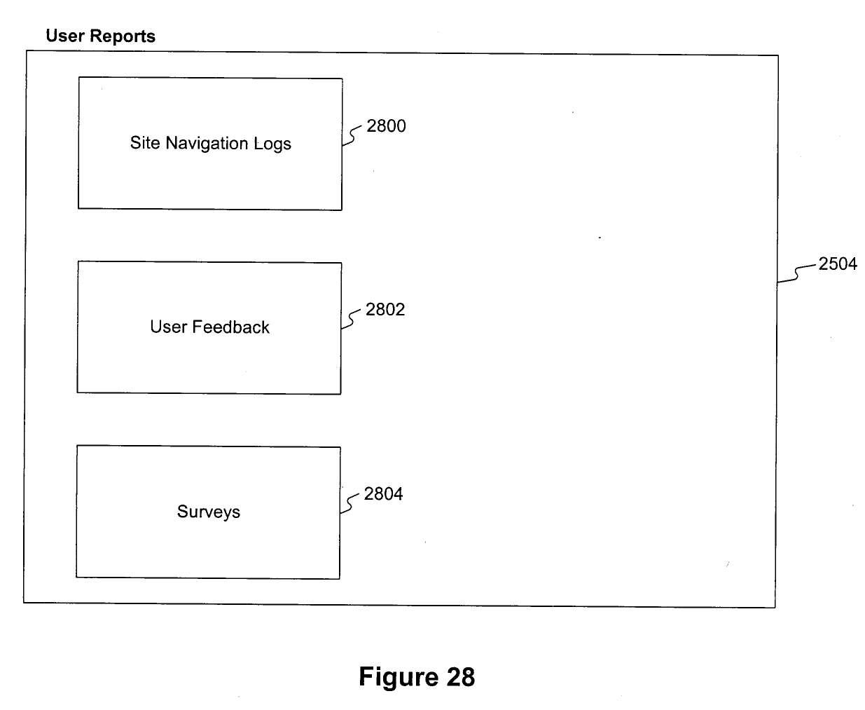

FIG. 28 is a block diagram of user reports 2504 in greater detail, consistent with an embodiment of the present invention. User reports 2504 may include, for example, site navigation logs 2800, user feedback 2802, and surveys 2804. Site navigation logs 2800 may track and store the ways in which users navigate the analysis service provider's website. User feedback 2802 may include user compliments or complaints. Surveys 2804 may include the results of customer or other surveys.

FIG. 29 is a block diagram of report formats in greater detail, consistent with an embodiment of the present invention. Report formats 2506 may include, for example, reports on fresh substances 2900, reports on substances from customers 2904, customizable reports 2904, material safety data sheets 2906, and unit operating data reports 2908. Report formats 2506 may include standard report templates that are used to produce customer-specific reports. Reports on fresh substances 2900 may include data about substances that are analyzed when they are new. Reports on substances from customers 2902 may include data about used substances received from a customer. Customizable reports 2904 may enable a customer to specify aspects of a report, such as date ranges or axis values. Material data safety sheets 2906 may include safety data about a product. This safety data may include, for example, an emergency contact, a trade name, chemical information, ingredients, first aid, toxicology report, typical chemical and physical information, handling information or other safety information about different products and substances. Unit operating data reports 2908 may include reports on actual or predicted customer performance based on unit operating data received from the customer.

A detailed example of sample reporting consistent with an embodiment of the present invention is described below with reference to FIG. 29.

VII. Sample Analysis and Reporting

FIG. 29.1 is a sample technical information page for a website consistent with an embodiment of the present invention. The technical information page may display various information available to a user. This information may be produced, for example, by analysis module 506 and reporting module 508. Technical information may include, for example, customer-specific analysis data, fresh substance analysis data, material safety data sheets, industry average reports, plotting tools, and optimization models. The data may relate to analysis of catalysts or any other type of substance. Optimization models may include, by way of example only, calculation templates for a variety of tests, including metals, heat balance, and undercutting value. These models may enable a user to input information, such as a catalyst name, and other data into an automatic calculator that will determine a target test result.

FIG. 29.2 is a sample customer-specific analysis page for a website consistent with an embodiment of the present invention. The customer-specific analysis page may be presented, for example, when a user chooses to view customer-specific analysis data from the technical information page. The customer-specific analysis page may prompt the user to select a unit for which to view customer-specific analysis data. The units listed in a drop-down list may be, for example, different departments or plants corresponding to a customer. Once the user selects a unit, a customer-specific report for that unit is presented. Alternatively, a user may not be prompted to select a unit if only one unit is available for viewing and the customer-specific report for that unit may automatically be displayed.

FIG. 29.3 is a sample customer-specific report for a website consistent with an embodiment of the present invention. The customer-specific report may include, for example, data produced by substance analyzer 2100 and stored as customer-specific analysis 2004. The data may be formatted, for example, by report generator 2500 and stored in user reports 2504. The customer-specific report may be generated using a standard report format 2506.

As shown in FIG. 29.3, the customer-specific report may be presented, for example, in a table format listing data for any number of tests run on a sample substance. For each sample, the table may include fields for sample number, date taken, date received by the analysis service provider, and submitter ID. For each sample, a number of test results may be displayed, such as gas factor and coke factor. The customer-specific report may span several pages. This report may also include, for example, a link to enable the user to view the data in an alternative format, such as in a Microsoft Excel format. To present the data in an alternative format, report generator 2500 may use, for example, spreadsheet tools 2602 or graphing tools 2600. The customer-specific report may also include links for the user to view testing methods or to change the types of samples displayed. By selecting a testing methods link, the user may view a testing methods document to inform the user about how tests are performed. The user may view analyses for different types of samples, such as fresh substances, i.e., substances purchased by a customer that are analyzed when they are new.

FIG. 29.4 is a sample test detail report for a website consistent with an embodiment of the present invention. To further facilitate the user's viewing of analysis data, each sample or other data item included in a customer-specific report may be displayed as a link. The user may select a data item link to display a test detail report with more detailed analysis about that specific test. For example, clicking on the “Coke Factor” test link in FIG. 29.3 may display the test detail report of FIG. 29.4.

The test detail report may include a trend plot to show sample analysis over time for a specific test (e.g., Coke Factor). In addition to a standard trend plot or other graph, the user may be given graph options, such as a specified date range or the inclusion of statistical lines. The statistical lines options may include, by way of example only, a mean line, a min/max line, a standard deviation line, and a best fit line. These options may be presented to the user, for example, using drop-down lists. Once a user selects graphing options, report generator 2000 may recreate the graph to include the additional statistical lines or other options chosen by the user.

FIG. 29.5 is a sample fresh substance analysis page for a website consistent with an embodiment of the present invention. Fresh substances may be, for example, substances purchased by a customer that are analyzed when they are new. The fresh substance analysis page may include, for example, a shipment ID number, order number, date shipped, and customer purchase order number. For each fresh substance listed, the fresh substance analysis page may include the results of any number of tests, such as Microactivity. The fresh substance analysis page may also include a drop-down list to enable the user to change a product or a unit and view data related to the chosen product or unit. In this way, the user may easily navigate among, for example, analysis data for different units within a single customer or different products purchased by the customer.

FIG. 29.6 is a sample fresh substance test detail report for a website consistent with an embodiment of the present invention. To further facilitate the user's viewing of analysis data, each sample or other data item included in a fresh substance analysis report may be displayed as a link. The user may select a data item link to display a fresh substance test detail report with more detailed analysis about that specific test. For example, clicking on the “Iron (Fe)” test link in FIG. 29.5 may display the fresh substance test detail report of FIG. 29.6.

The fresh substance test detail report may include a trend plot to show sample analysis over time for a specific test (e.g., Iron percentage). In addition to a standard trend plot or other graph, the user may be given graph options, such as a specified date range or the inclusion of statistical lines. The statistical lines options may include, by way of example only, a mean line, a min/max line, a standard deviation line, and a best fit line. These options may be presented to the user, for example, using drop-down lists. Once a user selects graphing options, report generator 2500 may recreate the graph to include the additional statistical lines or other options chosen by the user.

Within the fresh substance test detail report, each data item may be a link to additional information about the fresh substance. Selecting a link may display, for example, shipment information about the corresponding sample. The shipment information may include, for example, the shipment number, the product, the date manufactured, the date shipped, the plant, the customer purchase order number, the dry weight, the gross weight, and the tare weight. The shipment information may also include a table of test results, listing tests performed and results for that particular shipment. The shipment information display may also include links to allow the user to easily move back to the plot graph or the tabular graph.

FIG. 29.7 is a sample industry analysis page for a website consistent with an embodiment of the present invention. The industry analysis page may be presented, for example, when a user chooses to view industry analysis data from the technical information page (see FIG. 29.1). The industry analysis page may prompt the user to select a unit and/or a test for which to view industry analysis data. The units listed in a drop-down list may be, for example, different departments or plants corresponding to a customer. The tests listed in a drop-down list may be, for example, different comparisons such as Gas Factor versus Nickel Equivalents. Once the user selects a unit and/or a test, an industry report for that unit is presented. Alternatively, a user may not be prompted to select a unit if only one unit is available for viewing and the industry report for that unit may automatically be displayed.

FIG. 29.8 is a sample industry report for a website consistent with an embodiment of the present invention. The industry report may include, for example, data produced by substance analyzer 2100 and stored as industry analysis 2002. The data may be formatted, for example, by report generator 2500 and stored in user reports 2504. The industry report may be generated using a standard report format 2506.

As shown in FIG. 29.8, the industry report may be presented, for example, as a graph including data points showing results of a specific comparison test for samples received from various customers in an industry. In this way, a user may see how the user's test results compare with test results of the industry. The industry report may span several pages. This report may also include, for example, links for the user to change the unit or test displayed. The data points in the industry report may include detailed information that may be viewed by placing a mouse over a data point.

FIG. 29.9 is a sample comparison detail report for a website consistent with an embodiment of the present invention. To further facilitate the user's viewing of industry analysis data, each data point included in the industry report may be displayed as a link. The user may select a data point link to display a comparison detail report with more detailed analysis about that specific comparison. The comparison detail report may include a table corresponding to a sample including the unit configuration of the unit from which the sample came and average test results for the sample.

FIG. 29.10 is a sample advanced substance analysis report for a website consistent with an embodiment of the present invention. From the technical information menu (see FIG. 29.1), a user may choose advanced substance analysis data to display an advanced substance analysis report. The user may be presented with a drop-down list if data for more than one unit is available. Once a unit is selected by the user, an advanced substance analysis report is presented. Each data point may include additional information that can viewed by placing the mouse over the data point.

As part of advanced substance analysis, the user may be given a variety of graphing options, including unit, start and end dates, X-axis criteria, Y-axis criteria, graph by catalyst name, minimum/maximum limits, and Y-axis minimum/maximum limits. In this way, a user may customize the way in which data is viewed. The X-axis criteria may include, by way of example only, nickel equivalents, iron, rare earth, and surface area. The Y-axis criteria may be the same or different from the X-axis criteria and may include, by way of example only, coke factor and microactivity.

FIG. 29.11 is a sample advanced substance analysis by catalyst report for a website consistent with an embodiment of the present invention. The advanced substance analysis by catalyst report may be displayed if a user chooses to graph by catalyst name from the advanced substance analysis report. This catalyst reports includes data for one or more catalysts for given criteria (shown on the X-axis and Y-axis of the graph). By clicking on a data point corresponding to a sample result, the user may view more information about the sample in a detailed report. The detailed report may include, for example, a sample number, a submitted by field, the date the sample was taken, the date the sample was received, and the date the tests were complete. The test results be organized according to, for example, standard and advanced testing.

FIG. 29.12 is a sample unit operating report request screen for a website consistent with an embodiment of the present invention. The unit operating report request screen may include, for example, a drop-down box for the customer to select a unit and a place for the customer to enter an identifier. Once the customer enters the proper information, the customer may choose a “Submit” button to request a unit operating report.

FIG. 29.13 is a sample unit operating report selection screen for a website consistent with an embodiment of the present invention. The unit operating report selection screen may include, for example, a set of drop-down boxes to enable the customer options for reporting on substance analysis (e.g., “ECAT” data) and/or unit operating data analysis (e.g., “UOD” data). The customer may choose to run an ECAT report graphed by catalyst for a specified year. The customer may also be able to choose the variables to appear on the X- and Y-axis of the resulting graph. The customer may also choose to run a UOD report graphed by catalyst for a specified year, a specified unit, and specified fields. The customer may also be able to choose the variables to appear on the X- and Y-axis of the resulting graph.

FIG. 29.14 is a sample report generation screen for a website consistent with an embodiment of the present invention. Once the customer has selected the options shown on the unit operating report selection screen shown in FIG. 29.13, the report generation screen may be presented to inform the user that report generation is underway. In this embodiment, the report will be presented as an Excel file. In other embodiments, the report may be presented in any format and as any type of file.

FIG. 29.15 is a sample substance analysis report for a website consistent with an embodiment of the present invention. Once the customer has selected the options for reporting on substance analysis (e.g., “ECAT” data) using the unit operating report selection screen shown in FIG. 29.13, the substance analysis report may be presented. The substance analysis report may include a sample catalyst column, a sample date column, a submitter number column, and results of substance analysis (e.g., MAT wt %, Gas Factor, etc.).

FIG. 29.16 is a sample unit configuration report for a website consistent with an embodiment of the present invention. Once the customer has selected the options for reporting on unit operating data (e.g., “UOD” data) using the unit operating report selection screen shown in FIG. 29.13, the unit configuration report may be presented. The unit configuration report may include a catalyst inventory, a nominal unit capacity, a unit type, a catalyst on date, a catalyst end date, and a catalyst name.

FIG. 29.17 is a sample unit operating data report for a website consistent with an embodiment of the present invention. The unit operating data report may be include a catalyst name, a date, and data values corresponding, for example, to a standard variable list. Although FIG. 29.17 depicts a unit operating data report in table format, one skilled in the art will recognize that other formats, such as graphs or pie charts, may also be used consistent with the present invention.

FIG. 29.18 is another sample unit operating data report for a website consistent with an embodiment of the present invention. In this embodiment, the unit operating data report may be presented as a graph showing a variable, e.g., Fresh Feed Rate, over a series of dates for a certain unit, e.g., Refinery A.

FIG. 29.19 is another sample unit operating data report for a website consistent with an embodiment of the present invention. In this embodiment, the unit operating data report may be presented as a graph comparing data from one catalyst (e.g., CATALYST A) used over one set of dates versus a different catalyst (e.g., CATALYST B) used over a different set of dates. This type of report assists a customer in determining whether choosing a different catalyst might improve yields, cost, efficiency, etc.

FIG. 29.20 is another sample unit operating data-report for a website consistent with an embodiment of the present invention. In this embodiment, the unit operating data report may be presented as a graph comparing actual data versus predicted data. A user may select any data point on the graph and be presented with a chart (not shown) of the actual and/or predicted data represented by the data point. As described above, the predictions may be based on, for example, different feed stock data, operations data, yield data, or catalyst data. In an embodiment of the present invention, the actual data may be depicted using one color and the predicted data may be depicted using a different color. This type of report assists a customer in determining whether changing feed stock, operating conditions, yield or catalysts might improve cost, efficiency, yields, etc.

FIG. 29.21 is another sample unit operating data report for a website consistent with an embodiment of the present invention. In this embodiment, the unit operating data report may be presented as a graph comparing actual data versus predicted data. A user may select any data point on the graph and be presented with a chart (not shown) of the actual and/or predicted data represented by the data point. In an embodiment of the present invention, the actual data may be depicted using one color and the predicted data may be depicted using a different color. The predictions may be based on changes in feed stock, operating conditions, yield, and/or catalysts. In an embodiment of the present invention, predictions may be made using historical data of a customer, data from a different customer, or industry-wide data. This type of report assists a customer in determining whether changing feed stock, operating conditions, yield, or catalysts might improve cost, efficiency, yields, etc.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

TABLE 1

| | Old Names | New Names | |
|---|---|---|---|
| Category | Configuration_Code | Configuration_Code | Description |
| Fresh Catalyst | CATINVENT | Ecat_Inventory_TONS | Circulating Catalyst Inventory, Stons |
| | ECATTPD | Purchased_Ecat_TPD | Purchased E-Cat Additions, STons/Day |
| | FRESHTPD | Fresh_Catalyst_TPD | Fresh Catalyst Additions, STons/Day |
| | PRCHECATNI | Purchased_Ecat_Ni_PPM | Purchaed E-Cat Ni, ppm |
| | PRCHECATV | Purchased_ECAT_V_PPM | Purchaed E-Cat V, ppm |
| | ZSM5INV | ZSM5_In_Inventory_W | Wt % ZSM-5 Additive in Inventory |
| | ADDITIVE | ZSM5_Type | ZSM-5 Additive Type |
| | | ZSM5_Addition_Rate_LBSper Day | ZSM-5 Addition Rate, Lbs/Day |
| | CATALYST | Fresh_Catalyst_Name | FCC Catalyst Type |
| | CRC | Ecat_CRC_W | Unit Equilibrium CRC, wt % |
| | MAT | Ecat_MAT | Unit Eqilibrium MAT |
| | NIPV | Ecat_Ni_Plus_V_PPM | Unit Total Ni+V, ppm |
| | UNIT_NI | Ecat_Ni_PPM | Unit Equilibrium Ni, ppm |
| | UNIT_V | Ecat_V_PPM | Unit Equilibrium V, ppm |
| | UNIT_TSA | Ecat_Total_SA_M2PerGram | Unit Equilibrium TSA, m2/g |
| | UNIT_NIEQ | | Unit Equilibrium Nickel Equivalents, |
| | | | ppm |
| Fresh Feed Properties | FEEDRATE | Feed_Combined_Feed_Rate_BPD | Fresh Feed Rate, BPD |
| | DAORATE | Feed_DAO_Rate_BPD | DAO Feed Rate, BPD |
| | RESIDRATE | Feed_Resid_Rate_BPD | RESID Feed Rate, BPD |
| | RESID_PER | Feed_1000_F_Plus_V | Vol % 1000+ F(TBP) in feed |
| | HC_BTMSRATE | Feed_HC_Bottoms_Rate_BPD | Hydrocracker Bottoms rate, BPD |
| | FEEDAPI | Feed_API | Fresh Feed API |
| | FEEDRMSCARBON | Feed_Ramsbottom_Carbon_W | Fresh Feed Rambottom Carbon, wt % |
| | FEEDCARBON | Feed_Conradson_Carbon_W | Fresh Feed Conradson Carbon, Wt % |
| | | Feed_MCRT_W | Fresh Feed Micro Carbon Residue Test |
| | | | (MCRT), Wt % |
| | FEEDSULFUR | Feed_Sulfur_W | Fresh Feed Sulfur, Wt % |
| | FEED_K | Feed_UOP_K | Fresh Feed K Factor |
| | | Feed_Watson_K | Fresh Feed Watson-K Factor |
| | FEED_ANIL | Feed_Aniline_Point_F | Feed Aniline Point, F. |
| | FEED_RI | Feed_RI | Fresh Feed Refractive Index |
| | FEED_BN | Feed_Basic_N_PPM | Fresh Feed Basic N, ppm |
| | FEED_N | Feed_Total_N_PPM | Fresh Feed Total N, ppm |
| | FEED_NA | Feed_Na_PPM | Fresh Feed Na, ppm |
| | FEED_NI | Feed_Ni_PPM | Fresh Feed Ni, ppm |
| | FEED_V | Feed_V_PPM | Fresh Feed V, ppm |
| | FEED_Fe | Feed_Fe_PPM | Fresh Feed Fe, ppm |
| | FEED_IBP | Feed_IBP_F | Fresh Feed IBP, F. |
| | FEED_10 | Feed_10_F | Fresh Feed 10% Point, F. |
| | FEED_30 | Feed_30_F | Fresh Feed 30% Point, F. |
| | FEED_50 | Feed_50_F | Fresh Feed 50% Point, F. |
| | FEED_70 | Feed_70_F | Fresh Feed 70% Point, F. |
| | FEED_90 | Feed_90_F | Fresh Feed 90% Point, F. |
| | FEED_EP | Feed_EP_F | Fresh Feed EP, F. |
| | FEED_VABP | Feed_VABP_F | Fresh Feed, VABP, F. |
| Recycle Properties | REC_API | Recycle_API | Recycle API |
| | REC_CARBON | Recycle_Conradson_Carbon_W | Recycle ConCarbon, Wt % |
| | REC_K | Recycle_UOP_K | Recycle K |
| | REC_RATE | Recycle_Rate_BPD | Recycle Rate, BPD |
| Heat Balance | AIR_MSCFM | Air_Rate_MSCFM | Wet Air Rate, MSCFM. |
| | AIR_SCFB | Air_Rate_SCFB | Wet Air Rate, SCFB (FF) |
| | AIR_SCFH | Air_Rate_SCFH | Wet Air Rate, SCFH |
| | MAB_F | Air_Blower_Discharge_F | Air Blower Discharge Temp, F. |
| | CATCIRC | Catalyst_Circulation_STonsPerMin | Catalyst Circulation Rate, STons/Min |
| | CATTOOIL | Catalyst_To_Oil_Ratio | Cat/Oil Ratio |
| | CO2TOCO | CO2_To_CO_Vol | CO2/CO, Vol/Vol |
| | COKE_H | Coke_Hydrogen_W | Hydrogen in Coke, Wt % |
| | COKE_S | Coke_Sulfur_W | Sulfur in Coke, Wt % |
| | COKE_W | Coke_Yield_W | Coke Yield, W % Fresh Feed |
| | COOLERDUTY | Cooler_Duty_BTUPerHr | Catalyst Cooler Duty, BTU/ Hr. |
| | DELTACOKE | Delta_Coke | Delta Coke, WT % |
| | REGN_PSIG | Regn_PSIG | Regenerator Pressure, PSIG |
| For single stage regeneration | DENSE_C | Regn_Dense_C | Regen Dense Temp, C. |
| | DENSE_F | Regn_Dense_F | Regen Dense Temp, F. |
| | DILUTE_C | Regn_Dilute_C | Regen Dilute Temp, C. |
| | DILUTE_F | Regn_Dilute_F | Regen Dilute Temp. F. |
| For R1 | DENSE1_C | R1_Dense_C | Regen 1 Dense Temp, C. |
| | DENSE1_F | R1_Dense_F | Regen 1 Dense Temp, F. |
| | DILUTE1_C | R1_Dilute_C | Regen 1 Dilute Temp, C. |
| | DILUTE1_F | R1_Dilute_F | Regen 1 Dilute Temp, F. |
| For R2 | DENSE2_C | R2_Dense_C | Regen 2 Dense Temp, C. |
| | DENSE2_F | R2_Dense_F | Regen 2 Dense Temp, F. |
| | DILUTE2_C | R2_Dilute_C | Regen 2 Dilute Temp, C. |
| | DILUTE2_F | R2_Dilute_F | Regen 2 Dilute Temp, F. |
| | AIR_R1 | Air_Rate_To_R1_MSCFH | Air to regen 1, mscfh |
| | AIR_R2 | Air_Rate_To_R2_MSCFH | Air to regen 2, mscfh |
| | CO_CO2_R1 | | CO to CO2 ratio in R1 |
| | XS_O2_R2 | R2_Excess_O2_M | Excess O2 in R2, Mole % |
| | COMBUSTOR_F | Combustor_Lower_Temp_F | Combustor Temp. F. (UOP Hi Efficiency |
| | | | Fast Burn Unit) |
| | PLENUM_F | Regn_Plenum_F | Regenerator Plenum Temp, F. |
| | OPACITY | Flue_Gas_Opacity_P | Regen Stack Opacity, % |
| | FEEDRATIO | Feed_Combined_Feed_Ratio | Combined Feed Ratio, LV Basis |
| | FEEDTEMPC | Feed_Combined_Feed_C | Combined Feed Temp, C. |
| | FEEDTEMPF | Feed_Combined_Feed_F | Combined Feed Temp, F. |
| | HEATLOSS | Regn_Heat_Losses_P | Overall heat losses, % total heat of |
| | | | comb |
| | HEATRXN | Reactor_Heat_of_Rx_BTUPerLb | Heat of Reaction, Btu/lb |
| | O2INFLUE | Flue_Gas_O2_V | O2 in Flue Gas, Vol % |
| | CO2_V | Flue_Gas_CO2_V | CO2 in Flue Gas, Vol % |
| | CO_V | Flue_Gas_CO_V | CO in Flue Gas, Vol % |
| | SO2_V | Flue_Gas_SO2_PPM | SO2 in Flue Gas, ppm |
| | Boiler_Fuel_MSCFH | CO_Boiler_Fuel_MSCFH | Fuel to CO Boiler, MSCFH |
| | Boiler_O2 | CO_Boiler_O2_V | O2 in Flue Gas out of CO Boiler, Vol % |
| | MTC_BPD | Mix_Temp_Control_BPD | Mix Temperature Control, BPD |
| | MTC_BPD_RISER | | MTC to Riser, BPD |
| | MTC_BPD_FEED | | MTC to Feed, BPD |
| | POSTRISER_QUENCH | Post_Riser_Quench_BPD | Post Riser Quench, BPD |
| | REACTEMPC | Rx_Riser_Outlet_C | Reactor Temp, C. |
| | REACTTEMPF | Rx_Riser_Outlet_F | Reactor Temp, F. |
| | RX_PSIG | Rx_PSIG | Reactor Pressure, PSIG |
| | RX_LEVEL_IN | Rx_Level_InOfWater | Reactor Level, in of H2O |
| | RX_CYC_VEL | Rx_Cyclone_Intel_Velocity_FtPerS | Rx Cyclone Velocity, Ft/Sec |
| | TOTSTEAM | | Total RRX/SDX Steam, lb/bbl |
| | STRIPSTM | | Stripping Steam, lb/hr |
| | DISPSTM | | Feed Dispersion Steam, lb/hr |
| | PRESTRIP | | PreStripping Steam, lb/hr |
| | LIFTSTM | Rx_Riser_Lift_Steam_LbPerHr | Lift Steam at Base of Riser, lb/hr |
| PRODUCTQUALITY | LCN_API | LCN_API | LCN API |
| PRODUCTQUALITY | LCN_IBP | LCN_IBP_F | Light Cat Naptha IBP, F. |
| PRODUCTQUALITY | LCN_10 | LCN_10_F | Light Cat Naptha 10%, F. |
| PRODUCTQUALITY | LCN_30 | LCN_30_F | Light Cat Naptha 30%, F. |
| PRODUCTQUALITY | LCN_50 | LCN_50_F | Light Cat Naptha 50%, F. |
| PRODUCTQUALITY | LCN_70 | LCN_70_F | Light Cat Naptha 70%, F. |
| PRODUCTQUALITY | LCN_90 | LCN_90_F | Light Cat Naptha 90%, F. |
| PRODUCTQUALITY | LCN_EP | LCN_EP_F | Light Cat Naptha EP %, F. |
| PRODUCTQUALITY | LCN_RON | LCN_RONC | Light Cat Naptha RON |
| PRODUCTQUALITY | LCN_MON | LCN_MONC | Light Cat Naptha MON |
| | LCN_RM2 | LCN_RM2 | Light Cat Naptha R+M/2 |
| PRODUCTQUALITY | LCN_S | LCN_Sulfur_PPM | Light Cat Naptha, Sulfur, ppm |
| PRODUCTQUALITY | LCN_OLEF | LCN_FIA_Olefins_V | Light Cat Naptha FIA Olefins, LV % |
| | | ICN_API | Intermediate Cat Naptha API |
| | | ICN_IBP_F | Intermediate Cat Naptha IBP, F. |
| | | ICN_10_F | Intermediate Cat Naptha 10%, F. |
| | | ICN_30_F | Intermediate Cat Naptha 30%, F. |
| | | ICN_50_F | Intermediate Cat Naptha 50%, F. |
| | | ICN_70_F | Intermediate Cat Naptha 70%, F. |
| | | ICN_90_F | Intermediate Cat Naptha 90%, F. |
| | | ICN_EP_F | Intermediate Cat Naptha EP %, F. |
| | | ICN_RONC | Intermediate Cat Naptha RONC |
| | | ICN_MONC | Intermediate Cat Naptha MONC |
| | | ICN_RM2 | Intermediate Cat Naptha R+M/2 |
| | | ICN_Sulfur_PPM | Intermediate Cat Naptha Sulfur, ppm |
| | | ICN_FIA_Olefins_V | Intermediate Cat Naptha FIA Olefins, |
| | | | LV % |
| PRODUCTQUALITY | HCN_API | HCN_API | Heavy Cat Naptha API |
| PRODUCTQUALITY | HCN_IBP | HCN_IBP_F | Heavy Cat Naptha IBP, F. |
| PRODUCTQUALITY | HCN_10 | HCN_10_F | Heavy Cat Naptha 10%, F. |
| PRODUCTQUALITY | HCN_30 | HCN_30_F | Heavy Cat Naptha 30%, F. |
| PRODUCTQUALITY | HCN_50 | HCN_50_F | Heavy Cat Naptha 50%, F. |
| PRODUCTQUALITY | HCN_70 | HCN_70_F | Heavy Cat Naptha 70%, F. |
| PRODUCTQUALITY | HCN_90 | HCN_90_F | Heavy Cat Naptha 90%, F. |
| PRODUCTQUALITY | HCN_EP | HCN_EP_F | Heavy Cat Naptha EP %, F. |
| PRODUCTQUALITY | HCN_RON | HCN_RONC | Heavy Cat Naptha RON |
| PRODUCTQUALITY | HCN_MON | HCN_MONC | Heavy Cat Naptha MON |
| | HCN_RM2 | HCN_RM2 | Heavy Cat Naptha R+M/2 |
| PRODUCTQUALITY | HCN_S | HCN_Sulfur_PPM | Heavy Cat Naptha, Sulfur, ppm |
| PRODUCTQUALITY | HCN_OLEF | HCN_FIA_Olefins_V | Heavy Cat Naptha, FIA Olefins, LV % |
| PRODUCTQUALITY | GAS_API | Gasoline_API | Full Range Gasoline API @ 60 F. (As |
| | | | Produced) |
| | | Gasoline_API_430 | Full Range Gasoline API corrected to |
| | | | 430 F. End Point |
| PRODUCTQUALITY | GAS_IBP | Gasoline_IBP_F | Gasoline IBP, F. |
| PRODUCTQUALITY | GAS_10 | Gasoline_10_F | Gasoline 10, F. |
| PRODUCTQUALITY | GAS_30 | Gasoline_30_F | Gasoline 30, F. |
| PRODUCTQUALITY | GAS_50 | Gasoline_50_F | Gasoline 50, F. |
| PRODUCTQUALITY | GAS_70 | Gasoline_70_F | Gasoline 70, F. |
| PRODUCTQUALITY | GAS_90 | Gasoline_90_F | Gasoline 90, F. |
| PRODUCTQUALITY | GAS_EP | Gasoline_EP_F | Gasoline EP, F. |
| PRODUCTQUALITY | RONC | Gasoline_RONC | Gasoline RONC |
| PRODUCTQUALITY | MONC | Gasoline_MONC | Gasoline MONC |
| PRODUCTQUALITY | RPMO2 | Gasoline_RM2 | Gasoline (R+M)/2 |
| PRODUCTQUALITY | GAS_S | Gasoline_Sulfur_PPM | Gasoline S, ppm |
| PRODUCTQUALITY | GAS_OLEF | Gasoline_FIA_Olefins_V | Gasoline Olefins, LV % |
| PRODUCTQUALITY | GAS_RVP | Gasoline_RVP_PSIG | Gasoline RVP, psig. |
| PRODUCTQUALITY | GASOBENZ | Gasoline_Benzene_PPMV | Gasoline Benzene, LV % |
| PRODUCTQUALITY | LCO_API | LCO_API | LCO API (As Porduced) |
| PRODUCTQUALITY | LCO_IBP | LCO_IBP_F | LCO IBP, F. |
| PRODUCTQUALITY | LCO_10 | LCO_10_F | LCO 10, F. |
| PRODUCTQUALITY | LCO_30 | LCO_30_F | LCO 30, F. |
| PRODUCTQUALITY | LCO_50 | LCO_50_F | LCO 50, F. |
| PRODUCTQUALITY | LCO_70 | LCO_70_F | LCO 70, F. |
| PRODUCTQUALITY | LCO_90 | LCO_90_F | LCO 90, F. |
| PRODUCTQUALITY | LCO_95 | LCO_95_F | LCO 95, F. |
| PRODUCTQUALITY | LCO_EP | LCO_EP_F | LCO EP, F. |
| PRODUCTQUALITY | LCO_S | LCO_Sulfur_W | LCO Sulfur, Wt % |
| | | LCO_Pour_Point_F | LCO Ppur Point, F. |
| | | LCO_Cloud_Point_F | LCO Cloud Point, F. |
| PRODUCTQUALITY | HCO_API | HCO_API | Heavy Cycle Oil API (As Produced) |
| PRODUCTQUALITY | HCO_IBP | HCO_IBP_F | Heavy Cycle Oil IBP, F. |
| PRODUCTQUALITY | HCO_10 | HCO_10_F | Heavy Cycle Oil 10, F. |
| PRODUCTQUALITY | HCO_30 | HCO_30_F | Heavy Cycle Oil 30, F. |
| PRODUCTQUALITY | HCO_50 | HCO_50_F | Heavy Cycle Oil 50, F. |
| PRODUCTQUALITY | HCO_70 | HCO_70_F | Heavy Cycle Oil 70, F. |
| PRODUCTQUALITY | HCO_90 | HCO_90_F | Heavy Cycle Oil 90, F. |
| PRODUCTQUALITY | HCO_EP | HCO_EP_F | Heavy Cycle Oil EP, F. |
| PRODUCTQUALITY | HCO_S | HCO_Sulfur_W | Heavy Cycle Oil Sulfur, Wt % |
| PRODUCTQUALITY | SLURRY_IBP | Slurry_IBP_F | Slurry IBP, F. |
| PRODUCTQUALITY | SLURRY_10 | Slurry_10_F | Slurry 10, F. |
| PRODUCTQUALITY | SLURRY_30 | Slurry_30_F | Slurry 30, F. |
| PRODUCTQUALITY | SLURRY_50 | Slurry_50_F | Slurry 50, F. |
| PRODUCTQUALITY | SLURRY_70 | Slurry_70_F | Slurry 70, F. |
| PRODUCTQUALITY | SLURRY_90 | Slurry_90_F | Slurry 90, F. |
| PRODUCTQUALITY | SLURRY_EP | Slurry_EP_F | Slurry EP, F. |
| PRODUCTQUALITY | SLURRY_S | Slurry_Sulfur_W | Slurry Sulfur, Wt % |
| PRODUCTQUALITY | SLURRY_BSW | Slurry_BSW_V | Slurry BS&W, LV % |
| | | Slurry_Ash_W | Slurry Ash Content, Wt % |
| Material Balanced FCC Yields: | | | |
| | Dry_Gas_MSCFH | MB_Dry_Gas_MSCFH | FCC Fuel Gas, MSCFH |
| | Dry_Gas_SCFB | MB_Dry_Gas_SCFB | FCC Fuel Gas, SCFB |
| YIELDS | H2S_W | MB_H2S_W | Material Balanced H2S Yield, WT % |
| YIELDS | H2_W | MB_H2_W | Material Balanced H2 Yield, WT % |
| YIELDS | H2_SCFB | MB_H2_SCFB | Material Balanced H2 Yield, SCFB |
| YIELDS | CH4_W | MB_CH4_W | Material Balanced CH4 Yield, WT % |
| YIELDS | C2O_W | MB_C2O_W | Material Balanced C2= Yield, WT % |
| YIELDS | C2_W | MB_C2_W | Material Balanced C2 Yield, WT % |
| YIELDS | TOTC2M_W | MB_Total_C2_Minus_W | Material Balanced Total C2 Minus |
| | | | Yield, WT % |
| YIELDS | TOTC2M_S | MB_Total_C2_Minus_SCFB | Material Balanced Total Dry Gas Yield, |
| | | | SCFB |
| YIELDS | C3O_V | MB_C3=_V | Material Balanced Propylene Yield, |
| | | | LV % |
| YIELDS | C3O_W | MB_C3=_W | Material Balanced Propylene Yield, |
| | | | WT % |
| YIELDS | C3_V | MB_C3_V | Material Balanced Propane Yield, LV % |
| YIELDS | C3_W | MB_C3_W | Material Balanced Propane Yield, WT % |
| | | MB_Total C3_V | Material Balanced Total C3 Yield, LV % |
| | | MB_Total C3_W | Material Balanced Total C3 Yield, Wt % |
| YIELDS | IC4O_V | MB_IC4=_V | Material Balanced Iso Butylene Yield, |
| | | | LV % |
| YIELDS | IC4O_W | MB_IC4=_W | Material Balanced Iso Butylene Yield, |
| | | | WT % |
| YIELDS | C4O_V | MB_Total_C4=_V | Material Balanced Total Butylene (Iso + Normal) |
| | | | Yield, LV % |
| YIELDS | C4O_W | MB_Total_C4=_W | Material Balanced Total Butylene (Iso + Normal) |
| | | | Yield, WT % |
| YIELDS | IC4_V | MB_IC4_V | Material Balanced Isobutane Yield, |
| | | | LV % |
| YIELDS | IC4_W | MB_IC4_W | Material Balanced IsoButane Yield, |
| | | | WT % |
| YIELDS | NC4_V | MB_NC4_V | Material Balanced Normal Butane Yield, |
| | | | LV % |
| YIELDS | NC4_W | MB_NC4_W | Material Balanced Normal Butane Yield, |
| | | | WT % |
| | | MB_Total C4_V | Material Balanced Total C4 Yield, LV % |
| | | MB_Total_C4_W | Material Balanced Total C4 Yield, Wt % |
| YIELDS | IC5O_V | MB_IC5=_V | Material Balanced iC5= (Isoamylene) |
| | | | Yield, LV % |
| YIELDS | IC5O_W | MB_IC5=_W | Material Balanced iC5= (Isoamylene) |
| | | | Yield, WT % |
| YIELDS | NC5O_V | MB_NC5=_V | Material Balanced Normal Pentene |
| | | | Yield, LV % |
| YIELDS | NC5O_W | MB_NC5=_W | Material Balanced Normal Pentene |
| | | | Yield, WT % |
| YIELDS | C5O_V | MB_Total_C5=_V | Material Balanced Total C5 Olefins |
| | | | Yield, LV % |
| YIELDS | C5O_W | MB_Total_C5=_W | Material Balanced Total C5 Olefins |
| | | | Yield, WT % |
| YIELDS | IC5_V | MB_IC5_V | Material Balanced Iso Pentane Yield, |
| | | | LV % |
| YIELDS | IC5_W | MB_IC5_W | Material Balanced Iso Pentane Yield, |
| | | | WT % |
| YIELDS | NC5_V | MB_NC5_V | Material Balanced Normal Pentane |
| | | | Yield, LV % |
| YIELDS | NC5_W | MB_NC5_W | Material Balanced Normal Pentane |
| | | | Yield, WT % |
| | | MB_Total_C5_V | Material Balanced Total C5 Yield, LV % |
| | | MB_Total_C5W | Material Balanced Total C5 Yield, WT % |
| YIELDS | | | |
| YIELDS | GASOLINE_V | MB_Gasoline_430F_EP_V | Material Balanced GASOLINE Yield |
| | | | Corrected to (C5 to 430 F.), LV % |
| YIELDS | GASOLINE_W | MB_Gasoline_430F_EP_W | Material Balanced GASOLINE Yield |
| | | | Corrected to (C5 to 430 F.), Wt % |
| YIELDS | AP_GASOLINE_V | MB_Gasoline_V | Material Balanced Gasoline (not EP |
| | | | Corrected), LV % |
| YIELDS | AP_GASOLINE_W | MB_Gasoline_W | Material Balanced Gasoline (not EP |
| | | | Corrected), Wt % |
| YIELDS | | | |
| YIELDS | LCN_V | MB_LCN_V | Light Cat Naphtha LV % |
| YIELDS | LCN_W | MB_LCN_W | Light Cat Naphtha Wt % |
| | AP_LCN_V | | As Produced Light Cat Naptha, LV % |
| YIELDS | HCN_V | MB_HCN_V | Heavy Cat Naptha, LV % |
| YIELDS | HCN_W | MB_HCN_W | Heavy Cat Naptha, Wt % |
| | AP_HCN_V | | As Produced Heavy Cat Naptha, LV % |
| YIELDS | LCO_V | MB_LCO_650_V | Material Balanced LCO (430-650)F. |
| | | | Yield, LV % |
| YIELDS | LCO_W | MB_LCO_650_W | Material Balanced LCO (430-650)F. |
| | | | Yield, Wt % |
| | | MB_LCO_V | Material Balanced LCO (not EP |
| | | | Corrected) LV % |
| | | MB_LCO_W | Material Balanced LCO (not EP |
| | | | Corrected) Wt % |
| YIELDS | | | |
| YIELDS | HCO_V | MB_HCO_V | Material Balanced Heavy Cycle Oil |
| | | | Yield, LV % |
| YIELDS | HCO_W | MB_HCO_W | Material Balanced Heavy Cycle Oil |
| | | | Yield, Wt % |
| YIELDS | | | |
| YIELDS | SLURRY_V | MB_650_Plus Slurry_V | Material Balanced 650+ SLURRY Yield, |
| | | | LV % |
| YIELDS | SLURRY_W | MB_650_Plus_Slurry_W | Material Balanced 650+ SLURRY Yield, |
| | | | WT % |
| | | MB_Slurry_V | Material Balanced Slurry (No Cut Point |
| | | | Correction) LV % |
| | | MB_Slurry_W | Material Balanced Slurry (No Cut Point |
| | | | Correction) Wt % |
| YIELDS | | | |
| YIELDS | COKE_W | MB_Coke_W | Material Balanced Coke Yield, WT % |
| YIELDS | | | |
| YIELDS | TOTAL_V | MB_Total_C3_Plus_V | Material Balanced Total C3+ Yield LV % |
| | | MB_Total_C3_Plus_W | Material Balanced Total C3+ Yield, |
| | | | Wt % |
| YIELDS | TOTAL_W | MB_Wt_Recovery_W | Material Balance Total Weight |
| | | | Recovery, WT % (Should be 100%) |
| YIELDS | | | |
| YIELDS | CONV_V | MB_Conversion_430_V | Material Balanced CONVERSION, LV % |
| | | | Corrected to 430 F. |
| YIELDS | CONV_W | MB_Conversion_430_W | Material Balanced CONVERSION, |
| | | | WT % Corrected to 430 F. |
| YIELDS | | | |
| YIELDS | AP_Conv_V | MB_Conversion_V | Material Balanced Conversion, LV % |
| | | | (No Gasoline EP Correction) |
| YIELDS | AP_Conv_W | MB_Conversion_W | Material Balanced Conversion, Wt % |
| | | | (No Gasoline EP Correction) |
| As Produced FCC Yields: | | | |
| | Dry_Gas_MSCFH | AP_Dry_Gas_MSCFH | As Produced Dry Gas Yield, MSCFH |
| | Dry_Gas_SCFB | AP_Dry_Gas_SCFB | As Produced Dry Gas Yield, SCFB |
| YIELDS | H2S_W | AP_H2S_W | As Produced H2S Yield, WT % |
| YIELDS | H2_W | AP_H2_W | As Produced H2 Yield, WT % |
| YIELDS | H2_SCFB | AP_H2_SCFB | As Produced H2 Yield, SCFB |
| YIELDS | CH4_W | AP_CH4_W | As Produced CH4 Yield, WT % |
| YIELDS | C2O_W | AP_C2O_W | As Produced C2= Yield, WT % |
| YIELDS | C2_W | AP_C2_W | As Produced C2 Yield, WT % |
| YIELDS | TOTC2M_W | AP_Total_C2_Minus_W | As Produced Total C2 Minus Yield, |
| | | | WT % |
| YIELDS | TOTC2M_S | AP_Total_C2_Minus_SCFB | As Produced Total Dry Gas Yield, |
| | | | SCFB |
| YIELDS | C3O_V | AP_C3=_V | As Produced Propylene Yield, LV % |
| YIELDS | C3O_W | AP_C3=_W | As Produced Propylene Yield, WT % |
| YIELDS | C3_V | AP_C3_V | As Produced Propane Yield, LV % |
| YIELDS | C3_W | AP_C3_W | As Produced Propane Yield, WT % |
| | | AP_Total C3_V | As Produced Total C3 Yield, LV % |
| | | AP_Total C3_W | As Produced Total C3 Yield, Wt % |
| YIELDS | IC4O_V | AP_IC4=_V | As Produced Iso Butylene Yield, LV % |
| YIELDS | IC4O_W | AP_IC4=_W | As Produced Iso Butylene Yield, WT % |
| YIELDS | C4O_V | AP_Total_C4=_V | As Produced Total Butylene (Iso + Normal) |
| | | | Yield, LV % |
| YIELDS | C4O_W | AP_Total_C4=_W | As Produced Total Butylene (Iso + Normal) |
| | | | Yield, WT % |
| YIELDS | IC4_V | AP_IC4_V | As Produced Isobutane Yield, LV % |
| YIELDS | IC4_W | AP_IC4_W | As Produced IsoButane Yield, WT % |
| YIELDS | NC4_V | AP_NC4_V | As Produced Normal Butane Yield, |
| | | | LV % |
| YIELDS | NC4_W | AP_NC4_W | As Produced Normal Butane Yield, |
| | | | WT % |
| | | AP_Total C4_V | As Produced Total C4 Yield, LV % |
| | | AP_Total_C4_W | As Produced Total C4 Yield, Wt % |
| YIELDS | IC5O_V | AP_IC5=_V | As Produced IC5= (Isoamylene) Yield, |
| | | | LV % |
| YIELDS | IC5O_W | AP_IC5=_W | As Produced IC5= (Isoamylene) Yield, |
| | | | WT % |
| YIELDS | NC5O_V | AP_NC5=_V | As Produced Normal Pentene Yield, |
| | | | LV % |
| YIELDS | NC5O_W | AP_NC5=_W | As Produced Normal Pentene Yield, |
| | | | WT % |
| YIELDS | C5O_V | AP_Total_C5=_V | As Produced Total C5 Olefins Yield, |
| | | | LV % |
| YIELDS | C5O_W | AP_Total_C5=_W | As Produced Total C5 Olefins Yield, |
| | | | WT % |
| YIELDS | IC5_V | AP_IC5_V | As Produced Iso Pentane Yield, LV % |
| YIELDS | IC5_W | AP_IC5_W | As Produced Iso Pentane Yield, WT % |
| YIELDS | NC5_V | AP_NC5_V | As Produced Normal Pentane Yield, |
| | | | LV % |
| YIELDS | NC5_W | AP_NC5_W | As Produced Normal Pentane Yield, |
| | | | WT % |
| | | AP_Total_C5_V | As Produced Total C5 Yield, LV % |
| | | AP_Total_C5W | As Produced Total C5 Yield, Wt % |
| YIELDS | | | |
| YIELDS | GASOLINE_V | AP_Gasoline_430F_EP_V | As Produced GASOLINE Yield |
| | | | Corrected to (C5 to 430 F.), LV % |
| YIELDS | GASOLINE_W | AP_Gasoline_430F_EP_W | As Produced GASOLINE Yield |
| | | | Corrected to (C5 to 430 F.), Wt % |
| YIELDS | AP_GASOLINE_V | AP_Gasoline_V | As Produced Gasoline (not EP |
| | | | Corrected), LV % |
| YIELDS | AP_GASOLINE_W | AP_Gasoline_W | As Produced Gasoline (not EP |
| | | | Corrected), Wt % |
| YIELDS | | | |
| YIELDS | LCN_V | AP_LCN_V | As Produced Light Cat Naphtha LV % |
| YIELDS | LCN_W | AP_LCN_W | As Produced Light Cat Naphtha Wt % |
| | AP_LCN_V | | As Produced Light Cat Naptha, LV % |
| YIELDS | HCN_V | AP_HCN_V | As Produced Heavy Cat Naptha, LV % |
| YIELDS | HCN_W | AP_HCN_W | As Produced Heavy Cat Naptha, Wt % |
| | AP_HCN_V | | As Produced Heavy Cat Naptha, LV % |
| YIELDS | LCO_V | AP_LCO_650_V | As Produced LCO (430-650)F. Yield, |
| | | | LV % |
| YIELDS | LCO_W | AP_LCO_650_W | As Produced LCO (430-650)F. Yield, |
| | | | Wt % |
| | | AP_LCO_V | As Produced LCO (not EP Corrected) |
| | | | LV % |
| | | AP_LCO_W | As Produced LCO (not EP Corrected) |
| | | | Wt % |
| YIELDS | | | |
| YIELDS | HCO_V | AP_HCO_V | As Produced Heavy Cycle Oil Yield, |
| | | | LV % |
| YIELDS | HCO_W | AP_HCO_W | As Produced Heavy Cycle Oil Yield, |
| | | | Wt % |
| YIELDS | | | |
| YIELDS | SLURRY_V | AP_650_Plus Slurry_V | As Produced 650+ SLURRY Yield, LV % |
| YIELDS | SLURRY_W | AP_650_Plus_Slurry_W | As Produced 650+ SLURRY Yield, |
| | | | WT % |
| | | AP_Slurry_V | As Produced Slurry (No Cut Point |
| | | | Correction) LV % |
| | | AP_Slurry_W | As Produced Slurry (No Cut Point |
| | | | Correction) Wt % |
| YIELDS | | | |
| YIELDS | COKE_W | AP_Coke_W | As Produced Coke Yield, WT % |
| YIELDS | | | |
| YIELDS | TOTAL_V | AP_Total_C3_Plus_V | As Produced Total C3+ Yield LV % |
| | | AP_Total_C3_Plus_W | As Produced Total C3+ Yield, Wt % |
| YIELDS | TOTAL_W | AP_Wt_Recovery_W | As Produced Total Weight Recovery, |
| | | | WT % |
| YIELDS | | | |
| YIELDS | CONV_V | AP_Conversion_430_V | As Produced CONVERSION, LV % |
| | | | Corrected to 430 F. |
| YIELDS | CONV_W | AP_Conversion_430_W | As Produced CONVERSION, WT % |
| | | | Corrected to 430 F. |
| YIELDS | | | |
| YIELDS | AP_Conv_V | AP_Conversion_V | As Produced Conversion, LV % (Not EP |
| | | | Corrected) |
| YIELDS | AP_Conv_W | AP_Conversion_W | As Produced Conversion, Wt % (Not EP |
| | | | Corrected) |
| Product Ratios | GPD_V | | G+D Yield, LV % |
| | GPD_W | | G+D Yield, WT % |
| | TOTC3_V | | Total C3 Yield, LV % |
| | TOTC3_W | | Total C3 Yield, WT % |
| | TOTC4_V | | Total C4 Yield, LV % |
| | TOTC4_W | | Total C4 Yield, WT % |
| | TOTC3TOC4_V | | Total C3/C4, LV % |
| | C3OTOC4O_V | | C3=/C4= Ratio, LV % |
| | TOTLPG_V | | Total LPG Yield, LV % |
| | TOTLPG_W | | Total LPG Yield, WT % |
| | TOTC4M_W | | Total C4− Yield, Wt % |
| | C3ORATIO_V | | C3=/Total C3 Ratio, LV % |
| | C3ORATIO_W | | C3=/Total C3 Ratio, WT % |
| | C4ORATIO_V | | C4=/Total C4 Ratio, LV % |
| | C4ORATIO_W | | C4=/Total C4 Ratio, WT % |
| | IC4TOC4O_V | | IC4/Total C4= Ratio, LV % |
| | IC4TOC4O_W | | IC4/(Total C4= Ratio, WT % |
| | IC4TOC4OMV | | IC4/Total C4= minus Usable IC4=), |
| | | | LV % |
| | H2TOCH4 | H2_To_CH4_Ratio_M | H2/CH4, Mole/Mole |

What is claimed is:

1. A method for managing unit operating data of a customer, comprising:
receiving unit operating data from the customer, the unit operating data including feed stock data, operations data, yield data, and catalyst data;
analyzing the unit operating data;
storing results of the analysis of the unit operating data in a database; and
allowing the customer to access the results of the analysis of the unit operating data stored in the database via a network.

2. The method of claim 1, wherein analyzing further includes:
receiving a formula from the customer; and
analyzing the unit operating data using the formula received from the customer.

3. The method of claim 1, wherein analyzing further includes:
accessing a standard formula; and
analyzing the unit operating data using the formula.

4. The method of claim 1, wherein analyzing further includes:
accessing a custom formula; and
analyzing the unit operations data using the custom formula.

5. The method of claim 1, further including:
storing the unit operating data in the database; and
allowing the customer to access the unit operating data stored in the database via the network.

6. The method of claim 1, further including:
generating a report including the results of the analysis of the unit operating data;
storing the report in the database; and
allowing the customer to access the report stored in the database via the network.

7. The method of claim 1, wherein the network is the Internet.

8. The method of claim 1, wherein allowing further includes:
enabling the customer to download the results of the analysis.

9. The method of claim 1, wherein allowing further includes:
enabling the customer to view the results of the analysis using a web browser.

10. The method of claim 1, wherein allowing further includes:
sending the results of the analysis to the customer via the network.

11. A system for managing unit operating data of a customer, comprising:
a receiving component configured to receive unit operating data from the customer, the unit operating data including feed stock data, operations data, yield data, and catalyst data;
an analyzing component configured to analyze the unit operating data;
a storing component configured to store results of the analysis of the unit operating data in a database; and
an allowing component configured to allow the customer to access the results of the analysis of the unit operating data stored in the database via a network.

12. The system of claim 11, wherein the analyzing component further includes:
a formula receiving component configured to receive a formula from the customer; and
a formula analyzing component configured to analyze the unit operating data using the formula received from the customer.

13. The system of claim 11, wherein the analyzing component further includes:
a formula accessing component configured to access a standard formula; and
a formula analyzing component configured to analyze the unit operating data using the formula.

14. The system of claim 11, wherein the analyzing component further includes:
a formula accessing component configured to access a custom formula; and
a formula analyzing component configured to analyze the unit operations data using the custom formula.

15. The system of claim 11, further including:
a data storing component configured to store the unit operating data in the database; and
a data allowing component configured to allow the customer to access the unit operating data stored in the database via the network.

16. The system of claim 11, further including:
a generating component configured to generate a report including the results of the analysis of the unit operating data;
a report storing component configured to store the report in the database; and
a report allowing component configured to allow the customer to access the report stored in the database via the network.

17. The system of claim 11, wherein the network is the Internet.

18. The system of claim 11, wherein the allowing component further includes:
an enabling component configured to enable the customer to download the results of the analysis.

19. The system of claim 11, wherein the allowing component further includes:
an enabling component configured to enable the customer to view the results of the analysis using a web browser.

20. The system of claim 11, wherein the allowing component further includes:
a sending component configured to send the results of the analysis to the customer via the network.

21. A system for managing unit operating data of a customer, comprising:
means for receiving unit operating data from the customer, the unit operating data including feed stock data, operations data, yield data, and catalyst data;
means for analyzing the unit operating data;
means for storing results of the analysis of the unit operating data in a database; and
means for allowing the customer to access the results of the analysis of the unit operating data stored in the database via a network.

22. A computer-usable medium having computer readable code embodied therein for managing unit operating data of a customer, the computer readable code comprising:
a receiving module configured to receive unit operating data from the customer, the unit operating data including feed stock data, operations data, yield data, and catalyst data;
an analyzing module configured to analyze the unit operating data;
a storing module configured to store results of the analysis of the unit operating data in a database; and
an allowing module configured to allow the customer to access the results of the analysis of the unit operating data stored in the database via a network.

23. A method for receiving unit operating data of a customer, comprising:
receiving formatting information from the customer;
receiving unit operating data from the customer in a format specific to the customer, the unit operating data including feed stock data, operations data, yield data, and catalyst data;
reformatting the unit operating data using the formatting information;
storing the reformatted unit operating data in a database; and
allowing the customer to access the reformatted unit operating data stored in the database via a network.

24. The method of claim 23, further including:
receiving updated unit operating data from the customer in the format specific to the customer; and
reformatting the updated unit operating data using the formatting information.

25. The method of claim 23, wherein formatting information is used to map the unit operating data to a standard variable list.

26. The method of claim 25, wherein standard variable list includes at least one of: a catalyst variable, a fresh feed property variable, a recycle property variable, and a heat balance variable.

27. The method of claim 23, wherein formatting information includes at least one of: an orientation of variables, a variable header row, and a sample date column.

28. The method of claim 23, wherein the format specific to the customer includes a spreadsheet format.

29. The method of claim 23, wherein the format specific to the customer includes an Excel spreadsheet format.

30. The method of claim 23, wherein the network is the Internet.

31. The method of claim 23, wherein allowing further includes:
enabling the customer to download the reformatted unit operating data.

32. The method of claim 23, wherein allowing further includes:
enabling the customer to view the reformatted unit operating data using a web browser.

33. The method of claim 23, wherein allowing further includes:
sending the reformatted operating data to the customer via the network.

34. A system for receiving unit operating data of a customer, comprising:
a formatting information receiving component configured to receive formatting information from the customer;
a data receiving component configured to receive unit operating data from the customer in a format specific to the customer, the unit operating data including feed stock data, operations data, yield data, and catalyst data;
a reformatting component configured to reformat the unit operating data using the formatting information;
a storing component configured to store the reformatted unit operating data in a database; and
an allowing component configured to allow the customer to access the reformatted unit operating data stored in the database via a network.

35. The system of claim 34, further including:
a specific format receiving component configured to receive updated unit operating data from the customer in the format specific to the customer; and
a specific format reformatting component configured to reformat the updated unit operating data using the formatting information.

36. The system of claim 34, wherein formatting information is used to map the unit operating data to a standard variable list.

37. The system of claim 36, wherein standard variable list includes at least one of: a catalyst variable, a fresh feed property variable, a recycle property variable, and a heat balance variable.

38. The system of claim 34, wherein formatting information includes at least one of: an orientation of variables, a variable header row, and a sample date column.

39. The system of claim 34, wherein the format specific to the customer includes a spreadsheet format.

40. The system of claim 34, wherein the format specific to the customer includes an Excel spreadsheet format.

41. The system of claim 34, wherein the network is the Internet.

42. The system of claim 34, wherein the allowing component further includes:
an enabling component configured to enable the customer to download the reformatted unit operating data.

43. The system of claim 34, wherein the allowing component further includes:
an enabling component configured to enable the customer to view the reformatted unit operating data using a web browser.

44. The system of claim 34, wherein the allowing component further includes:
a sending component configured to send the reformatted operating data to the customer via the network.

45. A system for receiving unit operating data of a customer, comprising:
means for receiving formatting information from the customer;
means for receiving unit operating data from the customer in a format specific to the customer, the unit operating data including feed stock data, operations data, yield data, and catalyst data;
means for reformatting the unit operating data using the formatting information;
means for storing the reformatted unit operating data in a database; and
means for allowing the customer to access the reformatted unit operating data stored in the database via a network.

46. A computer usable medium having computer readable code embodied therein for receiving unit operating data of a customer, the computer readable code comprising:
a formatting information receiving module configured to receive formatting information from the customer;
a data receiving module configured to receive unit operating data from the customer in a format specific to the customer, the unit operating data including feed stock data, operations data, yield data, and catalyst data;
a reformatting module configured to reformat the unit operating data using the formatting information;
a storing module configured to store the reformatted unit operating data in a database; and
an allowing module configured to allow the customer to access the reformatted unit operating data stored in the database via a network.

47. A method for managing unit operating data of a customer, comprising:
receiving unit operating data from the customer, the unit operating data including feed stock data, operations data, yield data, and catalyst data;
analyzing the unit operating data to determine an actual operating efficiency of the customer;
determining a predicted operating efficiency of the customer by analyzing the unit operating data by changing at least one of the feed stock data, the operations data, the yield data, and the catalyst data; and
presenting the actual operating efficiency and the predicted operating efficiency to the customer.

48. The method of claim 47, further including:
receiving a selection from the customer indicating which of the feed stock data, the operations data, the yield data, and the catalyst data is to be changed in the determining step.

49. The method of claim 47, further including:
determining a historical operating efficiency of the customer by comparing the actual operating efficiency with unit operating data previously received from the customer.

50. The method of claim 47, wherein presenting further includes:
generating a graph containing the actual operating efficiency and the predicted operating efficiency.

51. The method of claim 50, further including:
presenting the graph to the customer.

52. The method of claim 50, wherein actual operating efficiency is depicted using one color and the predicted operating efficiency is depicted using a different color.

53. The method of claim 51, wherein presenting further includes:
enabling the customer to download the graph.

54. The method of claim 51, wherein presenting further includes:
enabling the customer to view the graph using a web browser.

55. The method of claim 51, wherein presenting further includes:
sending the graph to the customer via a network.

56. The method of claim 47, further including:
making recommendations to the customer based on adjustments to one of the feed stock data, operations data, yield data, and catalyst data.

57. A system for managing unit operating data of a customer, comprising:
a receiving component configured to receive unit operating data from the customer, the unit operating data including feed stock data, operations data, yield data, and catalyst data;
an analyzing component configured to analyze the unit operating data to determine an actual operating efficiency of the customer;
a determining component configured to determine a predicted operating efficiency of the customer by analyzing the unit operating data by changing at least one of the feed stock data, the operations data, the yield data, and the catalyst data; and
a presenting component configured to present the actual operating efficiency and the predicted operating efficiency to the customer.

58. The system of claim 57, further including:
a selection receiving component configured to receive a selection from the customer indicating which of the feed stock data, the operations data, the yield data, and the catalyst data is to be changed in the determining step.

59. The system of claim 57, further including:
a historical determining component configured to determine a historical operating efficiency of the customer by comparing the actual operating efficiency with unit operating data previously received from the customer.

60. The system of claim 57, wherein presenting further includes:
a generating component configured to generate a graph containing the actual operating efficiency and the predicted operating efficiency.

61. The system of claim 60, further including:
a graph presenting component configured to present the graph to the customer.

62. The system of claim 60, wherein actual operating efficiency is depicted using one color and the predicted operating efficiency is depicted using a different color.

63. The system of claim 61, wherein the graph presenting component further includes:
an enabling component configured to the enable the customer to download the graph.

64. The system of claim 61, wherein the graph presenting component further includes:
an enabling component configured to enable the customer to view the graph using a web browser.

65. The system of claim 61, wherein the graph presenting component further includes:
a sending component configured to send the graph to the customer via a network.

66. The system of claim 57, further including:
a making component configured to make recommendations to the customer based on adjustments to one of the feed stock data, operations data, yield data, and catalyst data;

67. A system for managing unit operating data of a customer, comprising:
means for receiving unit operating data from the customer, the unit operating data including feed stock data, operations data, yield data, and catalyst data;
means for analyzing the unit operating data to determine an actual operating efficiency of the customer;
means for determining a predicted operating efficiency of the customer by analyzing the unit operating data by changing at least one of the feed stock data, the operations data, the yield data, and the catalyst data; and
means for presenting the actual operating efficiency and the predicted operating efficiency to the customer.

68. A computer usable medium having computer readable code embodied therein for managing unit operating data of a customer, the computer readable code comprising:
a receiving module configured to receive unit operating data from the customer, the unit operating data including feed stock data, operations data, yield data, and catalyst data;
an analyzing module configured to analyze the unit operating data to determine an actual operating efficiency of the customer;
a determining module configured to determine a predicted operating efficiency of the customer by analyzing the unit operating data by changing at least one of the feed stock data, the operations data, the yield data, and the catalyst data; and
a presenting module configured to present the actual operating efficiency and the predicted operating efficiency to the customer.

69. A method for managing unit operating data of a customer, comprising:
receiving unit operating data corresponding to a catalyst used by the customer, the unit operating data including feed stock data, operations data, and yield data;
analyzing the unit operating data to determine an actual operating efficiency of the customer; and
determining a predicted operating efficiency of the customer by analyzing the unit operating data of the customer using data about a catalyst other than the catalyst used by the customer.

70. The method of claim 69, further including:
presenting the actual operating efficiency and the predicted operating efficiency to the customer.

71. The method of claim 70, wherein presenting further includes:
generating a graph containing the actual operating efficiency and the predicted operating efficiency; and
presenting the graph to the customer.

72. The method of claim 71, wherein the actual operating efficiency is depicted using one color and the predicted operating efficiency is depicted using a different color.

73. The method of claim 71, wherein presenting further includes:
enabling the customer to download the graph.

74. The method of claim 71, wherein presenting further includes:
enabling the customer to view the graph using a web browser.

75. The method of claim 71, wherein presenting further includes:
sending the graph to the customer via a network.

76. A system for managing unit operating data of a customer, comprising:
a receiving component configured to receive unit operating data corresponding to a catalyst used by the customer, the unit operating data including feed stock data, operations data, and yield data;
an analyzing component configured to analyze the unit operating data to determine an actual operating efficiency of the customer; and
a determining component configured to determine a predicted operating efficiency of the customer by analyzing the unit operating data of the customer using data about a catalyst other than the catalyst used by the customer.

77. The system of claim 76, further including:
a presenting component configured to present the actual operating efficiency and the predicted operating efficiency to the customer.

78. The system of claim 77, wherein the presenting component further includes:
a generating component configured to generate a graph containing the actual operating efficiency and the predicted operating efficiency; and
a graph presenting component configured to present the graph to the customer.

79. The system of claim 78, wherein the actual operating efficiency is depicted using one color and the predicted operating efficiency is depicted using a different color.

80. The system of claim 78, wherein the presenting component further includes:
an enabling component configured to enable the customer to download the graph.

81. The system of claim 78, wherein the presenting component further includes:
an enabling component configured to enable the customer to view the graph using a web browser.

82. The system of claim 78, wherein the presenting component further includes:
a sending component configured to send the graph to the customer via a network.

83. A system for managing unit operating data of a customer, comprising:
means for receiving unit operating data corresponding to a catalyst used by the customer, the unit operating data including feed stock data, operations data, and yield data;
means for analyzing the unit operating data to determine an actual operating efficiency of the customer; and
means for determining a predicted operating efficiency of the customer by analyzing the unit operating data of the customer using data about a catalyst other than the catalyst used by the customer.

84. A computer usable medium having computer usable code embodied therein for managing unit operating data of a customer, the computer readable code comprising:
a receiving module configured to receive unit operating data corresponding to a catalyst used by the customer, the unit operating data including feed stock data, operations data, and yield data;
an analyzing module configured to analyze the unit operating data to determine an actual operating efficiency of the customer; and
a determining module configured to determine a predicted operating efficiency of the customer by analyzing the unit operating data of the customer using data about a catalyst other than the catalyst used by the customer.

85. A method for managing unit operating data of a customer, comprising:
receiving a substance and unit operating data from the customer;
analyzing the substance;
storing results of the analysis of the substance together with the unit operating data in a database;
determining an actual operating efficiency based on the unit operating data and the analysis of the substance; and
determining an improved operating efficiency based on the unit operating data and the analysis of a different substance.

86. The method of claim 85, further including:
presenting the actual operating efficiency and the improved operating efficiency to the customer.

87. The method of claim 86, wherein presenting further includes:
generating a graph containing the actual operating efficiency and the predicted operating efficiency; and
presenting the graph to the customer.

88. The method of claim 87, wherein the actual operating efficiency is depicted using one color and the predicted operating efficiency is depicted using a different color.

89. The method of claim 87, wherein presenting further includes:
enabling the customer to download the graph.

90. The method of claim 87, wherein presenting further includes:
enabling the customer to view the graph using a web browser.

91. The method of claim 87, wherein presenting further includes:
sending the graph to the customer via a network.

92. A system for managing unit operating data of a customer, comprising:
a receiving component configured to receive a substance and unit operating data from the customer;
an analyzing component configured to analyze the substance;
a storing component configured to store results of the analysis of the substance together with the unit operating data in a database;
an actual determining component configured to determine an actual operating efficiency based on the unit operating data and the analysis of the substance; and
an improved determining component configured to determine an improved operating efficiency based on the unit operating data and the analysis of a different substance.

93. The system of claim 92, further including:
a presenting component configured to present the actual operating efficiency and the improved operating efficiency to the customer.

94. The system of claim 93, wherein the presenting component further includes:
a generating component configured to generate a graph containing the actual operating efficiency and the predicted operating efficiency; and
a graph presenting component configured to present the graph to the customer.

95. The system of claim 94, wherein the actual operating efficiency is depicted using one color and the predicted operating efficiency is depicted using a different color.

96. The system of claim 94, wherein the presenting component further includes:
an enabling component configured to enable the customer to download the graph.

97. The system of claim 94, wherein the presenting component further includes:
an enabling component configured to enable the customer to view the graph using a web browser.

98. The system of claim 94, wherein the presenting component further includes:
a sending component configured to send the graph to the customer via a network.

99. A system for managing unit operating data of a customer, comprising:
means for receiving a substance and unit operating data from the customer;
means for analyzing the substance;
means for storing results of the analysis of the substance together with the unit operating data in a database;
means for determining an actual operating efficiency based on the unit operating data and the analysis of the substance; and
means for determining an improved operating efficiency based on the unit operating data and the analysis of a different substance.

100. A computer usable medium having computer readable code embodied therein for managing unit operating data of a customer, the computer readable code comprising:
a receiving module configured to receive a substance and unit operating data from the customer;
an analyzing module configured to analyze the substance;
a storing module configured to store results of the analysis of the substance together with the unit operating data in a database;
an actual determining module configured to determine an actual operating efficiency based on the unit operating data and the analysis of the substance; and
an improved determining module configured to determine an improved operating efficiency based on the unit operating data and the analysis of a different substance.

101. A method for managing unit operating data of a customer, comprising:
receiving unit operating data including feed stock data, operations data, yield data, and catalyst data from a plurality of customers that belong to an industry;
analyzing the unit operating data received from the plurality of customers to determine data about the industry; and
storing the data about the industry in a database.

102. The method of claim 101, further including:
determining an actual operating efficiency for each of the plurality of customers based on the unit operating data received from the plurality of customers.

103. The method of claim 102, further including:
determining a relative operating efficiency between one of the plurality of customers and the plurality of customers by comparing the actual operating efficiency of that customer with the actual operating efficiency of the plurality of customers; and
presenting the actual operating efficiency of the plurality of customers and the relative operating efficiency to the one of the plurality of customers.

104. The method of claim 101, further including:
presenting the data about the industry to the plurality of customers.

105. The method of claim 104, wherein presenting further includes:
generating a graph containing the data about the industry; and
presenting the graph to the plurality of customers.

106. The method of claim 101, further including:
determining a predicted operating efficiency for each of the plurality of customers based on changing one of the feed stock data, the operations data, the yield data, and the catalyst data received from the plurality of customers.

107. The method of claim 106, further including:
determining an alternative operating efficiency for one of the plurality of customers based on changing the catalyst data of the one of the plurality of customers.

108. A system for managing unit operating data of a customer, comprising:
a receiving component configured to receive unit operating data including feed stock data, operations data, yield data, and catalyst data from a plurality of customers that belong to an industry;
an analyzing component configured to analyze the unit operating data received from the plurality of customers to determine data about the industry; and
a storing component configured to store the data about the industry in a database.

109. The system of claim 108, further including:
an actual efficiency determining component configured to determine an actual operating efficiency for each of the plurality of customers based on the unit operating data received from the plurality of customers.

110. The system of claim 109, further including:
a relative efficiency determining component configured to determine a relative operating efficiency between one of the plurality of customers and the plurality of customers by comparing the actual operating efficiency of that customer with the actual operating efficiency of the plurality of customers; and
a presenting component configured to present the actual operating efficiency of the plurality of customers and the relative operating efficiency to the one of the plurality of customers.

111. The system of claim 108, further including:
a presenting component configured to present the data about the industry to the plurality of customers.

112. The system of claim 111, wherein the presenting component further includes:
a generating component configured to generate a graph containing the data about the industry; and
a graph presenting component configured to present the graph to the plurality of customers.

113. The system of claim 108, further including:
a predicted efficiency determining component configured to determine a predicted operating efficiency for each of the plurality of customers based on changing one of the feed stock data, the operations data, the yield data, and the catalyst data received from the plurality of customers.

114. The system of claim 113, further including:
an alternative efficiency determining component configured to determine an alternative operating efficiency for one of the plurality of customers based on changing the catalyst data of the one of the plurality of customers.

115. A system for managing unit operating data of a customer, comprising:
means for receiving unit operating data including feed stock data, operations data, yield data, and catalyst data from a plurality of customers that belong to an industry;
means for analyzing the unit operating data received from the plurality of customers to determine data about the industry; and
means for storing the data about the industry in a database.

116. A computer usable medium having computer readable code embodied therein for managing unit operating data of a customer, the computer readable code comprising:
a receiving module configured to receive unit operating data including feed stock data, operations data, yield data, and catalyst data from a plurality of customers that belong to an industry;
an analyzing module configured to analyze the unit operating data received from the plurality of customers to determine data about the industry; and
a storing module configured to store the data about the industry in a database.
